(19) United States
(12) Patent Application Publication
(10) Pub. No.: US 2025/0244562 A1
(43) Pub. Date: Jul. 31, 2025

(54) IMAGING LENS AND IMAGING APPARATUS

(71) Applicant: FUJIFILM Corporation, Tokyo (JP)

(72) Inventors: Toshihiro AOI, Saitama (JP); Ukyo TOMIOKA, Saitama (JP)

(73) Assignee: FUJIFILM Corporation, Tokyo (JP)

(21) Appl. No.: 19/021,032

(22) Filed: Jan. 14, 2025

(30) Foreign Application Priority Data
Jan. 30, 2024 (JP) 2024-011990

(51) Int. Cl. G02B 13/00; G02B 9/64

(52) U.S. Cl. CPC G02B 13/0045; G02B 9/64

(57) ABSTRACT

An imaging lens consists of, in order from an object side to an image side, a first lens group having a positive refractive power, a second lens group, and a third lens group. During focusing, the second lens group moves. A lens closest to the object side is a negative meniscus lens, and at least one of a second lens from the object side or a third lens from the object side is a lens other than the negative meniscus lens. A stop is disposed closer to the image side than the second lens from the object side. The imaging lens satisfies a predetermined conditional expression.

### CROSS-REFERENCE TO RELATED APPLICATIONS

This application claims priority from Japanese Patent Application No. 2024-011990, filed on Jan. 30, 2024, the entire disclosure of which is incorporated herein by reference.

### BACKGROUND OF THE INVENTION

### Technical Field

The disclosed technology relates to an imaging lens and an imaging apparatus.

### Related Art

In the related art, lens systems according to JP2023-045839A and JP2023-019073A have been known as an imaging lens used in a digital camera or the like.

### SUMMARY

There has been a demand for an imaging lens that has a reduced total length of a lens system and favorable optical performance. A level of such a demand is increasing every year.

An object of the present disclosure is to provide an imaging lens that has a reduced total length of a lens system and favorable optical performance, and an imaging apparatus comprising the imaging lens.

According to an aspect of the disclosed technology, there is provided an imaging lens consisting of, in order from an object side to an image side, a first lens group having a positive refractive power, a second lens group, and a third lens group, in which, during focusing, the first lens group and the third lens group are fixed with respect to an image plane, and the second lens group moves along an optical axis, a lens closest to the object side is a negative meniscus lens, and at least one of a second lens from the object side or a third lens from the object side is a lens other than the negative meniscus lens, a stop is disposed closer to the image side than the second lens from the object side, and Conditional Expressions (1) and (2) are satisfied, which are represented by

$$1 < TL / Y < 4.5 and \qquad ( 1 )$$

$$- 0.18 < ( Y - f \times tan ω m ) / ( f \times tan ω m ) < - 0.02 . \qquad ( 2 )$$

A sum of a back focus of an entire system as an air conversion distance and a distance on the optical axis from a lens surface of the first lens group closest to the object side to a lens surface of the third lens group closest to the image side is denoted by TL. A maximum image height is denoted by Y. A focal length of the entire system in a state where an infinite distance object is in focus is denoted by f. A maximum half angle of view in the state where the infinite distance object is in focus is denoted by ωm.

In a case where a radius of a circle passing through three points consisting of a point of a lens surface on the optical axis and two points of the lens surface at most outer ends of an effective diameter in a cross section including the optical axis is referred to as Rc of the lens surface, and a sign of Rc is positive in a case where the point on the optical axis is closer to the object side than a center of the circle, and is negative in a case where the point on the optical axis is closer to the image side than the center of the circle, the number of lenses, included in the third lens group, of which a lens surface on the object side has an aspherical shape and of which the sign of Rc of the lens surface on the object side is negative is preferably one or two.

The number of lenses included in the imaging lens is preferably 5 or more and 10 or less.

In a case where ωm is in degree units, the imaging lens of the aspect preferably satisfies Conditional Expression (3) represented by

$$47 < ω m < 60. \qquad ( 3 )$$

In a case where a focal length of the first lens group is denoted by fG1, the imaging lens of the aspect preferably satisfies Conditional Expression (4) represented by

$$0.01 < f / fG 1 < 1.6 . \qquad ( 4 )$$

In a case where a distance on the optical axis from the lens surface of the first lens group closest to the object side to the stop in the state where the infinite distance object is in focus is denoted by dL1St, the imaging lens of the aspect preferably satisfies Conditional Expression (5) represented by

$$0.1 < d L 1 St / Y < 2.1 . \qquad ( 5 )$$

In a case where an angle between an axis line parallel to the optical axis and a principal ray of a maximum image height incident on the image plane in the state where the infinite distance object is in focus is denoted by CRA, and CRA is in degree units, the imaging lens of the aspect preferably satisfies Conditional Expression (6) represented by

$$16 < \vert CRA \vert < 69. \qquad ( 6 )$$

In a case where the back focus of the entire system as the air conversion distance is denoted by Bf, the imaging lens of the aspect preferably satisfies Conditional Expression (7) represented by

$$0.06 < Bf / TL < 0.3 . \qquad ( 7 )$$

In a case where f is in millimeter units, and an open F-number in the state where the infinite distance object is in focus is denoted by Fno, the imaging lens of the aspect preferably satisfies Conditional Expression (8) represented by

$$1.7 < f / Fno < 4.1 . \qquad ( 8 )$$

In a case where a focal length of the second lens group is denoted by fG2, the imaging lens of the aspect preferably satisfies Conditional Expression (9) represented by

$$0.24 < \vert f / fG 2 \vert < 2.4 . \qquad ( 9 )$$

One or two single lenses having a negative refractive power and one or two single lenses having a positive refractive power are preferably disposed closer to the object side than the stop, and the number of lenses disposed closer to the object side than the stop is preferably four or less.

A positive lens is preferably disposed adjacent to the image side of the stop, and in a case where an Abbe number based on a d line for the positive lens disposed adjacent to the image side of the stop is denoted by vrp, the imaging lens of the aspect preferably satisfies Conditional Expression (10) represented by

$$34 < ν rp < 87. \qquad ( 10 )$$

A positive lens is preferably disposed adjacent to the object side of the stop, and in a case where an Abbe number based on a d line for the positive lens disposed adjacent to the object side of the stop is denoted by vfp, the imaging lens of the aspect preferably satisfies Conditional Expression (11) represented by

$$23 < ν fp < 61. \qquad ( 11 )$$

A positive lens is preferably disposed adjacent to the object side of the stop, and an Lffn lens having a negative refractive power is preferably disposed adjacent to the object side of the positive lens, and in a case where an Abbe number based on a d line for the Lffn lens is denoted by vffn, the imaging lens of the aspect preferably satisfies Conditional Expression (12) represented by

$$16 < ν ffn < 100. \qquad ( 12 )$$

In a case where a radius of a circle passing through three points consisting of a point of a lens surface on the optical axis and two points of the lens surface at most outer ends of an effective diameter in a cross section including the optical axis is referred to as Rc of the lens surface, and a sign of Rc is positive in a case where the point on the optical axis is closer to the object side than a center of the circle, and is negative in a case where the point on the optical axis is closer to the image side than the center of the circle, the first lens group preferably includes, in consecutive order from a position closest to the object side to the image side, a negative partial group and one positive lens, the negative partial group preferably consists of one or two negative lenses having the same sign of Rc of a lens surface on the object side and Rc of a lens surface on the image side, at least one lens surface included in the negative partial group preferably has an aspherical shape, and the imaging lens of the aspect preferably satisfies Conditional Expressions (13) and (14) represented by

$$1.45 < N 1 nave < 2.3 and \qquad ( 13 )$$

$$16 < ν 1 nave < 85. \qquad ( 14 )$$

An average value of refractive indices with respect to a d line for all lenses included in the negative partial group is denoted by N1nave, and an average value of Abbe numbers based on the d line for all lenses included in the negative partial group is denoted by ν1nave.

In a case where a combined focal length of all lenses closer to the object side than the stop in the state where the infinite distance object is in focus is denoted by fGf, and a combined focal length of all lenses closer to the image side than the stop in the state where the infinite distance object is in focus is denoted by fGr, the imaging lens of the aspect preferably satisfies Conditional Expression (15) represented by

$$- 10 < fGf / fGr < 31. \qquad ( 15 )$$

A lens surface of the second lens group closest to the image side preferably has a convex shape.

The imaging lens preferably includes at least one lens surface having an inflection point, and in a case where a distance on the optical axis from the lens surface of the first lens group closest to the object side to the lens surface of the third lens group closest to the image side is denoted by DL, at least one intersection between the lens surface having the inflection point and the optical axis in the state where the infinite distance object is in focus is preferably a specific intersection within a range of 0.3×DL from an intersection between the lens surface of the first lens group closest to the object side and the optical axis to the image side or a range of 0.3×DL from an intersection between the lens surface of the third lens group closest to the image side and the optical axis to the object side.

In a case where a refractive power of a lens surface having the specific intersection is denoted by φa, and a refractive power of the imaging lens in the state where the infinite distance object is in focus is denoted by q, at least one lens surface having the specific intersection preferably satisfies Conditional Expression (16) represented by

$$- 2 < φ a / φ < 3. \qquad ( 16 )$$

According to another aspect of the present disclosure, there is provided an imaging apparatus comprising the imaging lens of the aspect.

In the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the illustrated constituents.

The term “group having a positive refractive power” in the present specification means that the entire group has a positive refractive power. The term “group having a negative refractive power” means that the entire group has a negative refractive power. The term “lens having a positive refractive power” and the term “positive lens” are synonymous with each other. The term “lens having a negative refractive power” and the term “negative lens” are synonymous with each other. The term “group” in the present specification is not limited to a configuration consisting of a plurality of lenses and may be a configuration consisting of only one lens.

A compound aspherical lens (a lens functioning as one aspherical lens as a whole, in which a lens (for example, a spherical lens) and a film of an aspherical shape formed on the lens are configured to be integrated with each other) is not regarded as a cemented lens and is regarded as one lens. Unless otherwise specified, a sign of a refractive power and a surface shape related to a lens including an aspherical surface in a paraxial region are used.

The term “entire system” in the present specification means the imaging lens. The term “focal length” used in the conditional expressions is a paraxial focal length. Unless otherwise specified, the term “distance on the optical axis” used in the conditional expressions is a geometrical distance. Unless otherwise specified, values used in the conditional expressions are values based on the d line in the state where the infinite distance object is in focus.

The terms “d line”, “C line”, and “F line” according to the present specification are bright lines. A wavelength of the d line is 587.56 nanometers (nm). A wavelength of the C line is 656.27 nanometers (nm). A wavelength of the F line is 486.13 nanometers (nm).

According to the present disclosure, an imaging lens that has a reduced total length of a lens system and favorable optical performance, and an imaging apparatus comprising the imaging lens can be provided.

### BRIEF DESCRIPTION OF THE DRAWINGS

FIG. 1 is a cross-sectional view that illustrates a configuration of an imaging lens according to one embodiment and that corresponds to an imaging lens of Example 1.

FIG. 2 is a cross-sectional view illustrating a configuration and luminous fluxes in each state of the imaging lens in FIG. 1.

FIG. 3 is a diagram for describing Rc.

FIG. 4 is a diagram for describing symbols of conditional expressions.

FIG. 5 is a diagram for describing symbols of the conditional expressions.

FIG. 6 is each aberration diagram of the imaging lens of Example 1.

FIG. 7 is a cross-sectional view illustrating a configuration of an imaging lens of Example 2.

FIG. 8 is each aberration diagram of the imaging lens of Example 2.

FIG. 9 is a cross-sectional view illustrating a configuration of an imaging lens of Example 3.

FIG. 10 is each aberration diagram of the imaging lens of Example 3.

FIG. 11 is a cross-sectional view illustrating a configuration of an imaging lens of Example 4.

FIG. 12 is each aberration diagram of the imaging lens of Example 4.

FIG. 13 is a cross-sectional view illustrating a configuration of an imaging lens of Example 5.

FIG. 14 is each aberration diagram of the imaging lens of Example 5.

FIG. 15 is a cross-sectional view illustrating a configuration of an imaging lens of Example 6.

FIG. 16 is each aberration diagram of the imaging lens of Example 6.

FIG. 17 is a cross-sectional view illustrating a configuration of an imaging lens of Example 7.

FIG. 18 is each aberration diagram of the imaging lens of Example 7.

FIG. 19 is a cross-sectional view illustrating a configuration of an imaging lens of Example 8.

FIG. 20 is each aberration diagram of the imaging lens of Example 8.

FIG. 21 is a cross-sectional view illustrating a configuration of an imaging lens of Example 9.

FIG. 22 is each aberration diagram of the imaging lens of Example 9.

FIG. 23 is a cross-sectional view illustrating a configuration of an imaging lens of Example 10.

FIG. 24 is each aberration diagram of the imaging lens of Example 10.

FIG. 25 is a cross-sectional view illustrating a configuration of an imaging lens of Example 11.

FIG. 26 is each aberration diagram of the imaging lens of Example 11.

FIG. 27 is a cross-sectional view illustrating a configuration of an imaging lens of Example 12.

FIG. 28 is each aberration diagram of the imaging lens of Example 12.

FIG. 29 is a cross-sectional view illustrating a configuration of an imaging lens of Example 13.

FIG. 30 is each aberration diagram of the imaging lens of Example 13.

FIG. 31 is a cross-sectional view illustrating a configuration of an imaging lens of Example 14.

FIG. 32 is each aberration diagram of the imaging lens of Example 14.

FIG. 33 is a cross-sectional view illustrating a configuration of an imaging lens of Example 15.

FIG. 34 is each aberration diagram of the imaging lens of Example 15.

FIG. 35 is a cross-sectional view illustrating a configuration of an imaging lens of Example 16.

FIG. 36 is each aberration diagram of the imaging lens of Example 16.

FIG. 37 is a cross-sectional view illustrating a configuration of an imaging lens of Example 17.

FIG. 38 is each aberration diagram of the imaging lens of Example 17.

FIG. 39 is a cross-sectional view illustrating a configuration of an imaging lens of Example 18.

FIG. 40 is each aberration diagram of the imaging lens of Example 18.

FIG. 41 is a cross-sectional view illustrating a configuration of an imaging lens of Example 19.

FIG. 42 is each aberration diagram of the imaging lens of Example 19.

FIG. 43 is a cross-sectional view illustrating a configuration of an imaging lens of Example 20.

FIG. 44 is each aberration diagram of the imaging lens of Example 20.

FIG. 45 is a cross-sectional view illustrating a configuration of an imaging lens of Example 21.

FIG. 46 is each aberration diagram of the imaging lens of Example 21.

FIG. 47 is a cross-sectional view illustrating a configuration of an imaging lens of Example 22.

FIG. 48 is each aberration diagram of the imaging lens of Example 22.

FIG. 49 is a cross-sectional view illustrating a configuration of an imaging lens of Example 23.

FIG. 50 is each aberration diagram of the imaging lens of Example 23.

FIG. 51 is a cross-sectional view illustrating a configuration of an imaging lens of Example 24.

FIG. 52 is each aberration diagram of the imaging lens of Example 24.

FIG. 53 is a cross-sectional view illustrating a configuration of an imaging lens of Example 25.

FIG. 54 is each aberration diagram of the imaging lens of Example 25.

FIG. 55 is a perspective view of a front surface side of an imaging apparatus according to one embodiment.

FIG. 56 is a perspective view of a rear surface side of the imaging apparatus according to one embodiment.

### DETAILED DESCRIPTION

Hereinafter, an embodiment of the disclosed technology will be described with reference to the drawings.

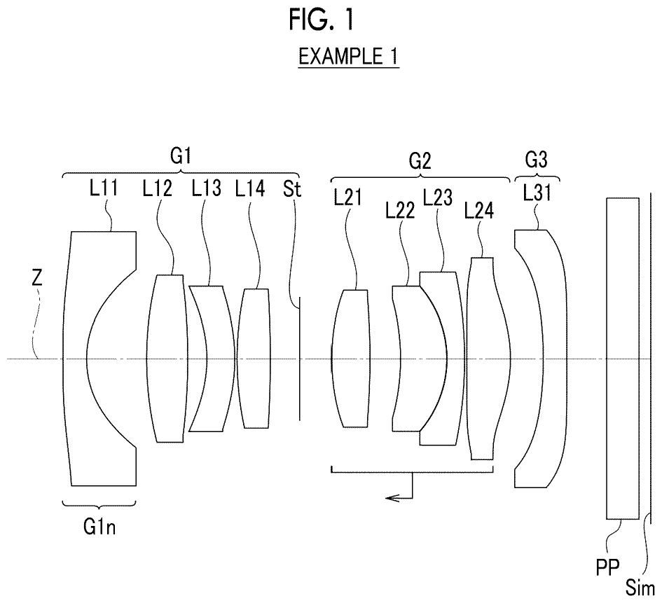

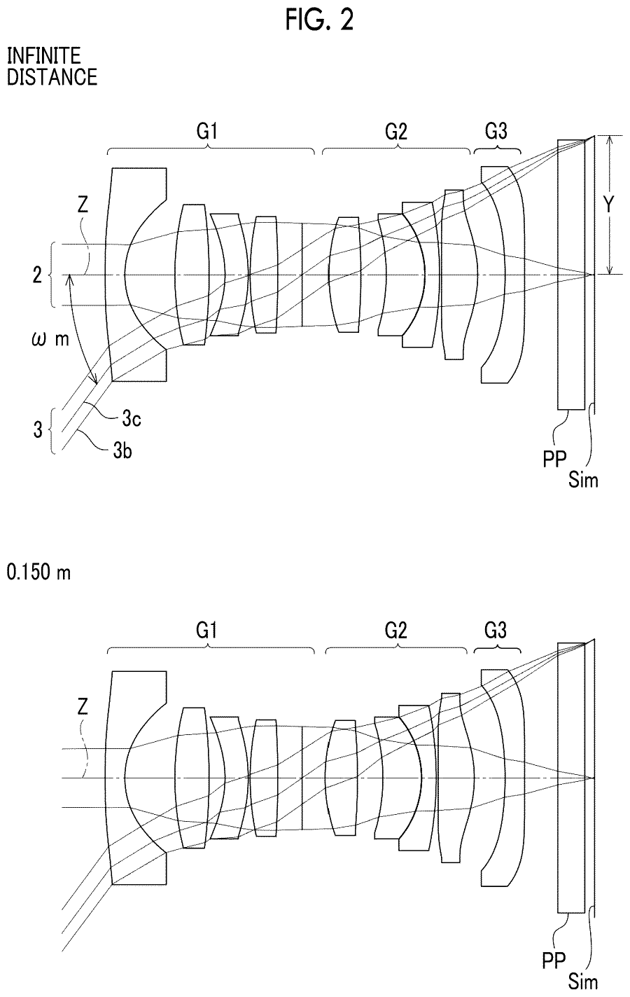

FIG. 1 illustrates a cross-sectional view of a configuration of an imaging lens according to one embodiment of the present disclosure. FIG. 2 is a cross-sectional view of a configuration and luminous fluxes of the imaging lens in FIG. 1. In FIG. 2, a state where an infinite distance object is in focus is illustrated in an upper part labeled “INFINITE DISTANCE”, and a state where a nearest object at an object distance of 0.150 m is in focus is illustrated in a lower part labeled “0.150 m”. In the present specification, the object distance refers to a distance from a lens surface of the imaging lens closest to an object side to an object. In FIG. 2, an on-axis luminous flux 2 and a luminous flux 3 at a maximum half angle of view ωm in the state where the infinite distance object is in focus, and an on-axis luminous flux and a luminous flux at the maximum half angle of view in the state where the nearest object is in focus are illustrated as the luminous fluxes. In FIGS. 1 and 2, a left side is an object side, and a right side is an image side. The examples illustrated in FIGS. 1 and 2 correspond to an imaging lens of Example 1 described later. Hereinafter, description will be mainly provided with reference to FIG. 1.

FIG. 1 illustrates an example in which an optical member PP having a shape of a parallel flat plate is disposed between the imaging lens and an image plane Sim, assuming that the imaging lens is applied to an imaging apparatus. The optical member PP is a member that is assumed to be various filters and/or a cover glass or the like. The various filters include a low-pass filter, an infrared cut filter, and/or a filter or the like that cuts a specific wavelength range. The optical member PP is a member not having a refractive power. The imaging apparatus can also be configured without the optical member PP.

The imaging lens of the present disclosure consists of, in order from the object side to the image side along an optical axis Z, a first lens group G1 having a positive refractive power, a second lens group G2, and a third lens group G3. Providing the first lens group G1 with a refractive power of a positive sign enables rays emitted from the first lens group G1 to converge and thus, achieves an advantage in reducing a total length of a lens system.

During focusing, the first lens group G1 and the third lens group G3 are fixed with respect to the image plane Sim, and the second lens group G2 moves along the optical axis Z. Hereinafter, a lens group that moves during the focusing will be referred to as a focus group. The focusing is performed by moving the focus group. In the imaging lens of the present disclosure, the focus group consists of the second lens group G2. Forming the second lens group G2 as the focus group can reduce a weight of the focus group compared to a configuration in which the entire lens system moves during the focusing, and thus, enables high-speed focusing.

For example, each group of the imaging lens in FIG. 1 is configured as follows. The first lens group G1 consists of, in order from the object side to the image side, four lenses including lenses L11 to L14, and an aperture stop St. The second lens group G2 consists of, in order from the object side to the image side, four lenses including lenses L21 to L24. The third lens group G3 consists of one lens that is a lens L31. The aperture stop St in FIG. 1 does not indicate a size or a shape and indicates a position in an optical axis direction. A bracket and a rightward arrow under the second lens group G2 in FIG. 1 indicate that the second lens group G2 is the focus group and moves to the object side during focusing from the infinite distance object to the nearest object.

In the present specification, the term “lens group” means a part that is a constituent of the imaging lens and that includes at least one lens divided by an air spacing which changes during the focusing. During the focusing, each lens group is moved or fixed in lens group units, and a mutual spacing between lenses in each lens group does not change. That is, in the present specification, one lens group means a group in which, during the focusing, a spacing with respect to an adjacent group changes, and all spacings between adjacent lenses in the group do not change.

In the imaging lens of the present disclosure, the number of lenses included in the first lens group G1 may be configured to be one or more and seven or less. Doing so achieves an advantage in reduction of the total length of the lens system.

The second lens group G2 may be a lens group having a positive refractive power or a lens group having a negative refractive power.

The number of lenses included in the second lens group G2 may be configured to be one or more and four or less. Doing so achieves an advantage in reduction of the total length of the lens system.

A lens surface of the second lens group G2 closest to the image side preferably has a convex shape. Doing so can reduce an emission angle of a ray emitted from the lens surface and thus, can suppress occurrence of aberrations, particularly occurrence of a field curvature.

The third lens group G3 may be a lens group having a positive refractive power or a lens group having a negative refractive power.

The number of lenses included in the third lens group G3 may be configured to be one or more and four or less. Doing so achieves an advantage in reduction of the total length of the lens system.

The number of lenses included in the imaging lens may be configured to be 5 or more and 10 or less. Providing five or more lenses achieves an advantage in reduction in size while maintaining high performance. Providing 10 or fewer lenses achieves an advantage in reduction of the total length of the lens system.

The number of cemented lenses included in the imaging lens may be configured to be zero or one. Doing so increases a degree of freedom by reducing bonding surfaces and thus, can increase an aberration correction effect even with a small number of lenses. This can achieve high performance.

In the imaging lens of the present disclosure, a lens closest to the object side is configured to be a negative meniscus lens, and at least one of a second lens from the object side or a third lens from the object side is configured to be a lens other than the negative meniscus lens. Forming the lens closest to the object side as a negative meniscus lens achieves an advantage in achieving a wide angle. Forming at least one of the second lens from the object side or the third lens from the object side as a lens other than the negative meniscus lens can favorably correct an astigmatism that is overcorrected by the negative meniscus lens. The term “negative meniscus lens” in the present specification means a meniscus lens having a negative refractive power.

In the example in FIG. 1, the term “lens closest to the object side”, the term “second lens from the object side”, and the term “third lens from the object side” correspond to the lens L11, the lens L12, and the lens L13, respectively. However, the term “second lens from the object side” does not necessarily mean a second lens from the object side in the first lens group G1 and means a second lens from the object side in the imaging lens. Similarly, the term “third lens from the object side” means a third lens from the object side in the imaging lens. For example, in the imaging lens in which the first lens group G1 consists of two lenses unlike the example in FIG. 1, the term “third lens from the object side” refers to a lens closest to the object side in the second lens group G2.

In the imaging lens of the present disclosure, the aperture stop St is disposed closer to the image side than the second lens from the object side. This configuration achieves an advantage in reduction of the entire lens system in size.

One or two single lenses having a negative refractive power and one or two single lenses having a positive refractive power are preferably disposed closer to the object side than the aperture stop St. The number of lenses disposed closer to the object side than the aperture stop St is preferably four or less. Disposing a negative lens closer to the object side than the aperture stop St achieves an advantage in achieving a wide angle. Furthermore, disposing a positive lens closer to the object side than the aperture stop St achieves an advantage in correcting a chromatic aberration. Providing a single lens configuration as described above increases the degree of freedom and thus, achieves an advantage in more effective aberration correction, particularly correction of the field curvature. Setting the number of lenses closer to the object side than the aperture stop St to be four or less achieves an advantage in reduction of the total length of the lens system.

A positive lens is preferably disposed adjacent to the object side of the aperture stop St. Doing so achieves an advantage in favorably correcting the astigmatism generated in the lens closest to the object side.

In a case where the positive lens is disposed adjacent to the object side of the aperture stop St, an Lffn lens having a negative refractive power is preferably disposed adjacent to the object side of the positive lens disposed adjacent to the object side of the aperture stop St. That is, the Lffn lens having a negative refractive power, the positive lens, and the aperture stop St are preferably disposed in consecutive order from the object side to the image side. Consecutively disposing the negative lens and the positive lens disposed adjacent to the object side of the aperture stop St achieves an advantage in favorably correcting an axial chromatic aberration and a lateral chromatic aberration. In the example in FIG. 1, the Lffn lens corresponds to the lens L13.

A positive lens is preferably disposed adjacent to the image side of the aperture stop St. Doing so achieves an advantage in favorably correcting a residual astigmatism generated in a group consisting of all lenses closer to the object side than the aperture stop St.

One or more and three or fewer negative lenses and two or more and four or fewer positive lenses are preferably disposed closer to the image side than the aperture stop St, and the number of lenses disposed closer to the image side than the aperture stop St is preferably seven or less. Doing so maintains a balance between the number of positive lenses and the number of negative lenses and thus, facilitates maintaining a balance in correction between the field curvature and the chromatic aberration. This achieves an advantage in maintaining high performance. In addition, setting the number of lenses closer to the image side than the aperture stop St to be seven or less achieves an advantage in reduction of the total length of the lens system.

The imaging lens of the present disclosure may be configured to include an aspherical lens. In the disclosed technology, a radius of a circle passing through three points consisting of a point of a lens surface on the optical axis and two points of the lens surface at most outer ends of an effective diameter in a cross section including the optical axis Z will be referred to as Rc of the lens surface. For a lens surface having a spherical shape, Rc denotes a curvature radius of the lens surface. For a lens surface having an aspherical shape, Rc denotes an approximate curvature radius described below.

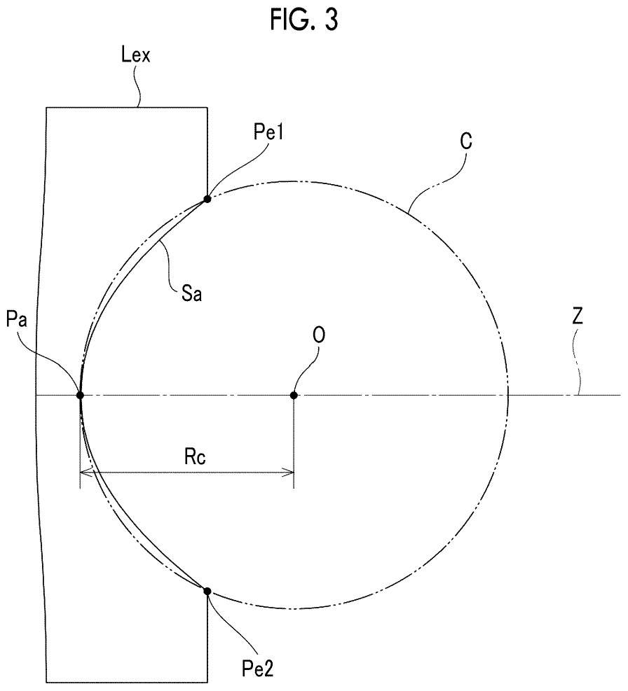

The approximate curvature radius will be described with reference to FIG. 3. FIG. 3 is a diagram for description and is a diagram illustrating a cross section including the optical axis Z. A lens surface Sa of a lens Lex illustrated in FIG. 3 on a right side of the drawing has an aspherical shape. FIG. 3 illustrates three points including a point Pa of the lens surface Sa on the optical axis, a point Pe1 of the lens surface Sa at a most outer end of an effective diameter on an upper side of the drawing, and a point Pe2 of the lens surface Sa at a most outer end of the effective diameter on a lower side of the drawing. A circle C passing through these three points is illustrated by a double-dot-dashed line.

In the disclosed technology, a radius of the circle C passing through the three points is an approximate curvature radius of the lens surface Sa and is illustrated in FIG. 3 as a radius Rc. A sign of the radius Rc is positive in a case where the point Pa on the optical axis is closer to the object side than a center O of the circle C, and is negative in a case where the point Pa on the optical axis is closer to the image side than the center O of the circle C. Similarly, a sign of Rc of the lens surface having a spherical shape is positive in a case where the point of the lens surface on the optical axis is closer to the object side than the center O of the circle passing through the three points, and is negative in a case where the point of the lens surface on the optical axis is closer to the image side than the center O of the circle.

The term “point at the most outer end of the effective diameter” of the lens surface means an intersection between the lens surface and a ray passing through a most outer side of the lens surface among rays used for image forming. The term “outer side” means an outer side in a diameter direction centered on the optical axis Z, that is, a side away from the optical axis Z. For example, in a case where a lower ray 3b is the ray passing through the most outer side on the lens surface closest to the object side in the drawing in the upper part of FIG. 2, an intersection between the lower ray 3b and the lens surface is the point at the outermost end of the effective diameter. A height of the most outer end point of the effective diameter from the optical axis Z is an effective radius, and twice the effective radius is the effective diameter.

The third lens group G3 preferably includes an aspherical lens. In this case, the number of aspherical lenses, included in the third lens group G3, of which a lens surface on the object side has an aspherical shape and of which a sign of Rc of the lens surface on the object side is negative is preferably one or two. Doing so achieves an advantage in compatibility between achieving of a wide angle and reduction in size. In addition, using the aspherical lens facilitates optimization of a curve of a distortion.

The first lens group G1 preferably includes, in consecutive order from a position closest to the object side to the image side, a negative partial group Gln and one positive lens. The negative partial group Gln consists of one or two negative lenses having the same sign of Rc of a lens surface on the object side and Rc of a lens surface on the image side. At least one lens surface included in the negative partial group Gln has an aspherical shape. Such a configuration achieves an advantage in correcting the distortion and the lateral chromatic aberration.

For example, the negative partial group Gln of the imaging lens in FIG. 1 consists of one lens that is the lens L11 having a negative meniscus shape. Both of a lens surface of the lens L11 on the object side and a lens surface of the lens L11 on the image side have positive Rc, and both of the lens surface of the lens L11 on the object side and the lens surface of the lens L11 on the image side have aspherical shapes.

The imaging lens of the present disclosure preferably includes at least one lens surface having an inflection point. The inflection point is a point at which a surface shape changes from a convex shape to a concave shape or a point at which a surface shape changes from a concave shape to a convex shape, that is, a point at which a sign of a curvature radius changes. Causing the lens surface to have the inflection point enables a refractive power in an edge part of the lens to be determined independently of a refractive power in a paraxial region.

The imaging lens preferably includes a lens surface having the inflection point, and at least one intersection between the lens surface having the inflection point and the optical axis Z is preferably a specific intersection described below. A distance on the optical axis from a lens surface of the first lens group G1 closest to the object side to a lens surface of the third lens group G3 closest to the image side is denoted by DL. The specific intersection is an intersection between the lens surface having the inflection point and the optical axis Z and is a point within a range of 0.3×DL from an intersection between the lens surface of the first lens group G1 closest to the object side and the optical axis Z to the image side or a range of 0.3×DL from an intersection between the lens surface of the third lens group G3 closest to the image side and the optical axis Z to the object side, in the state where the infinite distance object is in focus. In the present specification, the term “range from . . . to . . . ” means a range including a part corresponding to “ . . . ”. Since luminous fluxes of each angle of view are separated on a lens surface close to the object side and on a lens surface close to the image side, providing the surfaces with the inflection point facilitates effective correction of the aberrations such as the field curvature while favorably correcting a spherical aberration.

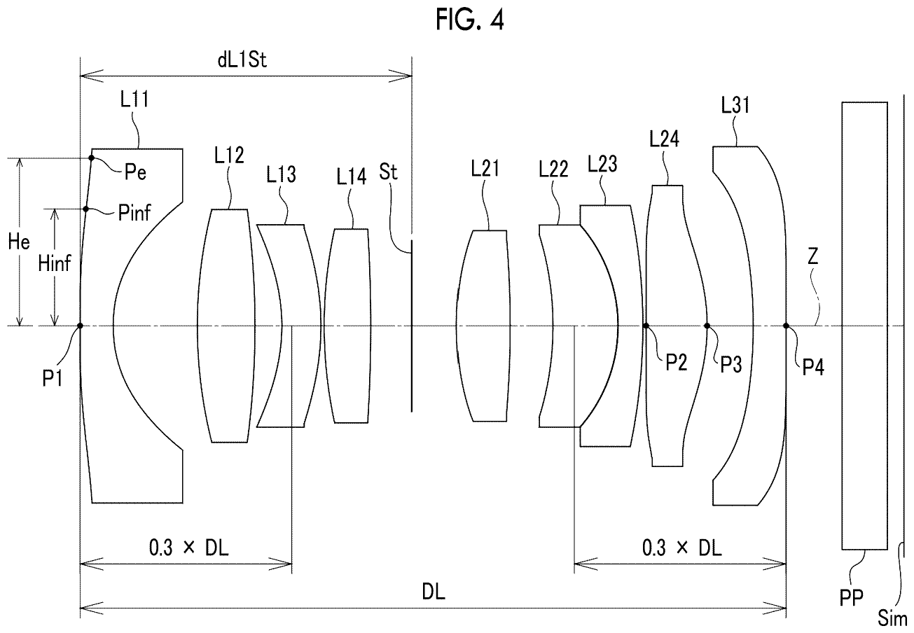

For example, FIG. 4 illustrates a cross-sectional view of the imaging lens in FIG. 1 and illustrates the distance DL in the imaging lens. FIG. 4 also illustrates the range of 0.3×DL from the intersection between the lens surface of the first lens group G1 closest to the object side and the optical axis Z to the image side and the range of 0.3×DL from the intersection between the lens surface of the third lens group G3 closest to the image side and the optical axis Z to the object side. In the example in FIG. 4, the surface of the lens L11 on the object side, a surface of the lens L21 on the image side, a surface of the lens L24 on the object side, a surface of the lens L24 on the image side, and a surface of the lens L31 on the image side have the inflection point. Intersections between the optical axis Z and four surfaces consisting of the surface of the lens L11 on the object side, the surface of the lens L24 on the object side, the surface of the lens L24 on the image side, and the surface of the lens L31 on the image side are specific intersections P1, P2, P3, and P4. An intersection between the surface of the lens L21 on the image side and the optical axis Z falls outside the ranges and thus, is not the specific intersection.

Hereinafter, preferable configurations of the imaging lens of the present disclosure related to conditional expressions will be described. In the following description of the conditional expressions, in order to avoid redundancy, the same symbol will be used for the same definition to omit duplicate descriptions of the symbol. Hereinafter, the “imaging lens of the present disclosure” will be simply referred to as the “imaging lens” in order to avoid redundancy.

The imaging lens preferably satisfies Conditional Expression (1). A sum of a back focus of an entire system as an air conversion distance and a distance on the optical axis from the lens surface of the first lens group G1 closest to the object side to the lens surface of the third lens group G3 closest to the image side is denoted by TL. A maximum image height is denoted by Y. For example, FIG. 2 illustrates the maximum image height Y. Ensuring that a corresponding value of Conditional Expression (1) is not less than or equal to its lower limit value achieves an advantage in securing the number of lenses required for aberration correction. Ensuring that the corresponding value of Conditional Expression (1) is not greater than or equal to its upper limit value facilitates reduction in size.

$$1 < TL / Y < 4.5 \qquad ( 1 )$$

In order to obtain more favorable characteristics, the lower limit value of Conditional Expression (1) is more preferably 1.1, further preferably 1.2, and further preferably 1.3. In order to obtain more favorable characteristics, the upper limit value of Conditional Expression (1) is more preferably 4.3, further preferably 4.2, and further preferably 4.1.

The imaging lens preferably satisfies Conditional Expression (2). A focal length of the entire system in the state where the infinite distance object is in focus is denoted by f. A maximum half angle of view in the state where the infinite distance object is in focus is denoted by ωm. For example, FIG. 2 illustrates the maximum half angle of view ωm. Here, tan denotes a tangent. Ensuring that a corresponding value of Conditional Expression (2) is not less than or equal to its lower limit value can reduce a barrel distortion. This facilitates maintaining image quality deterioration after image processing correction at an allowable level in a case where image processing is performed on an image obtained by imaging via the imaging lens. Ensuring that the corresponding value of Conditional Expression (2) is not greater than or equal to its upper limit value lowers an image height position with respect to an incidence angle and thus, can reduce a lens diameter. This achieves an advantage in reduction of the entire optical system in size.

$$- 0.18 < ( Y - f \times tan ω m ) / ( f \times tan ω m ) < - 0.02 \qquad ( 2 )$$

In order to obtain more favorable characteristics, the lower limit value of Conditional Expression (2) is more preferably −0.175, further preferably −0.16, further preferably −0.145, and further preferably −0.14. In order to obtain more favorable characteristics, the upper limit value of Conditional Expression (2) is more preferably −0.03, further preferably −0.04, further preferably −0.05, and further preferably −0.06.

The imaging lens preferably satisfies Conditional Expression (3). Here, ωm is in degree units. Ensuring that a corresponding value of Conditional Expression (3) is not less than or equal to its lower limit value increases an added value as an ultra-wide angle lens system. Ensuring that the corresponding value of Conditional Expression (3) is not greater than or equal to its upper limit value facilitates compatibility between reduction of a filter diameter and favorable optical performance.

$$47 < ω m < 60 \qquad ( 3 )$$

In order to obtain more favorable characteristics, the lower limit value of Conditional Expression (3) is more preferably 48, further preferably 49, further preferably 50, and further preferably 51. In order to obtain more favorable characteristics, the upper limit value of Conditional Expression (3) is more preferably 59, further preferably 58, further preferably 57, and further preferably 56.

In a case where a focal length of the first lens group G1 is denoted by fG1, the imaging lens preferably satisfies Conditional Expression (4). Ensuring that a corresponding value of Conditional Expression (4) is not less than or equal to its lower limit value facilitates reduction of the total length of the lens system and thus, achieves an advantage in reduction in size. Ensuring that the corresponding value of Conditional Expression (4) is not greater than or equal to its upper limit value facilitates achieving of a wide angle.

$$0.01 < f / fG 1 < 1.6 \qquad ( 4 )$$

In order to obtain more favorable characteristics, the upper limit value of Conditional Expression (4) is more preferably 1.55 and further preferably 1.5.

The imaging lens preferably satisfies Conditional Expression (5). A distance on the optical axis from the lens surface of the first lens group G1 closest to the object side to the aperture stop St in the state where the infinite distance object is in focus is denoted by dL1St. For example, FIG. 4 illustrates the distance dL1St. Ensuring that a corresponding value of Conditional Expression (5) is not less than or equal to its lower limit value achieves an advantage in reduction of the incidence angle of an off-axis principal ray on the image plane Sim. Ensuring that the corresponding value of Conditional Expression (5) is not greater than or equal to its upper limit value achieves an advantage in reduction of the total length of the lens system.

$$0.1 < d L 1 St / Y < 2.1 \qquad ( 5 )$$

In order to obtain more favorable characteristics, the lower limit value of Conditional Expression (5) is more preferably 0.2 and further preferably 0.3. In order to obtain more favorable characteristics, the upper limit value of Conditional Expression (5) is more preferably 1.9 and further preferably 1.7.

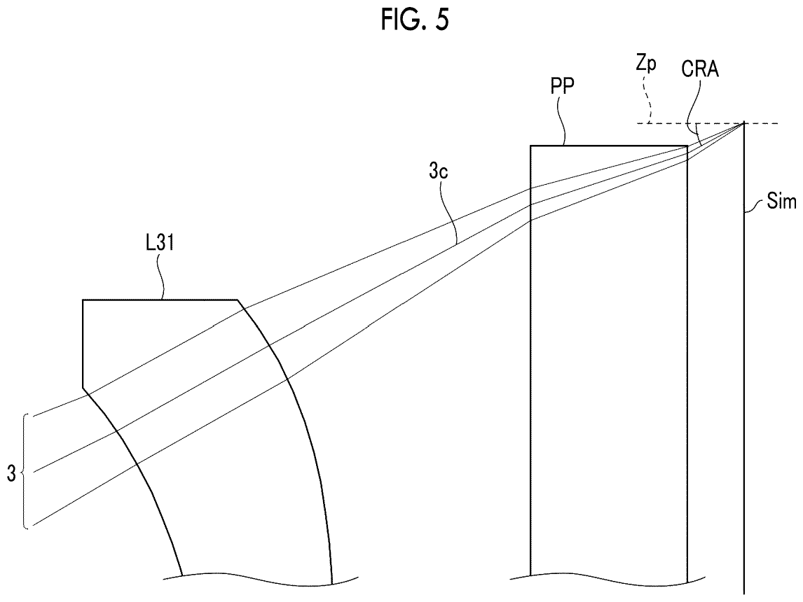

The imaging lens preferably satisfies Conditional Expression (6). An angle between an axis line parallel to the optical axis Z and a principal ray of the maximum image height incident on the image plane Sim in the state where the infinite distance object is in focus is denoted by CRA. CRA is in degree units. FIG. 5 illustrates a partial enlarged view including upper portions of each of the lens L31, the optical member PP, and the image plane Sim of the imaging lens in FIG. 1. For example, FIG. 5 illustrates the angle CRA. In FIG. 5, a principal ray 3c of the maximum half angle of view ωm incident on the image plane Sim is illustrated by a solid line, and an axis line Zp that passes parallel to the optical axis Z through an intersection between the principal ray 3c and the image plane Sim is illustrated by a broken line. The principal ray 3c of the maximum half angle of view ωm corresponds to the principal ray of the maximum image height. Ensuring that a corresponding value of Conditional Expression (6) is not less than or equal to its lower limit value can reduce a distance from the aperture stop St to the image plane Sim and thus, achieves an advantage in reduction of the total length of the lens system. Ensuring that the corresponding value of Conditional Expression (6) is not greater than or equal to its upper limit value can increase the back focus and thus, facilitates insertion of various filters such as an infrared cut filter.

$$16 < \vert CRA \vert < 69 \qquad ( 6 )$$

In order to obtain more favorable characteristics, the lower limit value of Conditional Expression (6) is more preferably 18 and further preferably 20. In order to obtain more favorable characteristics, the upper limit value of Conditional Expression (6) is more preferably 67 and further preferably 65.

In a case where the back focus of the entire system as the air conversion distance is denoted by Bf, the imaging lens preferably satisfies Conditional Expression (7). The back focus Bf of the entire system as the air conversion distance is an air conversion distance on the optical axis from a lens surface of the imaging lens closest to the image side to the image plane Sim. Ensuring that a corresponding value of Conditional Expression (7) is not less than or equal to its lower limit value facilitates insertion of various filters such as an infrared cut filter. Ensuring that the corresponding value of Conditional Expression (7) is not greater than or equal to its upper limit value achieves an advantage in securing the number of lenses required for aberration correction.

$$0.06 < Bf / TL < 0.3 \qquad ( 7 )$$

In order to obtain more favorable characteristics, the lower limit value of Conditional Expression (7) is more preferably 0.08 and further preferably 0.1. In order to obtain more favorable characteristics, the upper limit value of Conditional Expression (7) is more preferably 0.28 and further preferably 0.26.

The imaging lens preferably satisfies Conditional Expression (8). Here, f is in millimeter (mm) units. An open F-number of the imaging lens in the state where the infinite distance object is in focus is denoted by Fno. Ensuring that a corresponding value of Conditional Expression (8) is not less than or equal to its lower limit value can secure brightness that can maintain marketability. Ensuring that the corresponding value of Conditional Expression (8) is not greater than or equal to its upper limit value achieves an advantage in compatibility between maintaining of high performance and securing of required brightness.

$$1.7 < f / Fno < 4.1 \qquad ( 8 )$$

In order to obtain more favorable characteristics, the lower limit value of Conditional Expression (8) is more preferably 1.8 and further preferably 1.9. In order to obtain more favorable characteristics, the upper limit value of Conditional Expression (8) is more preferably 3.9 and further preferably 3.7.

In a case where a focal length of the second lens group G2 is denoted by fG2, the imaging lens preferably satisfies Conditional Expression (9). Ensuring that a corresponding value of Conditional Expression (9) is not less than or equal to its lower limit value can secure a required refractive power of the second lens group G2 and thus, can reduce a moving amount during the focusing. This achieves an advantage in reduction of the lens system in size. Ensuring that the corresponding value of Conditional Expression (9) is not greater than or equal to its upper limit value can suppress fluctuation of the aberrations during the focusing, and this can suppress fluctuation of optical performance in a case where the object distance fluctuates.

$$0.24 < \vert f / fG 2 \vert < 2.4 \qquad ( 9 )$$

In order to obtain more favorable characteristics, the lower limit value of Conditional Expression (9) is more preferably 0.26 and further preferably 0.28. In order to obtain more favorable characteristics, the upper limit value of Conditional Expression (9) is more preferably 2.2 and further preferably 2.

In the configuration in which the positive lens is disposed adjacent to the image side of the aperture stop St, the imaging lens preferably satisfies Conditional Expression (10). An Abbe number based on a d line for the positive lens disposed adjacent to the image side of the aperture stop St is denoted by vrp. Satisfying Conditional Expression (10) facilitates correction of the lateral chromatic aberration and the axial chromatic aberration.

$$34 < ν rp < 87 \qquad ( 10 )$$

In order to obtain more favorable characteristics, the lower limit value of Conditional Expression (10) is more preferably 36 and further preferably 38. In order to obtain more favorable characteristics, the upper limit value of Conditional Expression (10) is more preferably 85 and further preferably 83.

In the configuration in which the positive lens is disposed adjacent to the object side of the aperture stop St, the imaging lens preferably satisfies Conditional Expression (11). An Abbe number based on a d line for the positive lens disposed adjacent to the object side of the aperture stop St is denoted by vfp. Satisfying Conditional Expression (11) facilitates correction of the lateral chromatic aberration and the axial chromatic aberration.

$$23 < vfp < 61 \qquad ( 11 )$$

In order to obtain more favorable characteristics, the lower limit value of Conditional Expression (11) is more preferably 25 and further preferably 27. In order to obtain more favorable characteristics, the upper limit value of Conditional Expression (11) is more preferably 59 and further preferably 57.

In the configuration in which the positive lens is disposed adjacent to the object side of the aperture stop St, and the Lffn lens having a negative refractive power is disposed adjacent to the object side of the positive lens, the imaging lens preferably satisfies Conditional Expression (12). An Abbe number based on a d line for the Lffn lens is denoted by vffn. Satisfying Conditional Expression (12) facilitates correction of the lateral chromatic aberration and the axial chromatic aberration.

$$16 < vffn < 100 \qquad ( 12 )$$

In order to obtain more favorable characteristics, the lower limit value of Conditional Expression (12) is more preferably 17, further preferably 18, and further preferably 35. In order to obtain more favorable characteristics, the upper limit value of Conditional Expression (12) is more preferably 98, further preferably 96, and further preferably 45.

In the configuration in which the first lens group G1 includes, in consecutive order from the position closest to the object side to the image side, the negative partial group Gln and one positive lens, the imaging lens preferably satisfies Conditional Expression (13). An average value of refractive indices with respect to a d line for all lenses included in the negative partial group Gln is denoted by N1nave. Ensuring that a corresponding value of Conditional Expression (13) is not less than or equal to its lower limit value facilitates obtaining a required refractive power without reducing an absolute value of a curvature radius of a lens surface, on the image side, of a lens included in the negative partial group Gln. Thus, since the absolute value of the curvature radius of the lens surface on the image side can be increased, workability can be improved. Ensuring that the corresponding value of Conditional Expression (13) is not greater than or equal to its upper limit value can suppress a decrease in transmittance.

$$1.45 < N 1 nave < 2.3 \qquad ( 13 )$$

In order to obtain more favorable characteristics, the lower limit value of Conditional Expression (13) is more preferably 1.5 and further preferably 1.55. In order to obtain more favorable characteristics, the upper limit value of Conditional Expression (13) is more preferably 2.2 and further preferably 2.1.

In the configuration in which the first lens group G1 includes, in consecutive order from the position closest to the object side to the image side, the negative partial group Gln and one positive lens, the imaging lens preferably satisfies Conditional Expression (14). An average value of Abbe numbers based on the d line for all lenses included in the negative partial group Gln is denoted by ν1nave. Ensuring that a corresponding value of Conditional Expression (14) is not less than or equal to its lower limit value facilitates correction of the lateral chromatic aberration. Ensuring that the corresponding value of Conditional Expression (14) is not greater than or equal to its upper limit value can suppress use of a soft material susceptible to scratches and thus, achieves an advantage in improving exterior quality.

$$16 < v 1 nave < 85 \qquad ( 14 )$$

In order to obtain more favorable characteristics, the lower limit value of Conditional Expression (14) is more preferably 17, further preferably 18, and further preferably 25. In order to obtain more favorable characteristics, the upper limit value of Conditional Expression (14) is more preferably 82, further preferably 72, and further preferably 35.

In the configuration in which the first lens group G1 includes, in consecutive order from the position closest to the object side to the image side, the negative partial group Gln and one positive lens, the imaging lens more preferably satisfies Conditional Expressions (13) and (14) at the same time.

The imaging lens preferably satisfies Conditional Expression (15). A combined focal length of all lenses closer to the object side than the aperture stop St in the state where the infinite distance object is in focus is denoted by fGf. A combined focal length of all lenses closer to the image side than the aperture stop St in the state where the infinite distance object is in focus is denoted by fGr. Ensuring that a corresponding value of Conditional Expression (15) is not less than or equal to its lower limit value achieves an advantage in maintaining a favorable balance between a refractive power of the aperture stop St on the object side and a refractive power of the aperture stop St on the image side, and facilitates securing of the back focus. Ensuring that the corresponding value of Conditional Expression (15) is not greater than or equal to its upper limit value achieves an advantage in maintaining a favorable balance between the refractive power of the aperture stop St on the object side and the refractive power of the aperture stop St on the image side, and facilitates correction of the barrel distortion.

$$- 10 < fGf / fGr < 31 \qquad ( 15 )$$

In order to obtain more favorable characteristics, the lower limit value of Conditional Expression (15) is more preferably −8, further preferably −6, and further preferably 1.7. In order to obtain more favorable characteristics, the upper limit value of Conditional Expression (15) is more preferably 29, further preferably 27, and further preferably 6.

In the configuration having the specific intersection, at least one lens surface having the specific intersection preferably satisfies Conditional Expression (16). The term “lens surface having the specific intersection” means a lens surface for which an intersection between the lens surface and the optical axis Z is the specific intersection. A refractive power of the lens surface having the specific intersection is denoted by pa. A refractive power of the imaging lens in the state where the infinite distance object is in focus is denoted by q. Here, q=1/f is established. Satisfying Conditional Expression (16) prevents an excessively strong refractive power of the lens surface having the specific intersection and the inflection point and thus, can suppress excessively high processing sensitivity and excessively high sensitivity during assembly. This also achieves an advantage in favorably correcting the spherical aberration, the field curvature, and the like.

$$- 2 < φ a / φ < 3 \qquad ( 16 )$$

In a case where a refractive index of a medium of a lens surface on an incidence side is denoted by Nin, a refractive index of a medium of the lens surface on an emission side is denoted by Nout, and a curvature radius of the lens surface is denoted by R, the refractive power pa of the lens surface is represented by φa=(Nout−Nin)/R.

In order to obtain more favorable characteristics, the lower limit value of Conditional Expression (16) is more preferably −1 and further preferably −0.8. In order to obtain more favorable characteristics, the upper limit value of Conditional Expression (16) is more preferably 2.5 and further preferably 2.2.

In the configuration having the specific intersection, at least one lens surface having the specific intersection preferably satisfies Conditional Expression (17). For each lens surface, a height of the inflection point from the optical axis Z is denoted by Hinf, and a height of the point at the most outer end of the effective diameter from the optical axis Z is denoted by He. Hinf and He have positive values. As described above, He corresponds to the effective radius. In a case where one lens surface has a plurality of inflection points, at least one inflection point may satisfy Conditional Expression (17). For example, FIG. 4 illustrates an inflection point Pinf, the height Hinf, a point Pe at the most outer end of the effective diameter, and the height He with respect to the lens surface of the lens L11 on the object side. Ensuring that a corresponding value of Conditional Expression (17) is not less than or equal to its lower limit value can provide the inflection point at a position away from the optical axis Z and thus, achieves an advantage in effectively correcting the field curvature while favorably correcting the spherical aberration. Ensuring that the corresponding value of Conditional Expression (17) is not greater than or equal to its upper limit value achieves an advantage in correcting the field curvature.

$$0.3 < Hinf / He < 0.99 \qquad ( 17 )$$

In order to obtain more favorable characteristics, the lower limit value of Conditional Expression (17) is more preferably 0.4 and further preferably 0.55. In order to obtain more favorable characteristics, the upper limit value of Conditional Expression (17) is more preferably 0.98.

The imaging lens preferably satisfies Conditional Expression (18). Ensuring that a corresponding value of Conditional Expression (18) is not less than or equal to its lower limit value achieves an advantage in securing the number of lenses required for aberration correction. Ensuring that the corresponding value of Conditional Expression (18) is not greater than or equal to its upper limit value facilitates reduction in size.

$$1 < TL / f < 6 \qquad ( 18 )$$

In order to obtain more favorable characteristics, the lower limit value of Conditional Expression (18) is more preferably 1.25 and further preferably 1.5. In order to obtain more favorable characteristics, the upper limit value of Conditional Expression (18) is more preferably 5.5 and further preferably 5.1.

The imaging lens preferably satisfies Conditional Expression (19). Satisfying Conditional Expression (19) achieves an advantage in suppressing occurrence of the aberrations and also achieves an advantage in reduction of the incidence angle of the off-axis principal ray on the image plane Sim.

$$- 1.1 < f / fGf < 1.3 \qquad ( 19 )$$

In order to obtain more favorable characteristics, the lower limit value of Conditional Expression (19) is more preferably −0.9 and further preferably −0.7. In order to obtain more favorable characteristics, the upper limit value of Conditional Expression (19) is more preferably 1.1 and further preferably 0.9.

The imaging lens preferably satisfies Conditional Expression (20). Satisfying Conditional Expression (20) achieves an advantage in suppressing occurrence of the aberrations and also achieves an advantage in reduction of the incidence angle of the off-axis principal ray on the image plane Sim.

$$- 0.4 < f / fGf < 1.4 \qquad ( 20 )$$

In order to obtain more favorable characteristics, the lower limit value of Conditional Expression (20) is more preferably −0.2 and further preferably 0. In order to obtain more favorable characteristics, the upper limit value of Conditional Expression (20) is more preferably 1.2 and further preferably 1.

The imaging lens preferably satisfies Conditional Expression (21). An average value of Abbe numbers based on a d line for all negative lenses closer to the object side than the aperture stop St is denoted by vGfaven. An average value of Abbe numbers based on a d line for all positive lenses closer to the object side than the aperture stop St is denoted by vGfavep. Conditional Expression (21) is a conditional expression for favorably correcting the chromatic aberration in an entire wavelength range of a visible range. Ensuring that a corresponding value of Conditional Expression (21) is not less than or equal to its lower limit value can increase a correction effect for a residual second-order spectrum. Ensuring that the corresponding value of Conditional Expression (21) is not greater than or equal to its upper limit value can increase a correction effect for a first-order chromatic aberration.

$$0.6 < \vert vGfaven - vGfavep \vert < 47 \qquad ( 21 )$$

In order to obtain more favorable characteristics, the lower limit value of Conditional Expression (21) is more preferably 0.8, further preferably 1, and further preferably 6. In order to obtain more favorable characteristics, the upper limit value of Conditional Expression (21) is more preferably 45, further preferably 43, and further preferably 30.

The imaging lens preferably satisfies Conditional Expression (22). An average value of Abbe numbers based on a d line for all negative lenses closer to the image side than the aperture stop St is denoted by vGraven. An average value of Abbe numbers based on a d line for all positive lenses closer to the image side than the aperture stop St is denoted by vGravep. Conditional Expression (22) is a conditional expression for favorably correcting the chromatic aberration in the entire wavelength range of the visible range. Ensuring that a corresponding value of Conditional Expression (22) is not less than or equal to its lower limit value can increase the correction effect for the residual second-order spectrum. Ensuring that the corresponding value of Conditional Expression (22) is not greater than or equal to its upper limit value can increase the correction effect for the first-order chromatic aberration.

$$4 < \vert vGraven - vGravep \vert < 52 \qquad ( 22 )$$

In order to obtain more favorable characteristics, the lower limit value of Conditional Expression (22) is more preferably 6, further preferably 8, and further preferably 30. In order to obtain more favorable characteristics, the upper limit value of Conditional Expression (22) is more preferably 50, further preferably 49, and further preferably 48.

The imaging lens preferably satisfies Conditional Expression (23). Ensuring that a corresponding value of Conditional Expression (23) is not less than or equal to its lower limit value facilitates maintaining of high performance and also facilitates reduction in size. Ensuring that the corresponding value of Conditional Expression (23) is not greater than or equal to its upper limit value facilitates compatibility between securing of a small F-number and achieving of a wide angle.

$$0.8 < Fno / tan ω m < 3.2 \qquad ( 23 )$$

In order to obtain more favorable characteristics, the lower limit value of Conditional Expression (23) is more preferably 1 and further preferably 1.2. In order to obtain more favorable characteristics, the upper limit value of Conditional Expression (23) is more preferably 3 and further preferably 2.8.

In a case where a focal length of the third lens group G3 is denoted by fG3, the imaging lens preferably satisfies Conditional Expression (24). Ensuring that a corresponding value of Conditional Expression (24) is not less than or equal to its lower limit value can reduce the incidence angle of the off-axis principal ray on the image plane Sim and thus, can suppress an edge part light fall-off. Ensuring that the corresponding value of Conditional Expression (24) is not greater than or equal to its upper limit value facilitates suppression of the distortion.

$$- 2.4 < f / fG 3 < 1 \qquad ( 24 )$$

In order to obtain more favorable characteristics, the lower limit value of Conditional Expression (24) is more preferably −2.2 and further preferably −2. In order to obtain more favorable characteristics, the upper limit value of Conditional Expression (24) is more preferably 0.8 and further preferably 0.6.

The imaging lens preferably satisfies Conditional Expression (25). Conditional Expression (25) is an expression related to the second lens group G2 constituting the focus group. A lateral magnification of the second lens group G2 in the state where the infinite distance object is in focus is denoted by βfoc. A lateral magnification of the third lens group G3 in the state where the infinite distance object is in focus is denoted by βfocR. Ensuring that a corresponding value of Conditional Expression (25) is not less than or equal to its lower limit value can increase a moving amount of the image plane Sim with respect to a moving amount of the second lens group G2 in the optical axis direction and thus, can reduce the moving amount of the second lens group G2 during the focusing. This achieves an advantage in reduction of the total length of the lens system. Ensuring that the corresponding value of Conditional Expression (25) is not greater than or equal to its upper limit value can reduce the moving amount of the image plane Sim with respect to the moving amount of the second lens group G2 in the optical axis direction and thus, facilitates control during the focusing. This achieves an advantage in accurate focusing.

$$0.4 < \vert ( 1 - {β foc}^{2} ) \times {β foc R}^{2} \vert < 3.8 \qquad ( 25 )$$

In order to obtain more favorable characteristics, the lower limit value of Conditional Expression (25) is more preferably 0.45 and further preferably 0.5. In order to obtain more favorable characteristics, the upper limit value of Conditional Expression (25) is more preferably 3.6 and further preferably 3.4.

The imaging lens preferably satisfies Conditional Expression (26). Here, Y is in millimeter (mm) units. Ensuring that a corresponding value of Conditional Expression (26) is not less than or equal to its lower limit value facilitates securing of the number of pixels that can implement high resolution, as the number of pixels of an imaging element used in combination with the imaging lens. Ensuring that the corresponding value of Conditional Expression (26) is not greater than or equal to its upper limit value facilitates reduction in size.

$$2 < Y < 17 \qquad ( 26 )$$

In order to obtain more favorable characteristics, the lower limit value of Conditional Expression (26) is more preferably 3, further preferably 4, and further preferably 5. In order to obtain more favorable characteristics, the upper limit value of Conditional Expression (26) is more preferably 16, further preferably 15, and further preferably 8.

The example illustrated in FIG. 1 is merely an example, and various modifications can be made without departing from the gist of the disclosed technology. For example, the number of lenses included in each lens group may be different from the number in the example in FIG. 1. Signs of refractive powers of the second lens group G2 and the third lens group G3 may be different from those in the example in FIG. 1.

The imaging lens of the example in FIG. 1 consists of, in order from the object side to the image side, the first lens group G1 having a positive refractive power, the second lens group G2 having a positive refractive power, and the third lens group G3 having a negative refractive power. This refractive power disposition results in a telephoto-type lens system and thus, achieves an advantage in reduction in size.

As will be illustrated in an example described later, the imaging lens of the present disclosure may be configured to consist of, in order from the object side to the image side, the first lens group G1 having a positive refractive power, the second lens group G2 having a negative refractive power, and the third lens group G3 having a negative refractive power. This configuration also results in a telephoto-type lens system and thus, achieves an advantage in reduction in size.

As will be illustrated in another example described later, the imaging lens of the present disclosure may be configured to consist of, in order from the object side to the image side, the first lens group G1 having a positive refractive power, the second lens group G2 having a negative refractive power, and the third lens group G3 having a positive refractive power. Forming only the second lens group G2, which is the focus group, as a group having a negative refractive power can provide the second lens group G2 with a relatively strong refractive power and thus, facilitates reduction of a moving amount of the focus group during the focusing.

As will be illustrated in still another example described later, the imaging lens of the present disclosure may be configured to consist of, in order from the object side to the image side, the first lens group G1 having a positive refractive power, the second lens group G2 having a positive refractive power, and the third lens group G3 having a positive refractive power. Forming all lens groups as groups having a positive refractive power achieves an advantage in reduction in size.

In the imaging lens of the present disclosure, a lens surface having an aspherical shape may be a different surface from the example in FIG. 1. The aspherical shape may be formed through grinding processing or molding processing. A compound aspherical lens may also be used as a lens having an aspherical shape. A material of the lens may be glass or a resin.

In the imaging lens of the present disclosure, in order to correct the chromatic aberration, any lens group may be configured to have a lens of a type having a distributed refractive index, such as a gradient index lens (GRIN lens), or a diffractive optical element.

In the imaging lens of the present disclosure, an anti-reflection film may be applied in order to maintain transmittance in a wide wavelength range. The anti-reflection film may suppress reflection in an entire wavelength region to be used, or suppress reflection in only several wavelength ranges to be used by selecting the wavelength ranges. An anti-reflection film using a special coating configured to suppress reflection by forming a nano-level structure having a moth eye shape on a lens surface may be used.

The preferable configurations and available configurations described above can be combined in any manner without inconsistency and are preferably selectively adopted, as appropriate, in accordance with required specifications.

For example, according to a preferred aspect of the imaging lens of the present disclosure, the imaging lens consists of, in order from the object side to the image side, the first lens group G1 having a positive refractive power, the second lens group G2, and the third lens group G3, in which, during the focusing, the first lens group G1 and the third lens group G3 are fixed with respect to the image plane Sim, and the second lens group G2 moves along the optical axis Z, a lens closest to the object side is a negative meniscus lens, and at least one of a second lens from the object side or a third lens from the object side is a lens other than the negative meniscus lens, the aperture stop St is disposed closer to the image side than the second lens from the object side, and Conditional Expressions (1) and (2) are satisfied.

Next, examples of the imaging lens of the present disclosure will be described with reference to the drawings. Reference numerals provided to the lens groups and the lenses in the cross-sectional view of each example are independently used for each example in order to avoid complication of description and the drawings caused by an increasing number of digits of the reference numerals. Accordingly, even in a case where a common reference numeral is provided in the drawings of different examples, the common reference numeral does not necessarily indicate a common configuration.

### Example 1

A cross-sectional view of a configuration of the imaging lens of Example 1 is illustrated in FIG. 1, and its illustration method and configuration are the same as described above. Thus, duplicate descriptions will be partially omitted. The imaging lens of Example 1 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

For the imaging lens of Example 1, Table 1 shows basic lens data, Table 2 shows specifications, Table 3 shows a variable surface spacing during the focusing, and Tables 4A and 4B show aspherical coefficients.

The table of the basic lens data is described as follows. A column of “Sn” shows surface numbers in a case where the number is increased by one at a time toward the image side from a surface closest to the object side as a first surface. A column of “R” shows a curvature radius of each surface. A column of “D” shows a surface spacing on the optical axis between each surface and its adjacent surface on the image side. A column of “Nd” shows a refractive index with respect to a d line for each lens. A column of “vd” shows an Abbe number based on the d line for each lens. A column of “ED” shows an effective diameter of each surface. A half value of the effective diameter corresponds to the height He of the point at the most outer end of the effective diameter from the optical axis Z. A column of “Hinf” shows the height of the inflection point from the optical axis Z for each surface having the inflection point. For a surface having a plurality of inflection points, the column of “Hinf” shows values related to each inflection point separated by “/”. For a surface having the inflection point and not having the specific intersection, the column of “Hinf” shows a value in parentheses for reference.

In the table of the basic lens data, a sign of the curvature radius of the surface having a convex shape facing the object side is positive, and a sign of the curvature radius of the surface having a convex shape facing the image side is negative. A field of the surface number of the surface corresponding to the aperture stop St has the surface number and a text (St). The table of the basic lens data also shows the optical member PP. A value in a lowermost field of the column of D in the table indicates a spacing between a surface closest to the image side in the table and the image plane Sim. A symbol DD [ ] is used for the variable surface spacing during the focusing. A surface number on the object side of the spacing is provided in [ ] in the column of the surface spacing.

Table 2 shows the focal length f, the back focus Bf as the air conversion distance, the open F-number Fno, and a maximum full angle of view 2om of the entire system based on a d line. In a field of the maximum full angle of view, [°] indicates a degree unit. Table 2 shows values in the state where the infinite distance object is in focus.

In Table 3, a column of “Infinite Distance” shows the variable surface spacing in the state where the infinite distance object is in focus. An uppermost field of a rightmost column shows the object distance of the nearest object, and the column below the uppermost field shows the variable surface spacing in the state where the nearest object is in focus. For example, in Example 1, the object distance of the nearest object is 0.150 meters (m).

In the basic lens data, a surface number of an aspherical surface is marked with *, and a numerical value of a paraxial curvature radius is shown in a field of the curvature radius of the aspherical surface. In Tables 4A and 4B, the column of Sn shows the surface number of the aspherical surface, and columns of KA and Am (m=3, 4, 5, . . . , 20) show numerical values of the aspherical coefficients for each aspherical surface. In the numerical values of the aspherical coefficients in Tables 4A and 4B, “E±n” (n: integer) means “×10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + Σ A m \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Z)
h: a height (a distance from the optical axis Z to the lens surface)
C: a reciprocal of the paraxial curvature radius
KA and Am: aspherical coefficients
Σ in the aspheric equation means a sum total related to m.

In the data of each table, a degree unit is used for angles, and a millimeter (mm) unit is used for lengths other than the object distance. However, since the optical system can also be proportionally enlarged or proportionally reduced to be used, other appropriate units can also be used. Numerical values rounded to predetermined digits are described in each table shown below.

TABLE 1
Example 1

| Sn | R | D | Nd | vd | ED | Hinf |
|---|---|---|---|---|---|---|
| *1 | 915.7538 | 1.0071 | 1.68948 | 31.02 | 10.99 | 3.83 |
| *2 | 4.5853 | 2.5594 | | | 7.72 | |
| 3 | 15.1597 | 1.7544 | 1.85025 | 30.05 | 7.24 | |
| 4 | −27.9262 | 0.8164 | | | 6.66 | |
| *5 | −5.8277 | 1.1892 | 1.85135 | 40.10 | 6.30 | |
| *6 | −8.2465 | 0.0998 | | | 6.08 | |
| 7 | 14.4808 | 1.4151 | 1.67790 | 55.35 | 5.94 | |
| 8 | −50.3582 | 1.2504 | | | 5.78 | |
| 9 (St) | ∞ | DD[9] | | | | |
| *10 | 9.6381 | 1.6270 | 1.80139 | 45.45 | 5.22 | |
| *11 | −32.9640 | 1.3025 | | | 5.41 | (2.64) |
| 12 | −9.8080 | 1.9825 | 1.43875 | 94.66 | 5.66 | |
| 13 | −4.8635 | 0.7500 | 1.95906 | 17.47 | 6.28 | |
| 14 | −18.6329 | 0.1001 | | | 6.29 | |
| *15 | −2243.6411 | 1.8566 | 1.80139 | 45.45 | 7.48 | 0.14/0.79/ |
| | | | | | | 1.48/3.88 |
| *16 | −6.2256 | DD[16] | | | 8.28 | 2.54/4.18 |
| *17 | −15.8604 | 1.0000 | 1.68948 | 31.02 | 8.69 | |
| *18 | 4300.9086 | 1.7041 | | | 9.50 | 0.77 |
| 19 | ∞ | 1.3800 | 1.51680 | 64.20 | 11.03 | |
| 20 | ∞ | 0.4982 | | | | |

TABLE 2
Example 1

| | |
|---|---|
| f | 5.94 |
| Bf | 3.11 |
| Fno | 1.85 |
| 2ωm [°] | 108.0 |

TABLE 3
Example 1

| | Infinite Distance | 0.150 m |
|---|---|---|
| DD[9] | 1.3500 | 1.1775 |
| DD[16] | 1.4013 | 1.5738 |

TABLE 4A
Example 1

| Sn | 1 | 2 | 5 | 6 |
|---|---|---|---|---|
| KA | 2.3473177E+04 | −1.5524803E−01 | −2.4135065E−01 | −2.5052272E−01 |
| A3 | 0.0000000E+00 | 2.1180994E−18 | −1.2263905E−18 | 5.2111364E−18 |
| A4 | 4.7051079E−03 | 8.4114458E−03 | 5.3613943E−04 | 3.2142703E−04 |
| A5 | −1.0208504E−03 | −2.3378951E−03 | 8.7963762E−05 | 9.8334546E−05 |
| A6 | −3.7508407E−04 | −5.6952439E−04 | −9.2777894E−06 | −8.2454919E−06 |
| A7 | 1.5861589E−04 | 5.4728912E−04 | −4.3879181E−07 | −6.5848847E−07 |
| A8 | 3.6095249E−06 | −6.2594429E−05 | 9.6103504E−08 | 9.1166688E−08 |
| A9 | −9.8740165E−06 | −4.7280013E−05 | 4.0729903E−09 | 4.8314152E−09 |
| A10 | 7.9382667E−07 | 1.1982247E−05 | −5.8541770E−10 | −5.9644917E−10 |
| A11 | 3.2079662E−07 | 1.9951401E−06 | −1.9785576E−11 | −2.2212623E−11 |
| A12 | −4.3132638E−08 | −8.0689918E−07 | 2.2059702E−12 | 2.4216990E−12 |
| A13 | −5.9305953E−09 | −3.8993510E−08 | 5.5451507E−14 | 6.2742622E−14 |
| A14 | 1.0264269E−09 | 2.9272797E−08 | −5.1983122E−15 | −6.1719661E−15 |
| A15 | 6.2943633E−11 | 1.4280036E−10 | −9.0708268E−17 | −1.0626938E−16 |
| A16 | −1.2957176E−11 | −6.0802699E−10 | 7.4527351E−18 | 9.6062760E−18 |
| A17 | −3.5762971E−13 | 5.7925960E−12 | 8.0443710E−20 | 9.9040283E−20 |
| A18 | 8.4507869E−14 | 6.8166469E−12 | −5.9412776E−21 | −8.3421623E−21 |
| A19 | 8.4375819E−16 | −6.0952233E−14 | −2.9895438E−23 | −3.9043925E−23 |
| A20 | −2.2438079E−16 | −3.2015596E−14 | 2.0182577E−24 | 3.0959944E−24 |
| Sn | 10 | 11 | 15 | 16 |
| KA | 2.0559658E−01 | 1.0577567E+01 | 2.6825670E+05 | −2.9508614E+00 |
| A3 | −1.7190421E−18 | 0.0000000E+00 | 0.0000000E+00 | 3.3152308E−19 |
| A4 | −7.9576875E−04 | −6.3640798E−04 | 2.2264519E−03 | 1.3007144E−03 |
| A5 | 9.1385497E−04 | −1.2552335E−04 | −6.7578200E−04 | −1.2225485E−03 |
| A6 | 5.5871339E−04 | 1.5415522E−03 | −2.6254273E−03 | −4.0542568E−04 |
| A7 | −7.3205617E−04 | −1.0901374E−03 | 1.6564457E−03 | 6.4124047E−04 |
| A8 | −7.4587546E−05 | −2.5180633E−04 | 4.1570904E−04 | −5.2337832E−05 |
| A9 | 2.6654281E−04 | 4.5539913E−04 | −4.9389098E−04 | −9.5086824E−05 |
| A10 | −2.1656454E−05 | −2.9581051E−05 | 5.9514438E−06 | 1.8331852E−05 |
| A11 | −4.8025945E−05 | −8.3047706E−05 | 6.7492071E−05 | 7.1440833E−06 |
| A12 | 7.3404623E−06 | 1.3260483E−05 | −7.4475562E−06 | −1.8284647E−06 |
| A13 | 4.7313829E−06 | 8.1408632E−06 | −5.0128201E−06 | −2.9427538E−07 |
| A14 | −8.5249758E−07 | −1.6278948E−06 | 8.1219880E−07 | 9.3529864E−08 |
| A15 | −2.6097800E−07 | −4.4483287E−07 | 2.0891913E−07 | 6.4391984E−09 |
| A16 | 4.8448705E−08 | 9.6355050E−08 | −4.0661728E−08 | −2.7004962E−09 |
| A17 | 7.5766241E−09 | 1.2748166E−08 | −4.5997755E−09 | −6.3975381E−11 |
| A18 | −1.3591768E−09 | −2.8183323E−09 | 1.0008199E−09 | 4.2179170E−11 |
| A19 | −9.0157218E−11 | −1.4922483E−10 | 4.1707762E−11 | 1.5720088E−13 |
| A20 | 1.5058027E−11 | 3.2669282E−11 | −9.7902128E−12 | −2.7871353E−13 |

TABLE 4B
Example 1

| Sn | 17 | 18 |
|---|---|---|
| KA | −2.1431588E−01 | −3.9299486E+09 |
| A3 | 1.9849426E−17 | 1.5041072E−18 |
| A4 | 3.4003576E−04 | 2.3102794E−04 |
| A5 | −2.3250151E−04 | −1.7431241E−04 |
| A6 | −9.0461876E−06 | −6.6054381E−06 |
| A7 | 1.2903692E−07 | 9.9484679E−08 |
| A8 | 7.0585098E−08 | 6.0013925E−08 |
| A9 | 7.2746967E−12 | −1.2112068E−09 |
| A10 | −3.3309218E−10 | −3.5633957E−10 |
| A11 | −2.1318879E−12 | 6.3601939E−12 |
| A12 | 1.0082956E−12 | 1.3889998E−12 |
| A13 | 1.0213878E−14 | −1.7851551E−14 |
| A14 | −1.9661721E−15 | −3.4514978E−15 |
| A15 | −2.1872468E−17 | 2.9315592E−17 |
| A16 | 2.3983563E−18 | 5.2198028E−18 |
| A17 | 2.2586872E−20 | −2.6618745E−20 |
| A18 | −1.6739113E−21 | −4.3628823E−21 |
| A19 | −9.1342610E−24 | 1.0299118E−23 |
| A20 | 5.1279924E−25 | 1.5435909E−24 |

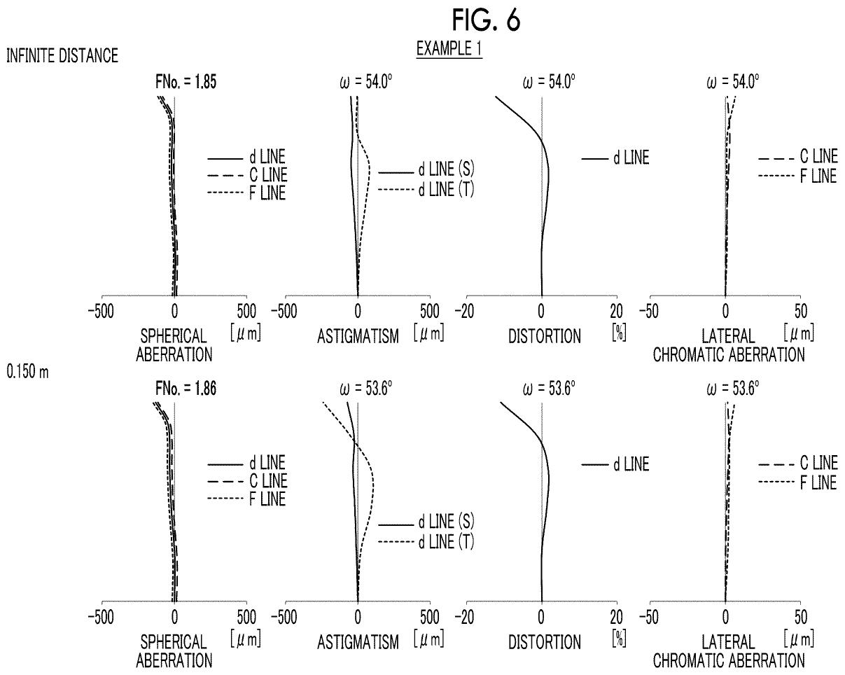

FIG. 6 illustrates each aberration diagram of the imaging lens of Example 1. In FIG. 6, the spherical aberration, the astigmatism, the distortion, and the lateral chromatic aberration are illustrated in this order from the left. In FIG. 6, each aberration diagram in the state where the infinite distance object is in focus is illustrated in an upper part labeled “INFINITE DISTANCE”, and each aberration diagram in the state where the nearest object is in focus is illustrated in a lower part labeled “0.150 m”. In the spherical aberration diagram, aberrations on a d line, a C line, and an F line are illustrated by a solid line, a long broken line, and a short broken line, respectively. In the astigmatism diagram, an aberration on the d line in a sagittal direction is illustrated by a solid line, and an aberration on the d line in a tangential direction is illustrated by a short broken line. In the distortion diagram, an aberration on the d line is illustrated by a solid line. In the lateral chromatic aberration diagram, aberrations on the C line and the F line are illustrated by a long broken line and a short broken line, respectively. In the spherical aberration diagram, a value of the open F-number is shown after “FNo.=”. In other aberration diagrams, a value of the maximum half angle of view is shown after “ω=”. FNo. and ω in the upper part of the drawing correspond to Fno and ωm in the conditional expressions, respectively.

Symbols, meanings, description methods, and illustration methods of each data related to Example 1 are basically the same for the following examples unless otherwise specified. Thus, duplicate descriptions will be omitted below. In the cross-sectional views from Example 2, a sign of the negative partial group Gln is not illustrated.

### Example 2

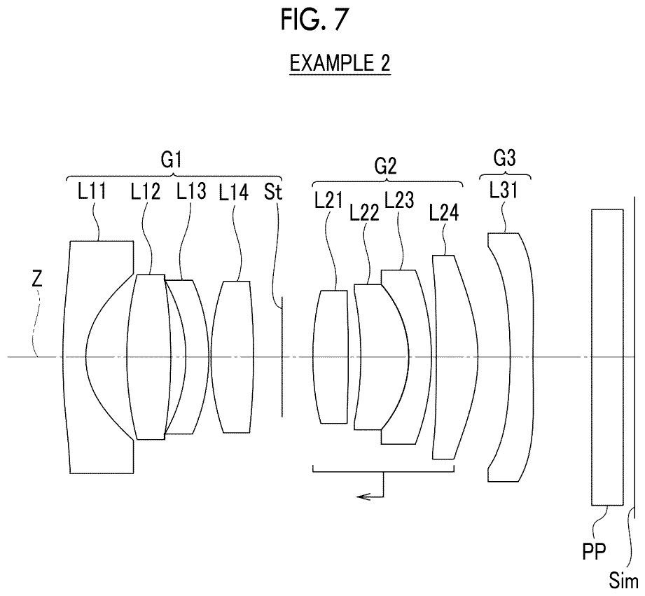

A cross-sectional view of a configuration of an imaging lens of Example 2 is illustrated in FIG. 7. The imaging lens of Example 2 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, four lenses including the lenses L11 to L14, and the aperture stop St. The second lens group G2 consists of, in order from the object side to the image side, four lenses including the lenses L21 to L24. The third lens group G3 consists of one lens that is the lens L31.

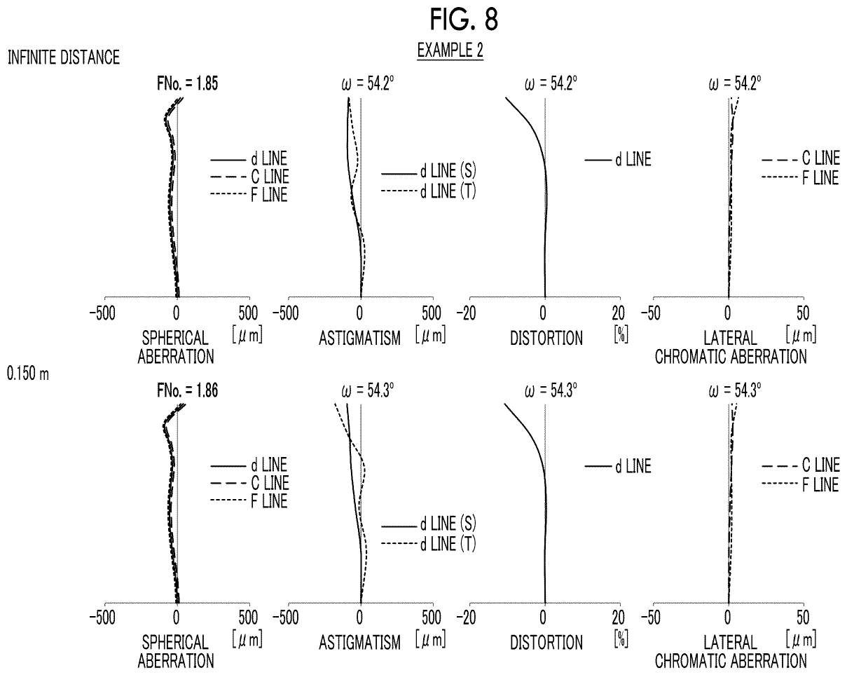

For the imaging lens of Example 2, Table 5 shows basic lens data, Table 6 shows specifications, Table 7 shows a variable surface spacing, Tables 8A and 8B show aspherical coefficients, and FIG. 8 illustrates each aberration diagram.

TABLE 5
Example 2

| Sn | R | D | Nd | vd | ED | Hinf |
|---|---|---|---|---|---|---|
| *1 | 45.3664 | 1.0000 | 1.82080 | 42.71 | 10.35 | 3.04 |
| *2 | 3.6133 | 1.7951 | | | 7.43 | |
| 3 | 15.1597 | 1.9035 | 1.90525 | 35.04 | 7.37 | |
| 4 | −23.1586 | 0.6649 | | | 6.86 | |
| *5 | −6.5701 | 1.0000 | 1.85135 | 40.10 | 6.86 | |
| *6 | −8.6819 | 0.1002 | | | 6.87 | |
| 7 | 10.7547 | 1.8617 | 1.72916 | 54.68 | 6.77 | |
| 8 | −31.5410 | 1.2500 | | | 6.40 | |
| 9 (St) | ∞ | DD[9] | | | | |
| *10 | 13.6108 | 1.5528 | 1.72903 | 54.04 | 5.11 | |
| *11 | −73.3745 | 0.5478 | | | 5.58 | (2.07) |
| 12 | −15.1811 | 2.1068 | 1.43875 | 94.66 | 5.80 | |
| 13 | −4.9616 | 0.9876 | 1.95906 | 17.47 | 6.49 | |
| 14 | −11.0965 | 0.2113 | | | 7.77 | |
| *15 | −581.7851 | 1.8287 | 1.80139 | 45.45 | 8.50 | |
| *16 | −7.4141 | DD[16] | | | 9.08 | 3.93/4.34 |
| *17 | −23.2275 | 1.0021 | 1.68948 | 31.02 | 9.91 | |
| *18 | 78.4493 | 2.5761 | | | 11.07 | 1.22 |
| 19 | ∞ | 1.3800 | 1.51680 | 64.20 | | |
| 20 | ∞ | 0.4986 | | | | |

TABLE 6
Example 2

| | |
|---|---|
| f | 5.77 |
| Bf | 3.98 |
| Fno | 1.85 |
| 2ωm [°] | 108.4 |

TABLE 7
Example 2

| | Infinite Distance | 0.150 m |
|---|---|---|
| DD[9] | 1.3500 | 1.1819 |
| DD[16] | 1.3863 | 1.5544 |

TABLE 8A
Example 2

| Sn | 1 | 2 | 5 | 6 |
|---|---|---|---|---|
| KA | −3.8150194E−01 | −4.8159773E−02 | 6.6928664E−03 | −2.1621041E−02 |
| A3 | 0.0000000E+00 | 1.0148377E−18 | 0.0000000E+00 | −9.5148442E−20 |
| A4 | 3.0044211E−03 | 6.6230834E−03 | −1.0644260E−05 | −2.7369454E−04 |
| A5 | −6.2874443E−04 | −2.3404070E−03 | −5.2800039E−05 | −2.6349113E−07 |
| A6 | −2.2389725E−04 | −7.9371507E−05 | −4.2312069E−08 | 3.5817396E−06 |
| A7 | 5.9581721E−05 | 3.9363965E−04 | 4.4542434E−07 | −1.3690534E−07 |
| A8 | 6.9950107E−06 | −1.0227437E−04 | −3.8565888E−10 | −3.3909118E−08 |
| A9 | −2.7911181E−06 | −3.3413216E−05 | −2.7385336E−09 | 1.2204396E−09 |
| A10 | −6.3541186E−08 | 1.3916258E−05 | 7.7365208E−12 | 2.0107296E−10 |
| A11 | 7.3979578E−08 | 1.5889253E−06 | 1.0842195E−11 | −5.5404520E−12 |
| A12 | −1.8679537E−09 | −8.9200430E−07 | −4.8636501E−14 | −7.4838170E−13 |
| A13 | −1.1649788E−09 | −4.3964440E−08 | −2.7097647E−14 | 1.4636608E−14 |
| A14 | 6.2883814E−11 | 3.2346065E−08 | 1.6255513E−16 | 1.7486041E−15 |
| A15 | 1.0815855E−11 | 6.9526564E−10 | 4.1304414E−17 | −2.2668211E−17 |
| A16 | −7.9547802E−13 | −6.7644055E−10 | −3.1057721E−19 | −2.4907495E−18 |
| A17 | −5.4708672E−14 | −5.7272835E−12 | −3.5056618E−20 | 1.9110841E−20 |
| A18 | 4.8355463E−15 | 7.5991148E−12 | 3.2027253E−22 | 1.9775783E−21 |
| A19 | 1.1630754E−16 | 1.8490060E−14 | 1.2698607E−23 | −6.7714946E−24 |
| A20 | −1.1708495E−17 | −3.5492621E−14 | −1.3837628E−25 | −6.7119728E−25 |
| Sn | 10 | 11 | 15 | 16 |
| KA | 4.8327044E−01 | −7.1123105E−01 | 1.6212839E+04 | −2.9109099E+00 |
| A3 | −8.5610883E−19 | 8.9508923E−19 | −1.7961370E−19 | 4.2922200E−19 |
| A4 | 5.0948779E−04 | −2.2629257E−04 | 8.8752541E−04 | 6.4027462E−04 |
| A5 | −3.7348341E−04 | −5.7399988E−04 | −1.3775629E−03 | −1.4106672E−04 |
| A6 | −4.0987094E−04 | 4.9429648E−04 | −1.2422197E−04 | −3.7203320E−04 |
| A7 | 6.5513312E−04 | −1.2928359E−04 | 5.5563380E−04 | 2.2255571E−04 |
| A8 | −8.9318214E−05 | −3.8355026E−05 | −8.3106144E−05 | 2.4151795E−05 |
| A9 | −2.1350169E−04 | 9.0824512E−05 | −1.0080289E−04 | −4.1701946E−05 |
| A10 | 6.6672248E−05 | −3.5651696E−05 | 2.5434772E−05 | 3.1354627E−06 |
| A11 | 3.3335580E−05 | −1.6800701E−05 | 9.7488884E−06 | 3.6636008E−06 |
| A12 | −1.2656050E−05 | 1.0535194E−05 | −3.1390405E−06 | −5.6515688E−07 |
| A13 | −2.9268898E−06 | 1.5298299E−06 | −5.3172204E−07 | −1.7811522E−07 |
| A14 | 1.1842563E−06 | −1.2619030E−06 | 2.0669282E−07 | 3.6663354E−08 |
| A15 | 1.4785383E−07 | −7.5241002E−08 | 1.6128880E−08 | 4.9244386E−09 |
| A16 | −6.0386852E−08 | 7.6579616E−08 | −7.5958075E−09 | −1.2209750E−09 |
| A17 | −4.0074759E−09 | 1.9072268E−09 | −2.4572320E−10 | −7.2640241E−11 |
| A18 | 1.6103951E−09 | −2.3247737E−09 | 1.4661549E−10 | 2.0823011E−11 |
| A19 | 4.5083130E−11 | −1.9454556E−11 | 1.3618355E−12 | 4.4450295E−13 |
| A20 | −1.7622029E−11 | 2.8056833E−11 | −1.1546860E−12 | −1.4422262E−13 |

TABLE 8B
Example 2

| Sn | 17 | 18 |
|---|---|---|
| KA | 6.3728108E−03 | 3.1535518E−02 |
| A3 | −2.1644736E−17 | −2.1818904E−18 |
| A4 | 1.4076404E−04 | −5.7220144E−04 |
| A5 | −1.5637650E−04 | −8.3736308E−05 |
| A6 | −4.3455363E−06 | 4.0783901E−06 |
| A7 | −7.8282765E−08 | 3.2301543E−07 |
| A8 | 2.9163841E−08 | −3.5698069E−08 |
| A9 | 1.7593700E−10 | −1.8676882E−09 |
| A10 | −1.1748103E−10 | 1.8110066E−10 |
| A11 | 6.0324216E−13 | 6.6037435E−12 |
| A12 | 2.8464710E−13 | −5.5601696E−13 |
| A13 | −3.6593959E−15 | −1.4657472E−14 |
| A14 | −4.0632110E−16 | 1.0488751E−15 |
| A15 | 7.9109228E−18 | 1.9956322E−17 |
| A16 | 3.2209656E−19 | −1.1876497E−18 |
| A17 | −8.3312522E−21 | −1.5215860E−20 |
| A18 | −1.2487554E−22 | 7.3948022E−22 |
| A19 | 3.5423609E−24 | 4.9727690E−24 |
| A20 | 1.8097025E−26 | −1.9394570E−25 |

### Example 3

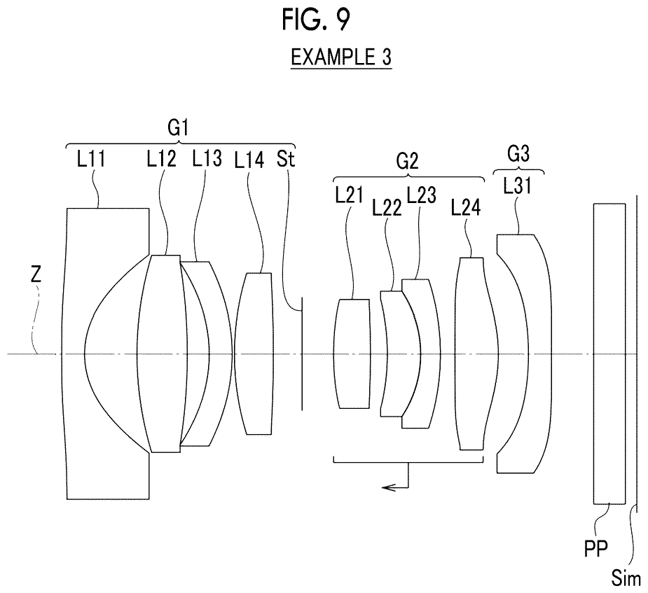

A cross-sectional view of a configuration of an imaging lens of Example 3 is illustrated in FIG. 9. The imaging lens of Example 3 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, four lenses including the lenses L11 to L14, and the aperture stop St. The second lens group G2 consists of, in order from the object side to the image side, four lenses including the lenses L21 to L24. The third lens group G3 consists of one lens that is the lens L31.

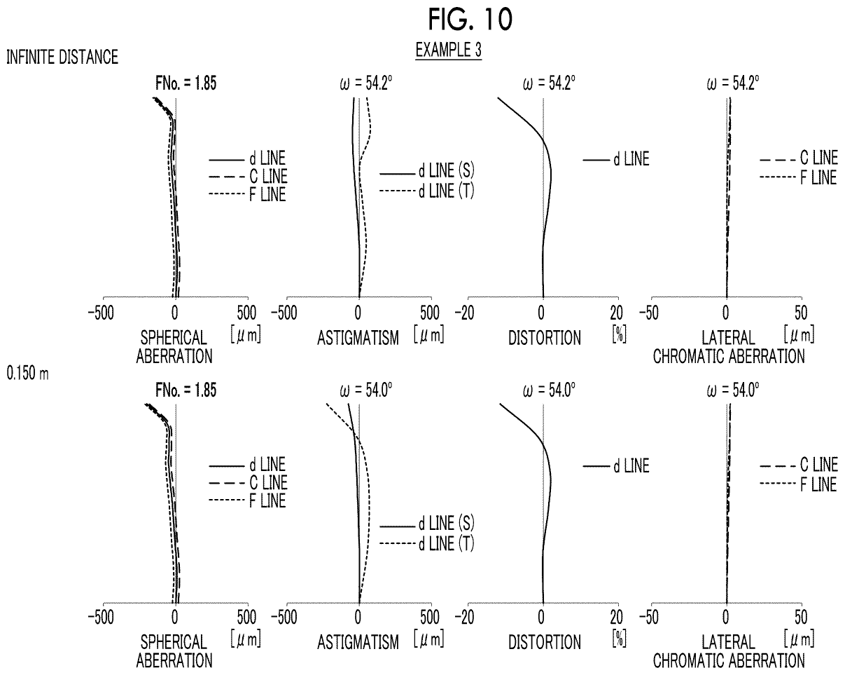

For the imaging lens of Example 3, Table 9 shows basic lens data, Table 10 shows specifications, Table 11 shows a variable surface spacing, Tables 12A and 12B show aspherical coefficients, and FIG. 10 illustrates each aberration diagram.

TABLE 9
Example 3

| Sn | R | D | Nd | vd | ED | Hinf |
|---|---|---|---|---|---|---|
| *1 | 173.7926 | 0.9998 | 1.63858 | 55.18 | 12.89 | 3.28/6.40 |
| *2 | 3.9375 | 2.2849 | | | 8.78 | |
| 3 | 15.1597 | 2.1929 | 1.78800 | 47.37 | 8.72 | |
| 4 | −26.0468 | 0.9561 | | | 8.07 | |
| *5 | −6.5537 | 1.0000 | 1.85135 | 40.10 | 8.07 | |
| *6 | −8.4462 | 0.1000 | | | 8.16 | |
| 7 | 12.1615 | 1.6966 | 1.72916 | 54.68 | 7.14 | |
| 8 | −59.8205 | 1.2501 | | | 6.48 | |
| 9 (St) | ∞ | DD[9] | | | | |
| *10 | 12.2614 | 1.6094 | 1.80139 | 45.45 | 4.81 | |
| *11 | −34.9421 | 0.7352 | | | 4.43 | (1.64) |
| 12 | −10.1013 | 1.4584 | 1.43875 | 94.66 | 4.85 | |
| 13 | −5.0976 | 0.8557 | 1.95906 | 17.47 | 5.55 | |
| 14 | −10.7407 | 0.6314 | | | 6.58 | |
| *15 | 7640.2230 | 1.8932 | 1.80139 | 45.45 | 8.15 | 4.06 |
| *16 | −7.0261 | DD[16] | | | 8.50 | 2.5 |
| *17 | −11.8782 | 1.0002 | 1.68948 | 31.02 | 8.86 | |
| *18 | 235.5632 | 1.8451 | | | 10.55 | 0.74 |
| 19 | ∞ | 1.3800 | 1.51680 | 64.20 | | |
| 20 | ∞ | 0.4987 | | | | |

TABLE 10
Example 3

| | |
|---|---|
| f | 5.77 |
| Bf | 3.25 |
| Fno | 1.85 |
| 2ωm [°] | 108.4 |

TABLE 11
Example 3

| | Infinite Distance | 0.150 m |
|---|---|---|
| DD[9] | 1.3496 | 1.2017 |
| DD[16] | 1.3141 | 1.4620 |

TABLE 12A
Example 3

| Sn | 1 | 2 | 5 | 6 |
|---|---|---|---|---|
| KA | −2.8028700E+01 | −9.4297753E−02 | −7.7892659E−02 | −8.6830625E−03 |
| A3 | 0.0000000E+00 | 2.9428372E−18 | −1.9969030E−19 | −1.0741919E−18 |
| A4 | 3.2610948E−03 | 7.1444558E−03 | −2.0056131E−04 | −2.6751818E−04 |
| A5 | −8.3299789E−04 | −2.6724756E−03 | 3.0182380E−06 | 3.0898251E−05 |
| A6 | −2.1307181E−04 | −2.8050195E−04 | 3.4926513E−06 | 4.3664499E−06 |
| A7 | 9.9342983E−05 | 5.1860934E−04 | −1.2472709E−08 | −2.3736657E−07 |
| A8 | 1.1469000E−06 | −7.6026418E−05 | −3.5477200E−08 | −4.5585271E−08 |
| A9 | −5.2837759E−06 | −4.4819799E−05 | 5.7102736E−10 | 1.9581431E−09 |
| A10 | 3.9161656E−07 | 1.1364145E−05 | 2.1525596E−10 | 2.8431330E−10 |
| A11 | 1.5239370E−07 | 2.0945368E−06 | −3.5998818E−12 | −8.8797757E−12 |
| A12 | −1.8281186E−08 | −7.1722316E−07 | −8.1124278E−13 | −1.0923038E−12 |
| A13 | −2.5436838E−09 | −5.5335556E−08 | 1.1342791E−14 | 2.3820756E−14 |
| A14 | 3.8674071E−10 | 2.5035490E−08 | 1.9222195E−15 | 2.6125834E−15 |
| A15 | 2.4556541E−11 | 8.0225675E−10 | −1.9723522E−17 | −3.7654234E−17 |
| A16 | −4.3946035E−12 | −5.0161464E−10 | −2.7880932E−18 | −3.7912526E−18 |
| A17 | −1.2722984E−13 | −5.6076131E−12 | 1.8014096E−20 | 3.2453991E−20 |
| A18 | 2.5996398E−14 | 5.4036068E−12 | 2.2629305E−21 | 3.0560522E−21 |
| A19 | 2.7364725E−16 | 1.2428568E−14 | −6.7506449E−24 | −1.1764284E−23 |
| A20 | −6.2939987E−17 | −2.4261295E−14 | −7.8758028E−25 | −1.0501577E−24 |
| Sn | 10 | 11 | 15 | 16 |
| KA | 4.9139412E−01 | 8.8836952E+00 | −8.0311828E+10 | −2.7702152E+00 |
| A3 | 0.0000000E+00 | 0.0000000E+00 | −7.3177840E−19 | 8.7022699E−19 |
| A4 | −1.9936088E−03 | −1.2345264E−03 | 5.9552080E−04 | −1.2874935E−03 |
| A5 | 5.0245835E−03 | 2.9007610E−03 | 2.6993460E−04 | 2.4494448E−03 |
| A6 | −2.8676319E−03 | −7.7387258E−04 | −1.0933900E−03 | −1.0326396E−03 |
| A7 | −8.7329310E−04 | −1.3486436E−03 | 6.2380885E−04 | −2.0839916E−04 |
| A8 | 1.3436149E−03 | 7.3748069E−04 | 1.5342254E−04 | 2.6028559E−04 |
| A9 | −3.9919379E−05 | 3.3293688E−04 | −1.8686494E−04 | −8.3659843E−06 |
| A10 | −2.7743477E−04 | −2.3425650E−04 | 5.4208813E−06 | −2.9986465E−05 |
| A11 | 3.0140311E−05 | −4.6369968E−05 | 2.4485649E−05 | 2.8618864E−06 |
| A12 | 3.2960167E−05 | 3.8499817E−05 | −3.0526094E−06 | 2.0541731E−06 |
| A13 | −3.9147169E−06 | 3.8089675E−06 | −1.7368067E−06 | −2.1956350E−07 |
| A14 | −2.3769526E−06 | −3.5758610E−06 | 3.0527652E−07 | −8.8289998E−08 |
| A15 | 2.3807728E−07 | −1.8307654E−07 | 6.9185318E−08 | 8.0853621E−09 |
| A16 | 1.0224250E−07 | 1.8866960E−07 | −1.4536150E−08 | 2.3281051E−09 |
| A17 | −7.1265190E−09 | 4.7516333E−09 | −1.4576811E−09 | −1.4792290E−10 |
| A18 | −2.4044000E−09 | −5.2673680E−09 | 3.4532082E−10 | −3.4293202E−11 |
| A19 | 8.4632724E−11 | −5.1300743E−11 | 1.2659375E−11 | 1.0790297E−12 |
| A20 | 2.3732141E−11 | 6.0388297E−11 | −3.2898571E−12 | 2.1535214E−13 |

TABLE 12B
Example 3

| Sn | 17 | 18 |
|---|---|---|
| KA | 1.5835245E+00 | −1.1961173E+03 |
| A3 | −2.8138665E−17 | 3.1483428E−19 |
| A4 | −1.9598514E−04 | −4.8812257E−04 |
| A5 | −2.4367278E−04 | −1.3006315E−04 |
| A6 | −1.4942924E−06 | 2.8486701E−06 |
| A7 | 1.9199498E−07 | 3.7835262E−07 |
| A8 | 5.1820791E−09 | −2.5352898E−08 |
| A9 | −3.4992345E−10 | −1.8627184E−09 |
| A10 | 5.9986128E−12 | 1.2237767E−10 |
| A11 | −4.3156049E−13 | 6.1575984E−12 |
| A12 | −1.0676495E−13 | −3.3512351E−13 |
| A13 | 4.4703534E−15 | −1.3461249E−14 |
| A14 | 3.5879640E−16 | 5.1689990E−16 |
| A15 | −1.0302487E−17 | 1.8642483E−17 |
| A16 | −5.6973845E−19 | −4.0697095E−19 |
| A17 | 1.0432738E−20 | −1.4763108E−20 |
| A18 | 4.3757088E−22 | 1.0698165E−22 |
| A19 | −4.0055319E−24 | 5.0678481E−24 |
| A20 | −1.2721628E−25 | 2.2636151E−26 |

### Example 4

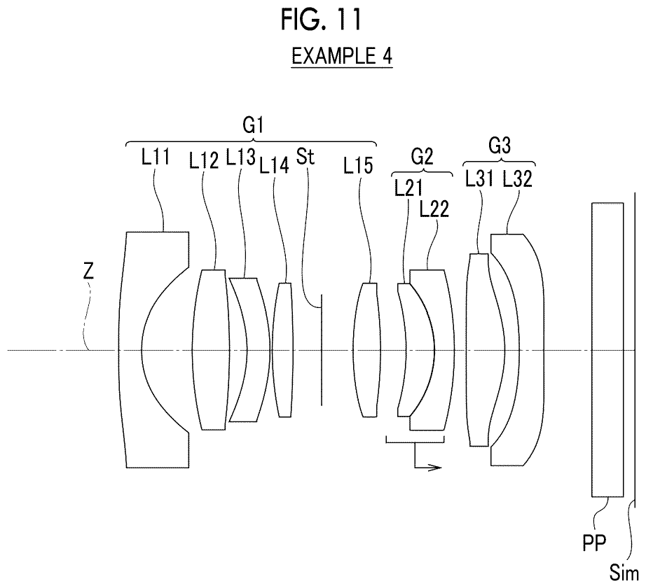

A cross-sectional view of a configuration of an imaging lens of Example 4 is illustrated in FIG. 11. The imaging lens of Example 4 consists of, in order from the object side to the image side, the first lens group G1 having a positive refractive power, the second lens group G2 having a negative refractive power, and the third lens group G3 having a positive refractive power. The focus group consists of the second lens group G2, and during the focusing from the infinite distance object to the nearest object, the focus group moves to the image side along the optical axis Z.

The first lens group G1 consists of, in order from the object side to the image side, the lenses L11 to L14, the aperture stop St, and a lens L15. The second lens group G2 consists of, in order from the object side to the image side, two lenses including the lenses L21 and L22. The third lens group G3 consists of, in order from the object side to the image side, two lenses including lenses L31 and L32.

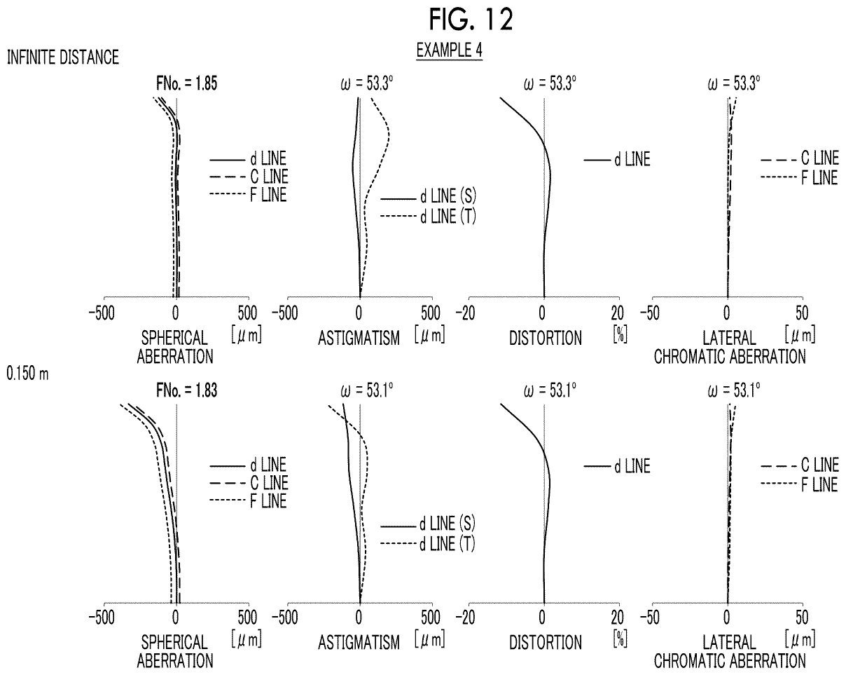

For the imaging lens of Example 4, Table 13 shows basic lens data, Table 14 shows specifications, Table 15 shows a variable surface spacing, Tables 16A and 16B show aspherical coefficients, and FIG. 12 illustrates each aberration diagram.

TABLE 13
Example 4

| Sn | R | D | Nd | vd | ED | Hinf |
|---|---|---|---|---|---|---|
| *1 | 800.5141 | 0.9999 | 1.68948 | 31.02 | 10.49 | 3.49 |
| *2 | 4.3750 | 2.2171 | | | 7.36 | |
| 3 | 15.1597 | 1.6271 | 2.00100 | 29.14 | 7.10 | |
| 4 | −29.2961 | 0.7710 | | | 6.63 | |
| *5 | −5.8832 | 1.0041 | 1.85135 | 40.10 | 6.37 | |
| *6 | −7.8121 | 0.1002 | | | 6.20 | |
| 7 | 14.6679 | 0.9055 | 1.71299 | 53.87 | 5.95 | |
| 8 | −46.0676 | 1.2498 | | | 5.78 | |
| 9 (St) | ∞ | 1.3587 | | | | |
| *10 | 11.7126 | 1.1997 | 1.80610 | 40.73 | 4.74 | |
| *11 | −19.5325 | DD[11] | | | 5.04 | (2.41) |
| 12 | −9.4671 | 1.2452 | 1.43875 | 94.66 | 5.59 | |
| 13 | −4.5676 | 0.8672 | 1.95906 | 17.47 | 5.90 | |
| 14 | −14.1064 | DD[14] | | | 7.12 | |
| *15 | −2289.6291 | 1.6846 | 1.80139 | 45.45 | 8.23 | 0.12/0.87/ |
| | | | | | | 1.36/3.86 |
| *16 | −5.9627 | 0.6371 | | | 8.56 | 2.48/4.14 |
| *17 | −13.9696 | 1.0684 | 1.68948 | 31.02 | 8.65 | |
| *18 | 75.9007 | 2.1102 | | | 10.30 | 0.98 |
| 19 | ∞ | 1.3800 | 1.51680 | 64.20 | | |
| 20 | ∞ | 0.4979 | | | | |

TABLE 14
Example 4

| | |
|---|---|
| f | 5.92 |
| Bf | 3.52 |
| Fno | 1.85 |
| 2ωm [°] | 106.6 |

TABLE 15
Example 4

| | Infinite Distance | 0.150 m |
|---|---|---|
| DD[11] | 1.1198 | 1.3515 |
| DD[14] | 0.5232 | 0.2915 |

TABLE 16A
Example 4

| Sn | 1 | 2 | 5 | 6 |
|---|---|---|---|---|
| KA | 1.9320712E+04 | −1.4372978E−01 | −3.0066181E−01 | −3.2764595E−01 |
| A3 | 1.6435185E−18 | −3.6369668E−18 | 1.8503658E−18 | −6.9256188E−19 |
| A4 | 4.9310185E−03 | 8.9353714E−03 | 4.3205156E−04 | 1.5762206E−04 |
| A5 | −9.7876036E−04 | −1.6954890E−03 | 7.5275556E−05 | 8.8652396E−05 |
| A6 | −3.7543242E−04 | −9.3019092E−04 | −7.4805488E−06 | −5.4582671E−06 |
| A7 | 1.4386440E−04 | 5.3203563E−04 | −4.7622519E−07 | −6.1417953E−07 |
| A8 | 3.8597696E−06 | 2.7826435E−07 | 7.8731985E−08 | 6.0036936E−08 |
| A9 | −8.8040643E−06 | −5.5593285E−05 | 4.3538910E−09 | 4.6715951E−09 |
| A10 | 7.4517638E−07 | 6.4776547E−06 | −4.8233799E−10 | −3.8845965E−10 |
| A11 | 2.8351294E−07 | 2.9898844E−06 | −2.0907490E−11 | −2.1743963E−11 |
| A12 | −4.0976358E−08 | −5.2378953E−07 | 1.8225455E−12 | 1.5604844E−12 |
| A13 | −5.2118047E−09 | −8.9574492E−08 | 5.8200808E−14 | 6.1645781E−14 |
| A14 | 9.8369821E−10 | 2.0288883E−08 | −4.2995768E−15 | −3.9419811E−15 |
| A15 | 5.5113402E−11 | 1.4780995E−09 | −9.4822686E−17 | −1.0438607E−16 |
| A16 | −1.2536939E−11 | −4.3434594E−10 | 6.1637901E−18 | 6.0923816E−18 |
| A17 | −3.1251409E−13 | −1.2144807E−11 | 8.3897821E−20 | 9.7103396E−20 |
| A18 | 8.2603916E−14 | 4.9389419E−12 | −4.9085888E−21 | −5.2610855E−21 |
| A19 | 7.3695805E−16 | 3.6053471E−14 | −3.1132629E−23 | −3.8190962E−23 |
| A20 | −2.2163352E−16 | −2.3318770E−14 | 1.6642729E−24 | 1.9434206E−24 |
| Sn | 10 | 11 | 15 | 16 |
| KA | 3.5909867E−01 | 8.3531829E+00 | 2.9979485E+05 | −2.5779915E+00 |
| A3 | −1.2717780E−18 | 0.0000000E+00 | 1.4644889E−18 | −1.7667739E−18 |
| A4 | −1.9730112E−03 | −2.1785919E−03 | 3.3489402E−03 | 2.0957780E−03 |
| A5 | 3.2954033E−03 | 2.5347313E−03 | −2.1739132E−03 | −7.9306049E−04 |
| A6 | −1.2565734E−03 | 2.2510783E−04 | −2.1192222E−03 | −1.0198159E−03 |
| A7 | −7.1716319E−04 | −1.8374478E−03 | 1.9972565E−03 | 6.7829761E−04 |
| A8 | 6.3483681E−04 | 5.0082028E−04 | 1.7852449E−04 | 9.7643394E−05 |
| A9 | 4.7769845E−05 | 5.5019125E−04 | −5.1310348E−04 | −1.2131478E−04 |
| A10 | −1.3344230E−04 | −2.2207492E−04 | 4.4614376E−05 | −1.0678732E−07 |
| A11 | 3.9168588E−06 | −8.5723187E−05 | 6.5101123E−05 | 1.0907848E−05 |
| A12 | 1.6273830E−05 | 4.0701891E−05 | −1.0747497E−05 | −5.0021595E−07 |
| A13 | −7.9654392E−07 | 7.6234978E−06 | −4.6005726E−06 | −5.5384780E−07 |
| A14 | −1.2066100E−06 | −3.9127431E−06 | 9.7604606E−07 | 3.4201124E−08 |
| A15 | 4.8452931E−08 | −3.9021547E−07 | 1.8422386E−07 | 1.6012312E−08 |
| A16 | 5.2930823E−08 | 2.0661083E−07 | −4.5526528E−08 | −1.0711469E−09 |
| A17 | −1.3025848E−09 | 1.0689301E−08 | −3.9100466E−09 | −2.4532948E−10 |
| A18 | −1.2531987E−09 | −5.6748503E−09 | 1.0841231E−09 | 1.6938361E−11 |
| A19 | 1.3020112E−11 | −1.2123730E−10 | 3.4172505E−11 | 1.5437143E−12 |
| A20 | 1.2275254E−11 | 6.3407162E−11 | −1.0454627E−11 | −1.1027455E−13 |

TABLE 16B
Example 4

| Sn | 17 | 18 |
|---|---|---|
| KA | −3.8147494E−01 | −1.0122843E+03 |
| A3 | −1.0779889E−17 | 1.1145026E−17 |
| A4 | −3.9288244E−04 | −6.5891726E−04 |
| A5 | −3.1448644E−04 | −1.6299693E−04 |
| A6 | 2.2377689E−06 | 2.9357493E−06 |
| A7 | 6.3829461E−07 | 8.2612182E−08 |
| A8 | −2.6426988E−08 | −2.2789229E−08 |
| A9 | −2.0431514E−09 | −1.3966774E−09 |
| A10 | 1.8729839E−10 | 1.1068490E−10 |
| A11 | 4.0722930E−12 | 7.0390940E−12 |
| A12 | −7.5953864E−13 | −3.1666748E−13 |
| A13 | −2.3147484E−15 | −1.8544299E−14 |
| A14 | 1.8259512E−15 | 5.3741077E−16 |
| A15 | −5.8151374E−18 | 2.7995348E−17 |
| A16 | −2.5731968E−18 | −5.2290301E−19 |
| A17 | 1.0819497E−20 | −2.2824231E−20 |
| A18 | 1.9599759E−21 | 2.6006965E−22 |
| A19 | −5.3870907E−24 | 7.7728473E−24 |
| A20 | −6.2188699E−25 | −4.6620024E−26 |

### Example 5

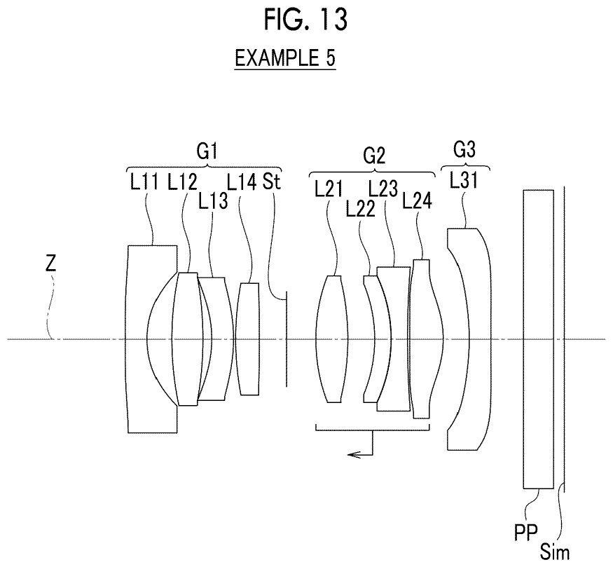

A cross-sectional view of a configuration of an imaging lens of Example 5 is illustrated in FIG. 13. The imaging lens of Example 5 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, four lenses including the lenses L11 to L14, and the aperture stop St. The second lens group G2 consists of, in order from the object side to the image side, four lenses including the lenses L21 to L24. The third lens group G3 consists of one lens that is the lens L31.

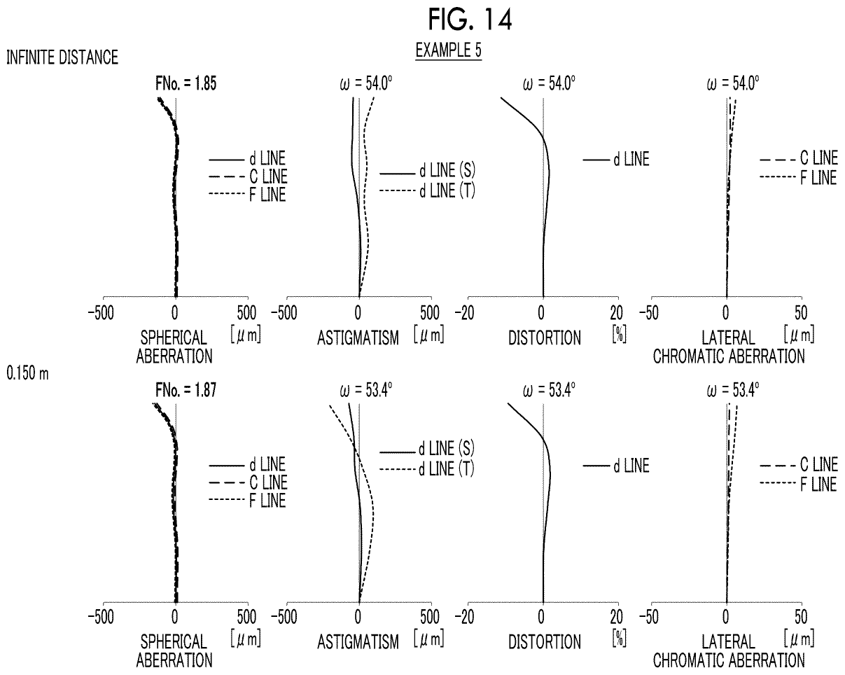

For the imaging lens of Example 5, Table 17 shows basic lens data, Table 18 shows specifications, Table 19 shows a variable surface spacing, Tables 20A and 20B show aspherical coefficients, and FIG. 14 illustrates each aberration diagram.

TABLE 17
Example 5

| Sn | R | D | Nd | vd | ED | Hinf |
|---|---|---|---|---|---|---|
| *1 | −146.8622 | 1.0002 | 1.68948 | 31.02 | 8.75 | 0.46/3.01 |
| *2 | 4.5968 | 1.1194 | | | 6.28 | |
| 3 | 15.1597 | 1.4298 | 1.85025 | 30.05 | 6.23 | |
| 4 | −16.6799 | 0.4063 | | | 5.75 | |
| *5 | −5.4255 | 1.0000 | 1.85135 | 40.10 | 5.75 | |
| *6 | −7.7247 | 0.1000 | | | 5.41 | |
| 7 | 14.2926 | 1.0889 | 1.67790 | 55.35 | 5.19 | |
| 8 | −91.4454 | 1.2500 | | | 4.92 | |
| 9 (St) | ∞ | DD[9] | | | | |
| *10 | 9.0119 | 1.4698 | 1.80139 | 45.45 | 5.32 | |
| *11 | −11.9230 | 1.2363 | | | 5.51 | |
| 12 | −6.9074 | 0.7600 | 1.43875 | 94.66 | 5.66 | |
| 13 | −7.0998 | 0.7500 | 1.95906 | 17.47 | 5.93 | |
| 14 | 45.3925 | 0.1002 | | | 6.74 | |
| *15 | −833.1180 | 1.5441 | 1.80139 | 45.45 | 6.95 | 0.13/0.74/ |
| | | | | | | 1.06/3.08 |
| *16 | −4.5673 | DD[16] | | | 7.40 | 2.00/3.44 |
| *17 | −11.0540 | 1.0000 | 1.68948 | 31.02 | 8.48 | |
| *18 | −1954.8569 | 1.4973 | | | 10.20 | 0.27/1.56 |
| 19 | ∞ | 1.3800 | 1.51680 | 64.20 | | |
| 20 | ∞ | 0.4987 | | | | |

TABLE 18
Example 5

| | |
|---|---|
| f | 5.85 |
| Bf | 2.91 |
| Fno | 1.85 |
| 2ωm [°] | 108.0 |

TABLE 19
Example 5

| | Infinite Distance | 0.150 m |
|---|---|---|
| DD[9] | 1.3500 | 1.1983 |
| DD[16] | 1.1693 | 1.3210 |

TABLE 20A
Example 5

| Sn | 1 | 2 | 5 | 6 |
|---|---|---|---|---|
| KA | −1.3631617E+04 | −4.2412293E−01 | −1.0886401E−01 | −2.4700698E−01 |
| A3 | −4.6042663E−19 | 0.0000000E+00 | −8.0005224E−18 | 6.8249411E−19 |
| A4 | 1.9439006E−03 | 7.1589717E−03 | 1.4588455E−03 | 9.0544650E−04 |
| A5 | 7.8964271E−04 | −1.7162306E−03 | 8.1744969E−05 | 1.5753580E−04 |
| A6 | −5.3200422E−04 | 3.4543365E−04 | −2.8207853E−05 | −2.3034938E−05 |
| A7 | 8.7908785E−06 | 2.4646052E−04 | −2.2504092E−07 | −6.1350086E−07 |
| A8 | 2.9675878E−05 | −2.1031610E−04 | 2.8060738E−07 | 2.5949462E−07 |
| A9 | −5.5007539E−06 | 1.3989356E−07 | 2.8774334E−09 | 3.5195872E−09 |
| A10 | 1.0509968E−07 | 2.4417011E−05 | −1.6592435E−09 | −1.7155903E−09 |
| A11 | 3.0380731E−07 | −1.6935558E−06 | −1.3793895E−11 | −1.7549650E−11 |
| A12 | −7.0902385E−08 | −1.4497461E−06 | 6.1277711E−12 | 7.0224772E−12 |
| A13 | −7.3416538E−09 | 1.1885164E−07 | 3.6864331E−14 | 5.3975385E−14 |
| A14 | 3.0000166E−09 | 5.0413250E−08 | −1.4268530E−14 | −1.8005135E−14 |
| A15 | 8.6663862E−11 | −3.6447789E−09 | −5.7642327E−17 | −9.6908787E−17 |
| A16 | −5.8028743E−11 | −1.0372087E−09 | 2.0345118E−17 | 2.8136779E−17 |
| A17 | −4.4695445E−13 | 5.3604917E−11 | 4.9138256E−20 | 9.4821255E−20 |
| A18 | 5.5086484E−13 | 1.1691171E−11 | −1.6199706E−20 | −2.4494578E−20 |
| A19 | 5.6016024E−16 | −3.0822109E−13 | −1.7510575E−23 | −3.9228989E−23 |
| A20 | −2.0749848E−15 | −5.5583795E−14 | 5.5071110E−24 | 9.1039631E−24 |
| Sn | 10 | 11 | 15 | 16 |
| KA | −5.1800278E−01 | 4.6815995E+00 | 5.3497321E+04 | −3.1998368E+00 |
| A3 | 1.2031122E−17 | 0.0000000E+00 | −9.8054020E−18 | 0.0000000E+00 |
| A4 | 2.5047637E−03 | 3.7997023E−03 | 8.8187766E−03 | 4.9775619E−03 |
| A5 | −4.1050153E−03 | −6.0509257E−03 | −1.0104959E−02 | −7.4835234E−03 |
| A6 | 2.8861520E−03 | 3.1343113E−03 | −1.3475550E−03 | 8.2935562E−04 |
| A7 | 7.7576297E−04 | 1.0899049E−03 | 5.8138280E−03 | 2.5045519E−03 |
| A8 | −1.6747846E−03 | −1.4206238E−03 | −9.8168725E−04 | −7.0155032E−04 |
| A9 | 3.2498135E−04 | 1.0517528E−04 | −1.3617756E−03 | −3.4899687E−04 |
| A10 | 2.9185335E−04 | 2.3742268E−04 | 4.1675441E−04 | 1.3920761E−04 |
| A11 | −1.0695112E−04 | −5.0344117E−05 | 1.6332608E−04 | 2.7259701E−05 |
| A12 | −2.1361965E−05 | −1.9745626E−05 | −6.7975691E−05 | −1.3394319E−05 |
| A13 | 1.2439530E−05 | 6.0304390E−06 | −1.0539888E−05 | −1.2884489E−06 |
| A14 | 4.8570271E−07 | 8.4386723E−07 | 5.8309591E−06 | 7.1702500E−07 |
| A15 | −7.1136469E−07 | −3.4482708E−07 | 3.4820256E−07 | 3.6517654E−08 |
| A16 | 1.9078180E−08 | −1.5745522E−08 | −2.7874870E−07 | −2.1881194E−08 |
| A17 | 2.0161707E−08 | 9.7219652E−09 | −4.6699935E−09 | −5.6876048E−10 |
| A18 | −1.1848012E−09 | 3.1777071E−12 | 7.0412035E−09 | 3.5740293E−10 |
| A19 | −2.2656379E−10 | −1.0856887E−10 | 2.2733009E−12 | 3.7229066E−12 |
| A20 | 1.6951742E−11 | 2.5824674E−12 | −7.3384888E−11 | −2.4326148E−12 |

TABLE 20B
Example 5

| Sn | 17 | 18 |
|---|---|---|
| KA | 1.8066090E+00 | 1.1856862E+05 |
| A3 | 4.8601285E−17 | −2.2354720E−18 |
| A4 | 2.4522907E−03 | 7.3369158E−04 |
| A5 | −3.7309132E−04 | −2.4863881E−04 |
| A6 | −6.1757644E−05 | −9.2507153E−06 |
| A7 | −1.6424056E−06 | −1.1382405E−06 |
| A8 | 5.2123060E−07 | 8.3365587E−08 |
| A9 | 1.1488948E−08 | 6.6516306E−09 |
| A10 | −2.8195026E−09 | −4.5714945E−10 |
| A11 | −3.7174958E−11 | −2.3590630E−11 |
| A12 | 1.0018391E−11 | 1.6998262E−12 |
| A13 | 7.2068195E−14 | 5.7442057E−14 |
| A14 | −2.2937815E−14 | −4.3450287E−15 |
| A15 | −8.6134238E−17 | −8.9256017E−17 |
| A16 | 3.2597140E−17 | 7.1093037E−18 |
| A17 | 6.1406900E−20 | 7.9102853E−20 |
| A18 | −2.6228756E−20 | −6.5459765E−21 |
| A19 | −2.2593500E−23 | −3.0664329E−23 |
| A20 | 9.1512481E−24 | 2.5465916E−24 |

### Example 6

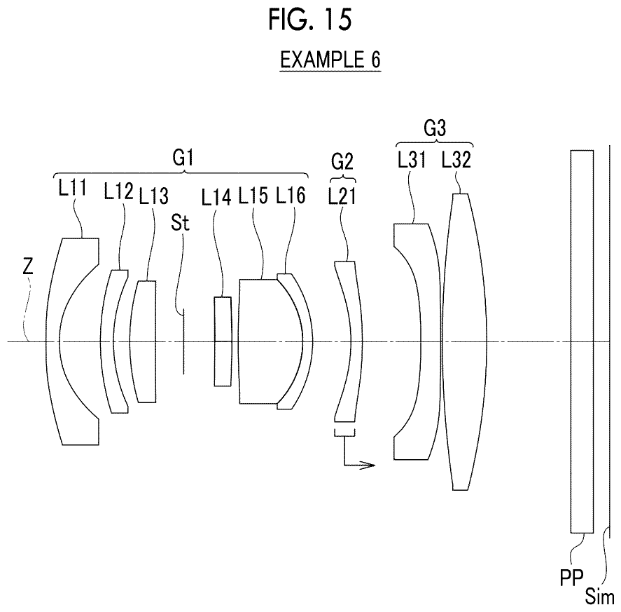

A cross-sectional view of a configuration of an imaging lens of Example 6 is illustrated in FIG. 15. The imaging lens of Example 6 consists of, in order from the object side to the image side, the first lens group G1 having a positive refractive power, the second lens group G2 having a negative refractive power, and the third lens group G3 having a positive refractive power. The focus group consists of the second lens group G2, and during the focusing from the infinite distance object to the nearest object, the focus group moves to the image side along the optical axis Z.

The first lens group G1 consists of, in order from the object side to the image side, the lenses L11 to L13, the aperture stop St, and lenses L14 to L16. The second lens group G2 consists of one lens that is the lens L21. The third lens group G3 consists of, in order from the object side to the image side, two lenses including the lenses L31 and L32.

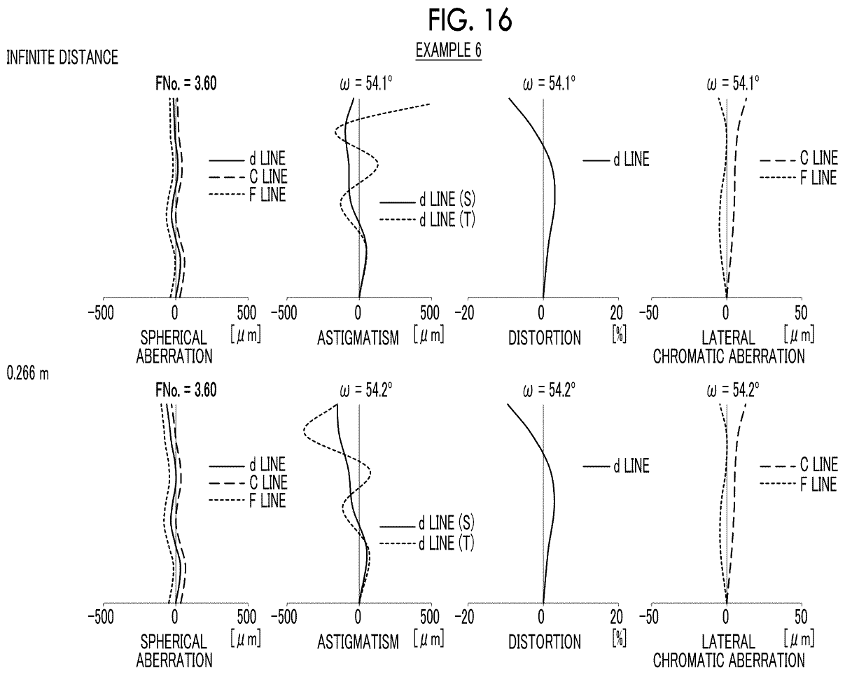

For the imaging lens of Example 6, Table 21 shows basic lens data, Table 22 shows specifications, Table 23 shows a variable surface spacing, Table 24 shows aspherical coefficients, and FIG. 16 illustrates each aberration diagram.

TABLE 21
Example 6

| Sn | R | D | Nd | vd | ED | Hinf |
|---|---|---|---|---|---|---|
| *1 | 87.8058 | 0.8228 | 1.80610 | 40.73 | 12.89 | 6.32 |
| *2 | 7.1602 | 2.5132 | | | 9.66 | |
| 3 | 14.8588 | 0.7995 | 1.49700 | 81.54 | 8.91 | |
| 4 | 9.5326 | 0.9999 | | | 8.07 | |
| 5 | 13.9634 | 1.5799 | 2.00100 | 29.14 | 7.57 | |
| 6 | 729.6407 | 1.7001 | | | 6.85 | |
| 7 (St) | ∞ | 1.9002 | | | | |
| *8 | −176.6681 | 1.0468 | 1.49710 | 81.56 | 5.36 | |
| *9 | −46.5605 | 0.3921 | | | 5.83 | (1.9) |
| 10 | 57.0732 | 3.9590 | 1.72916 | 54.68 | 6.22 | |
| 11 | −5.5685 | 0.5998 | 1.89286 | 20.36 | 7.74 | |
| 12 | −7.5253 | DD[12] | | | 8.45 | |
| *13 | −10.9538 | 0.7002 | 1.82115 | 24.06 | 9.43 | (3.88) |
| *14 | −29.1293 | DD[14] | | | 10.00 | 3.49 |
| *15 | −66.6355 | 1.2217 | 1.85070 | 26.91 | 11.88 | |
| *16 | 465.7698 | 0.0998 | | | 14.70 | 0.30/2.34/2.92 |
| 17 | 62.5324 | 2.6849 | 1.89190 | 37.13 | 17.91 | |
| 18 | −37.1835 | 5.1644 | | | 18.45 | |
| 19 | ∞ | 1.3800 | 1.51680 | 64.20 | | |
| 20 | ∞ | 1.0017 | | | | |

TABLE 22
Example 6

| | |
|---|---|
| f | 9.74 |
| Bf | 7.08 |
| Fno | 3.60 |
| 2ωm [°] | 108.2 |

TABLE 23
Example 6

| | Infinite Distance | 0.266 m |
|---|---|---|
| DD[12] | 2.3454 | 2.6239 |
| DD[14] | 3.5867 | 3.3082 |

TABLE 24
Example 6

| Sn | 1 | 2 | 8 | 9 |
|---|---|---|---|---|
| KA | 1.0000000E+00 | 1.0000000E+00 | 1.0000000E+00 | 1.0000000E+00 |
| A3 | 8.2238743E−19 | 1.0486707E−17 | −4.8552027E−17 | 5.0575028E−19 |
| A4 | 4.5130067E−03 | 4.4198918E−03 | 6.0134005E−04 | 3.2916263E−03 |
| A5 | −2.7704041E−04 | 7.8389820E−04 | −2.5570934E−03 | −6.7335403E−03 |
| A6 | −4.6079002E−04 | −8.0172980E−04 | 4.5131125E−03 | 3.4295055E−03 |
| A7 | 4.4237127E−05 | −1.4290444E−04 | −3.5346764E−03 | 2.1971222E−03 |
| A8 | 2.9058097E−05 | 1.3736433E−04 | 5.5056936E−05 | −1.7307798E−03 |
| A9 | −4.0293945E−06 | 2.5457932E−06 | 1.5349197E−03 | −7.1924453E−04 |
| A10 | −1.0482169E−06 | −1.7412092E−05 | −6.0303749E−04 | 5.6950519E−04 |
| A11 | 1.9172927E−07 | 2.7838606E−06 | −2.3198073E−04 | 1.7028344E−04 |
| A12 | 2.1393911E−08 | 1.0967151E−06 | 1.8529331E−04 | −1.2661907E−04 |
| A13 | −5.1444550E−09 | −3.6530633E−07 | 6.1454498E−07 | −2.3477849E−05 |
| A14 | −2.3300722E−10 | −1.9551297E−08 | −2.5051920E−05 | 1.7314462E−05 |
| A15 | 8.1061609E−11 | 1.9209342E−08 | 3.9905420E−06 | 1.8504784E−06 |
| A16 | 9.7290244E−13 | −9.8310273E−10 | 1.4834343E−06 | −1.3946370E−06 |
| A17 | −7.4774387E−13 | −4.5063871E−10 | −4.4556092E−07 | −7.8537180E−08 |
| A18 | 7.2659293E−15 | 4.6357274E−11 | −1.3938631E−08 | 6.0987740E−08 |
| A19 | 3.3890436E−15 | 3.7160648E−12 | 1.5560797E−08 | 1.4024713E−09 |
| A20 | −1.1004963E−16 | −5.0416018E−13 | −1.3666696E−09 | −1.1197553E−09 |
| Sn | 13 | 14 | 15 | 16 |
| KA | 1.0000000E+00 | 1.0000000E+00 | 1.0000000E+00 | 1.0000000E+00 |
| A3 | −3.1225023E−18 | 2.2812177E−18 | −1.0406384E−18 | −1.2357437E−18 |
| A4 | −2.7333319E−03 | −3.1447829E−03 | −3.7427144E−03 | −2.2617951E−03 |
| A5 | −2.7732270E−04 | −7.1831270E−04 | 3.7906234E−05 | 2.0302337E−04 |
| A6 | 8.6206119E−04 | 1.3926419E−03 | 8.3932771E−04 | 2.9797271E−04 |
| A7 | 1.5387739E−04 | −1.1211887E−04 | −1.8823231E−04 | −2.0055976E−05 |
| A8 | −2.2515038E−04 | −1.8975146E−04 | −5.1137506E−05 | −1.8224471E−05 |
| A9 | −2.9943434E−06 | 3.2184385E−05 | 2.4543427E−05 | −3.2476603E−08 |
| A10 | 2.8251033E−05 | 1.3531268E−05 | −2.0096910E−07 | 6.2224501E−07 |
| A11 | −1.9641173E−06 | −3.1155573E−06 | −1.5749588E−06 | 8.5504151E−08 |
| A12 | −1.9342424E−06 | −5.1890778E−07 | 1.8267035E−07 | −1.6828510E−08 |
| A13 | 2.4105051E−07 | 1.5961535E−07 | 5.7837703E−08 | −4.6540336E−09 |
| A14 | 7.2030697E−08 | 8.6325130E−09 | −1.0215181E−08 | 4.5477105E−10 |
| A15 | −1.2808129E−08 | −4.6142580E−09 | −1.2473613E−09 | 1.1181261E−10 |
| A16 | −1.2018319E−09 | 5.3586270E−11 | 2.7285924E−10 | −9.5585238E−12 |
| A17 | 3.3312203E−10 | 7.1170580E−11 | 1.4920524E−11 | −1.3009314E−12 |
| A18 | −9.3310618E−13 | −4.0073530E−12 | −3.7475347E−12 | 1.1342395E−13 |
| A19 | −3.4707876E−12 | −4.5632155E−13 | −7.7632956E−14 | 5.9860996E−15 |
| A20 | 2.0173073E−13 | 4.1002794E−14 | 2.1413738E−14 | −5.4830811E−16 |

### Example 7

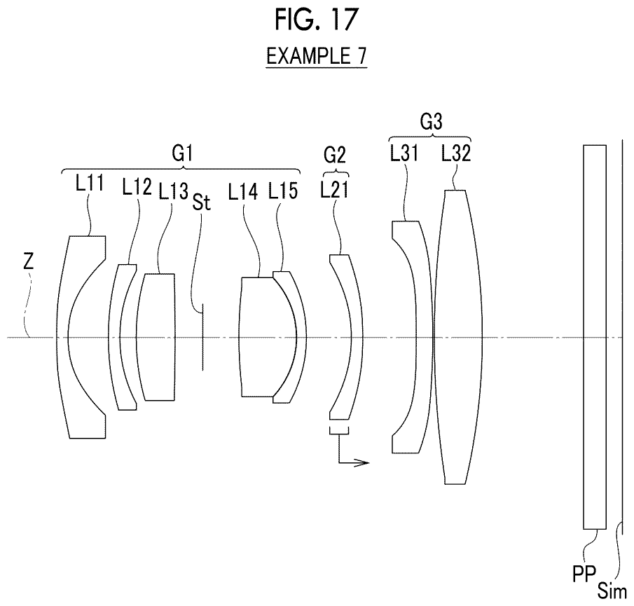

A cross-sectional view of a configuration of an imaging lens of Example 7 is illustrated in FIG. 17. The imaging lens of Example 7 consists of, in order from the object side to the image side, the first lens group G1 having a positive refractive power, the second lens group G2 having a negative refractive power, and the third lens group G3 having a positive refractive power. The focus group consists of the second lens group G2, and during the focusing from the infinite distance object to the nearest object, the focus group moves to the image side along the optical axis Z.

The first lens group G1 consists of, in order from the object side to the image side, the lenses L11 to L13, the aperture stop St, and the lenses L14 and L15. The second lens group G2 consists of one lens that is the lens L21. The third lens group G3 consists of, in order from the object side to the image side, two lenses including the lenses L31 and L32.

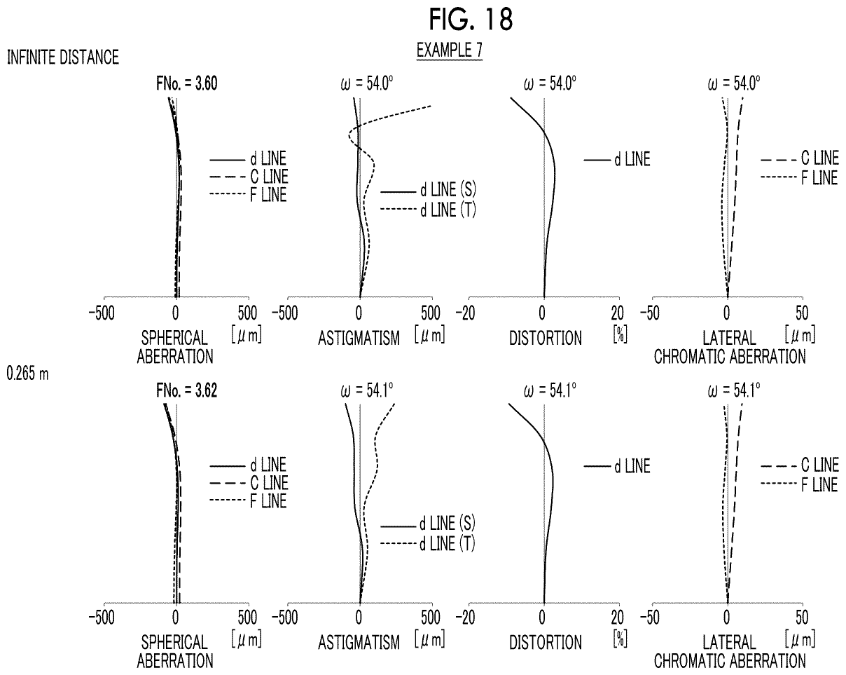

For the imaging lens of Example 7, Table 25 shows basic lens data, Table 26 shows specifications, Table 27 shows a variable surface spacing, Table 28 shows aspherical coefficients, and FIG. 18 illustrates each aberration diagram.

TABLE 25
Example 7

| Sn | R | D | Nd | vd | ED | Hinf |
|---|---|---|---|---|---|---|
| *1 | 109.3318 | 0.6951 | 1.80139 | 45.45 | 12.56 | 5.49 |
| *2 | 7.2798 | 2.4665 | | | 9.70 | |
| 3 | 16.4934 | 0.7043 | 1.43700 | 95.10 | 9.02 | |
| 4 | 8.8742 | 1.0002 | | | 8.20 | |
| 5 | 14.3607 | 2.3790 | 2.00100 | 29.14 | 7.85 | |
| 6 | −143.7028 | 1.6998 | | | 6.77 | |
| 7 (St) | ∞ | 2.2099 | | | | |
| 8 | 27.7556 | 3.5318 | 1.69680 | 55.53 | 6.19 | |
| 9 | −5.4575 | 0.6001 | 1.89286 | 20.36 | 7.40 | |
| 10 | −8.5103 | DD[10] | | | 8.15 | |
| *11 | −9.5998 | 0.7000 | 1.82115 | 24.06 | 9.35 | |
| *12 | −24.0062 | DD[12] | | | 10.24 | |
| *13 | 1305.2862 | 1.0095 | 1.76802 | 49.24 | 12.26 | 0.17 |
| *14 | −81.2177 | 0.0998 | | | 14.42 | |
| 15 | 59.7346 | 2.9378 | 1.90525 | 35.04 | 17.57 | |
| 16 | −40.2682 | 6.2018 | | | 18.29 | |
| 17 | ∞ | 1.3800 | 1.51680 | 64.20 | | |
| 18 | ∞ | 1.0016 | | | | |

TABLE 26
Example 7

| | |
|---|---|
| f | 9.78 |
| Bf | 8.11 |
| Fno | 3.60 |
| 2ωm [°] | 108.0 |

TABLE 27
Example 7

| | Infinite Distance | 0.265 m |
|---|---|---|
| DD[10] | 2.7164 | 3.0531 |
| DD[12] | 3.2735 | 2.9368 |

TABLE 28
Example 7

| Sn | 1 | 2 | 11 | 12 |
|---|---|---|---|---|
| KA | 1.0000000E+00 | 1.0000000E+00 | 1.0000000E+00 | 1.0000000E+00 |
| A3 | −1.8503717E−18 | 3.0843257E−18 | −7.3725748E−19 | 1.3687306E−18 |
| A4 | 4.0887324E−03 | 4.9918080E−03 | −1.7537175E−03 | −2.3992915E−03 |
| A5 | −2.6513104E−04 | −3.0883081E−04 | −1.1790566E−03 | −1.6574314E−03 |
| A6 | −4.0188695E−04 | −7.2874787E−04 | 6.6947339E−04 | 1.4993665E−03 |
| A7 | 4.0791310E−05 | 1.6069649E−04 | 4.4537001E−04 | 3.5289379E−06 |
| A8 | 2.5149971E−05 | 9.1838241E−05 | −2.2265858E−04 | −2.2453563E−04 |
| A9 | −3.7715850E−06 | −4.3081936E−05 | −5.6602263E−05 | 2.5578686E−05 |
| A10 | −9.0658367E−07 | −8.3513219E−06 | 3.3457142E−05 | 1.7690828E−05 |
| A11 | 1.8092278E−07 | 6.8577258E−06 | 3.8693122E−06 | −3.0409754E−06 |
| A12 | 1.8649408E−08 | 1.3850572E−07 | −2.8542508E−06 | −8.0860597E−07 |
| A13 | −4.8789376E−09 | −5.8755662E−07 | −1.4222426E−07 | 1.7161956E−07 |
| A14 | −2.1583787E−10 | 3.9147223E−08 | 1.4676284E−07 | 2.1205447E−08 |
| A15 | 7.7369952E−11 | 2.6474125E−08 | 2.0911772E−09 | −5.3198553E−09 |
| A16 | 1.3289818E−12 | −3.0779366E−09 | −4.4720898E−09 | −2.8019686E−10 |
| A17 | −7.2197691E−13 | −5.8129064E−10 | 1.8087525E−11 | 8.7170751E−11 |
| A18 | −3.7339114E−16 | 8.6875444E−11 | 7.3589538E−11 | 9.3603289E−13 |
| A19 | 3.3249436E−15 | 4.7099674E−12 | −6.8134780E−13 | −5.9129301E−13 |
| A20 | −6.6347954E−17 | −8.3289384E−13 | −4.9283496E−13 | 9.8341853E−15 |

| Sn | 13 | 14 |
|---|---|---|
| KA | 1.0000000E+00 | 1.0000000E+00 |
| A3 | 3.1219153E−18 | −1.2357437E−18 |
| A4 | −2.1742519E−03 | −1.3667128E−03 |
| A5 | −4.9557320E−04 | 2.7554151E−04 |
| A6 | 6.6198801E−04 | 5.6373171E−05 |
| A7 | −1.0640681E−04 | −2.5213532E−05 |
| A8 | −5.1995034E−05 | 6.5363665E−06 |
| A9 | 1.8597268E−05 | 2.6416960E−07 |
| A10 | 1.4499766E−06 | −7.5551771E−07 |
| A11 | −1.3302663E−06 | 7.3769757E−08 |
| A12 | 3.4767622E−08 | 2.9584836E−08 |
| A13 | 5.2310797E−08 | −4.3599566E−09 |
| A14 | −3.7419164E−09 | −5.1980654E−10 |
| A15 | −1.1956536E−09 | 1.0735940E−10 |
| A16 | 1.1480829E−10 | 2.9258080E−12 |
| A17 | 1.5133422E−11 | −1.2638205E−12 |
| A18 | −1.6767517E−12 | 2.4094342E−14 |
| A19 | −8.3198030E−14 | 5.8556199E−15 |
| A20 | 9.9979290E−15 | −2.7468726E−16 |

### Example 8

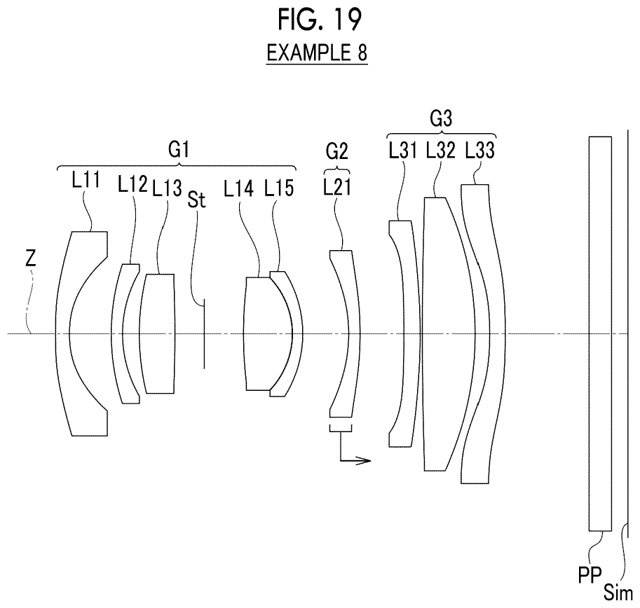

A cross-sectional view of a configuration of an imaging lens of Example 8 is illustrated in FIG. 19. The imaging lens of Example 8 consists of, in order from the object side to the image side, the first lens group G1 having a positive refractive power, the second lens group G2 having a negative refractive power, and the third lens group G3 having a positive refractive power. The focus group consists of the second lens group G2, and during the focusing from the infinite distance object to the nearest object, the focus group moves to the image side along the optical axis Z.

The first lens group G1 consists of, in order from the object side to the image side, the lenses L11 to L13, the aperture stop St, and the lenses L14 and L15. The second lens group G2 consists of one lens that is the lens L21. The third lens group G3 consists of, in order from the object side to the image side, three lenses including lenses L31 to L33.

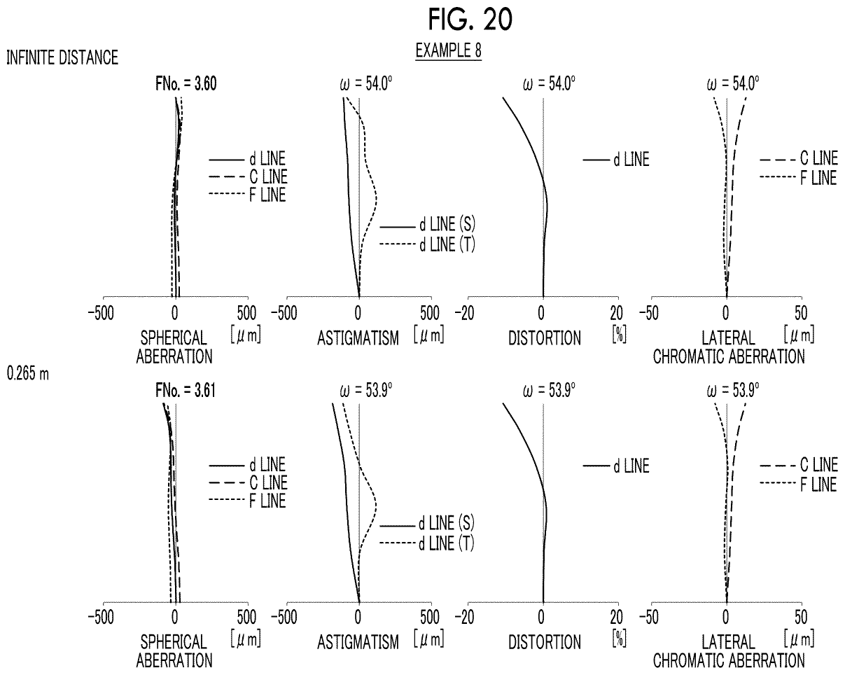

For the imaging lens of Example 8, Table 29 shows basic lens data, Table 30 shows specifications, Table 31 shows a variable surface spacing, Table 32 shows aspherical coefficients, and FIG. 20 illustrates each aberration diagram.

TABLE 29
Example 8

| Sn | R | D | Nd | vd | ED | Hinf |
|---|---|---|---|---|---|---|
| *1 | 68.4725 | 0.8503 | 1.80139 | 45.45 | 12.71 | 6.21 |
| *2 | 7.3409 | 2.5621 | | | 9.59 | |
| 3 | 14.1170 | 0.6926 | 1.43700 | 95.10 | 8.68 | |
| 4 | 7.8077 | 1.0265 | | | 7.76 | |
| 5 | 15.8089 | 2.1440 | 2.00100 | 29.13 | 7.42 | |
| 6 | −89.2226 | 1.7965 | | | 6.40 | |
| 7 (St) | ∞ | 2.4059 | | | | |
| 8 | 26.0904 | 3.0001 | 1.61800 | 63.32 | 6.09 | |
| 9 | −5.1453 | 0.6284 | 1.89286 | 20.36 | 7.01 | |
| 10 | −7.3869 | DD[10] | | | 7.78 | |
| *11 | −9.3226 | 0.6998 | 1.68948 | 31.02 | 9.44 | |
| *12 | −21.2092 | DD[12] | | | 10.38 | (4.34) |
| *13 | −457.0655 | 0.9999 | 1.69350 | 53.20 | 12.40 | |
| *14 | −55.2246 | 0.1378 | | | 14.07 | |
| 15 | 263.4030 | 3.2321 | 1.80440 | 39.58 | 15.88 | |
| 16 | −20.5808 | 0.8611 | | | 16.98 | |
| *17 | −20.5291 | 0.9501 | 1.68948 | 31.02 | 17.78 | 4.98 |
| *18 | −58.3808 | 5.1359 | | | 18.58 | 5.57 |
| 19 | ∞ | 1.3800 | 1.51680 | 64.20 | | |
| 20 | ∞ | 1.0007 | | | | |

TABLE 30
Example 8

| | |
|---|---|
| f | 10.31 |
| Bf | 7.05 |
| Fno | 3.60 |
| 2ωm [°] | 108.0 |

TABLE 31
Example 8

| | Infinite Distance | 0.265 m |
|---|---|---|
| DD[10] | 2.8152 | 3.2155 |
| DD[12] | 2.6763 | 2.2760 |

TABLE 32
Example 8

| Sn | 1 | 2 | 11 | 12 |
|---|---|---|---|---|
| KA | 1.0000000E+00 | 1.0000000E+00 | 1.0000000E+00 | 1.0000000E+00 |
| A3 | −2.0559686E−19 | 0.0000000E+00 | −6.9388939E−19 | −4.5624354E−19 |
| A4 | 4.0163543E−03 | 5.1694110E−03 | 1.5009643E−03 | 1.7823862E−03 |
| A5 | −1.9445642E−04 | −8.0044688E−05 | −2.1458234E−04 | −1.3074724E−03 |
| A6 | −3.7808256E−04 | −7.9954409E−04 | −5.4014982E−04 | 3.0342658E−04 |
| A7 | 3.1614774E−05 | 1.0912656E−04 | 1.0585703E−04 | −6.1433273E−05 |
| A8 | 2.2154615E−05 | 1.1375203E−04 | 3.8343545E−05 | −2.5819754E−05 |
| A9 | −3.1027426E−06 | −3.4814677E−05 | 8.7628620E−06 | 3.3826929E−05 |
| A10 | −7.1436689E−07 | −1.2645151E−05 | −1.8724937E−06 | −2.4781521E−06 |
| A11 | 1.5169196E−07 | 6.0300848E−06 | −3.4024652E−06 | −3.6919210E−06 |
| A12 | 1.1645461E−08 | 6.1228341E−07 | 2.3939617E−07 | 4.9481499E−07 |
| A13 | −4.0899750E−09 | −5.3718592E−07 | 3.4065505E−07 | 2.0310310E−07 |
| A14 | −6.6148166E−11 | 9.1087193E−09 | −2.7927437E−08 | −3.2797540E−08 |
| A15 | 6.4506253E−11 | 2.4665789E−08 | −1.6824324E−08 | −6.2294059E−09 |
| A16 | −4.9261124E−13 | −1.9840434E−09 | 1.6444026E−09 | 1.1083462E−09 |
| A17 | −6.0596065E−13 | −5.4609294E−10 | 4.2149165E−10 | 1.0158603E−10 |
| A18 | 1.0873019E−14 | 6.5585373E−11 | −4.6719016E−11 | −1.9201588E−11 |
| A19 | 2.8807223E−15 | 4.4234730E−12 | −4.2929546E−12 | −6.8774751E−13 |
| A20 | −9.1354955E−17 | −6.6145508E−13 | 5.2006104E−13 | 1.3543982E−13 |
| Sn | 13 | 14 | 17 | 18 |
| KA | 1.0000000E+00 | 1.0000000E+00 | 0.0000000E+00 | 0.0000000E+00 |
| A3 | 2.4281564E−18 | −3.7072311E−18 | −7.1054274E−19 | 0.0000000E+00 |
| A4 | −2.0326063E−04 | −1.7041626E−03 | −1.5283510E−03 | −7.2064221E−04 |
| A5 | −1.0970300E−03 | 4.2988905E−04 | 9.9336947E−05 | 6.0788665E−06 |
| A6 | 5.8349794E−04 | 7.8025222E−05 | 3.6234905E−05 | 1.7175695E−05 |
| A7 | −1.3835841E−05 | −3.7043307E−05 | −1.4600680E−06 | −6.2391592E−10 |
| A8 | −5.7777111E−05 | 4.8840419E−06 | −4.1151896E−07 | −1.8121502E−07 |
| A9 | 1.0334716E−05 | 8.7298486E−07 | 1.1099478E−08 | −4.4500181E−10 |
| A10 | 2.5605422E−06 | −6.5406079E−07 | 2.6269454E−09 | 1.0642184E−09 |
| A11 | −8.7381388E−07 | 5.3612359E−08 | −4.8707216E−11 | 3.2397924E−12 |
| A12 | −3.9111878E−08 | 2.5698886E−08 | −1.0083887E−11 | −3.7724553E−12 |
| A13 | 3.6540755E−08 | −3.9365783E−09 | 1.2800603E−13 | −1.0554002E−14 |
| A14 | −1.0386542E−09 | −4.2513979E−10 | 2.3780342E−14 | 8.2857548E−15 |
| A15 | −8.6403535E−10 | 1.0191690E−10 | −1.9878056E−16 | 1.8083215E−17 |
| A16 | 5.7448963E−11 | 1.4833856E−12 | −3.3729365E−17 | −1.1056351E−17 |
| A17 | 1.1248351E−11 | −1.2248040E−12 | 1.6812457E−19 | −1.5844880E−20 |
| A18 | −1.0157711E−12 | 3.6479472E−14 | 2.6401189E−20 | 8.2255174E−21 |
| A19 | −6.3722387E−14 | 5.7362106E−15 | −5.9681362E−23 | 5.5946634E−24 |
| A20 | 6.8013995E−15 | −3.1982366E−16 | −8.7622219E−24 | −2.6201487E−24 |

### Example 9

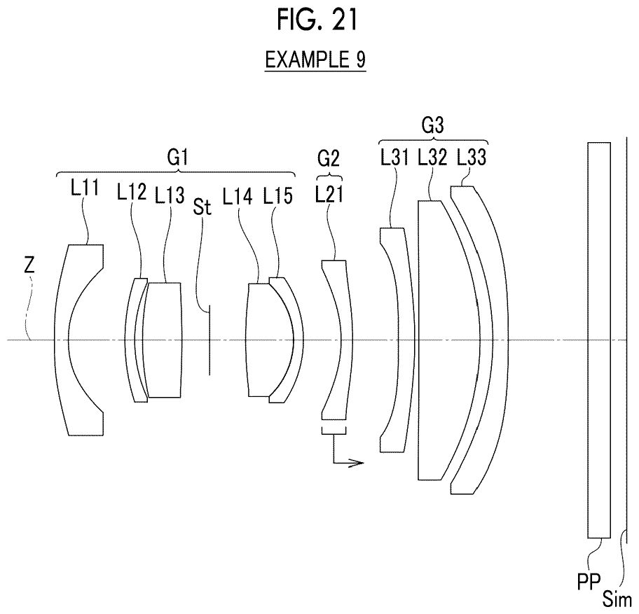

A cross-sectional view of a configuration of an imaging lens of Example 9 is illustrated in FIG. 21. The imaging lens of Example 9 consists of, in order from the object side to the image side, the first lens group G1 having a positive refractive power, the second lens group G2 having a negative refractive power, and the third lens group G3 having a positive refractive power. The focus group consists of the second lens group G2, and during the focusing from the infinite distance object to the nearest object, the focus group moves to the image side along the optical axis Z.

The first lens group G1 consists of, in order from the object side to the image side, the lenses L11 to L13, the aperture stop St, and the lenses L14 and L15. The second lens group G2 consists of one lens that is the lens L21. The third lens group G3 consists of, in order from the object side to the image side, three lenses including the lenses L31 to L33.

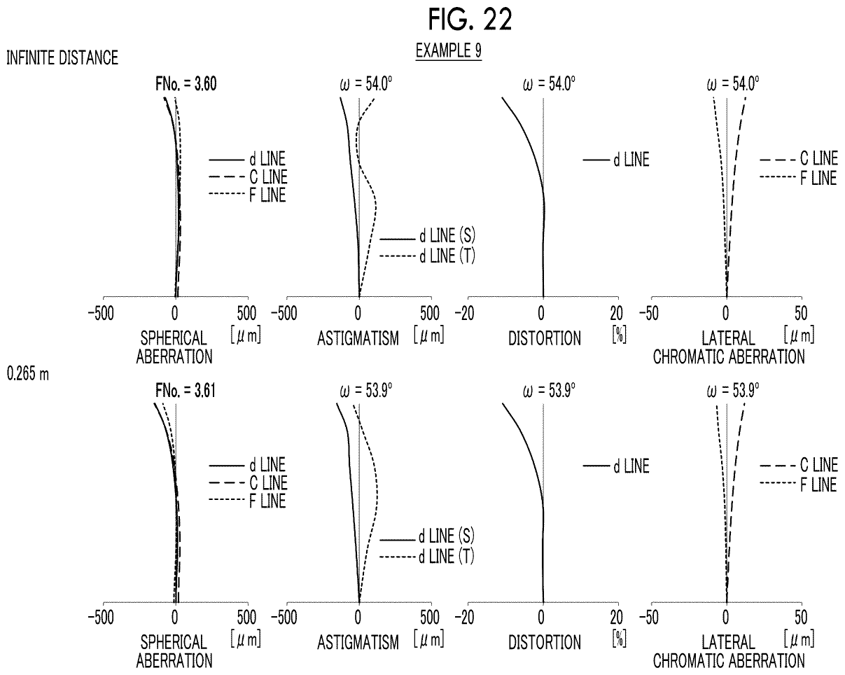

For the imaging lens of Example 9, Table 33 shows basic lens data, Table 34 shows specifications, Table 35 shows a variable surface spacing, Table 36 shows aspherical coefficients, and FIG. 22 illustrates each aberration diagram.

TABLE 33
Example 9

| Sn | R | D | Nd | vd | ED | Hinf |
|---|---|---|---|---|---|---|
| *1 | 89.0215 | 0.8500 | 1.80139 | 45.45 | 12.77 | 6.21 |
| *2 | 7.0929 | 3.4672 | | | 9.54 | |
| 3 | 12.7532 | 0.6002 | 1.43700 | 95.10 | 8.03 | |
| 4 | 8.7861 | 0.4766 | | | 7.40 | |
| 5 | 16.6724 | 2.3796 | 2.00100 | 29.13 | 7.35 | |
| 6 | −59.1216 | 1.6998 | | | 6.20 | |
| 7 (St) | ∞ | 2.2093 | | | | |
| 8 | 26.1122 | 2.9361 | 1.61800 | 63.32 | 6.20 | |
| 9 | −4.8962 | 0.5998 | 1.89286 | 20.36 | 7.04 | |
| 10 | −7.0137 | DD[10] | | | 7.81 | |
| *11 | −8.1164 | 0.6998 | 1.68948 | 31.02 | 9.00 | |
| *12 | −23.9890 | DD[12] | | | 9.93 | (3.08) |
| *13 | −256.9881 | 0.9996 | 1.69350 | 53.20 | 12.13 | |
| *14 | −31.0413 | 0.2498 | | | 13.99 | |
| 15 | −960.7652 | 3.7187 | 1.80440 | 39.58 | 16.09 | |
| 16 | −17.1516 | 0.7835 | | | 17.39 | |
| *17 | −16.6908 | 0.9499 | 1.68948 | 31.02 | 17.86 | |
| *18 | −62.8379 | 4.8807 | | | 19.14 | |
| 19 | ∞ | 1.3800 | 1.51680 | 64.20 | | |
| 20 | ∞ | 1.0007 | | | | |

TABLE 34
Example 9

| | |
|---|---|
| f | 10.31 |
| Bf | 6.79 |
| Fno | 3.60 |
| 2ωm [°] | 108.0 |

TABLE 35
Example 9

| | Infinite Distance | 0.265 m |
|---|---|---|
| DD[10] | 2.3127 | 2.5942 |
| DD[12] | 2.8101 | 2.5286 |

TABLE 36
Example 9

| Sn | 1 | 2 | 11 | 12 |
|---|---|---|---|---|
| KA | 1.0000000E+00 | 1.0000000E+00 | 1.0000000E+00 | 1.0000000E+00 |
| A3 | 5.1399214E−19 | −3.0843257E−18 | 3.1225023E−18 | 1.3687306E−18 |
| A4 | 4.4674426E−03 | 5.6278034E−03 | −1.4417477E−03 | −1.3127629E−03 |
| A5 | −1.4066305E−04 | 2.1078027E−06 | 3.5449331E−04 | −1.2184021E−03 |
| A6 | −4.7823240E−04 | −8.4000826E−04 | 2.4260904E−04 | 1.1494123E−03 |
| A7 | 2.4411689E−05 | 9.0050986E−05 | −2.8021668E−05 | −7.4126888E−05 |
| A8 | 3.3603801E−05 | 9.9979490E−05 | −6.4937693E−05 | −1.5357741E−04 |
| A9 | −2.5701465E−06 | −3.1793617E−05 | 3.0182382E−05 | 3.5587181E−05 |
| A10 | −1.4709784E−06 | −8.5385767E−06 | 3.6654540E−06 | 9.1178071E−06 |
| A11 | 1.2745198E−07 | 5.7127529E−06 | −5.5795047E−06 | −3.8462897E−06 |
| A12 | 4.2337133E−08 | 1.3493263E−07 | 4.1117658E−07 | −1.6137130E−07 |
| A13 | −3.4076249E−09 | −5.1652348E−07 | 4.7869868E−07 | 2.1140455E−07 |
| A14 | −8.4456837E−10 | 3.9186427E−08 | −6.8416071E−08 | −9.4534405E−09 |
| A15 | 5.2966645E−11 | 2.3863966E−08 | −2.2088890E−08 | −6.4940089E−09 |
| A16 | 1.1544087E−11 | −3.0673321E−09 | 3.9205291E−09 | 6.0088536E−10 |
| A17 | −4.9853257E−13 | −5.2912321E−10 | 5.3162904E−10 | 1.0615433E−10 |
| A18 | −9.2794518E−14 | 8.6623492E−11 | −1.0473642E−10 | −1.3047147E−11 |
| A19 | 2.4574674E−15 | 4.2730392E−12 | −5.2624131E−12 | −7.2060803E−13 |
| A20 | 2.8929368E−16 | −8.3274274E−13 | 1.0964862E−12 | 1.0356498E−13 |

| Sn | 13 | 14 | 17 | 18 |
|---|---|---|---|---|
| KA | 1.0000000E+00 | 1.0000000E+00 | 0.0000000E+00 | 0.0000000E+00 |
| A3 | −1.7343974E−19 | 0.0000000E+00 | 1.2212453E−19 | −1.1102230E−19 |
| A4 | −1.0197545E−03 | −1.2182550E−03 | −1.1418896E−04 | −1.5609684E−04 |
| A5 | −1.1122342E−03 | 4.2881069E−04 | 1.4333717E−05 | −1.9783336E−05 |
| A6 | 7.2562934E−04 | 7.3902922E−05 | 4.0352628E−07 | 1.8659498E−06 |
| A7 | −2.3555477E−05 | −3.6112951E−05 | −1.0257475E−07 | 1.5767495E−07 |
| A8 | −7.5569262E−05 | 1.1549962E−07 | −3.9347280E−09 | −1.4792850E−08 |
| A9 | 1.2089259E−05 | 8.1112252E−07 | 4.3250467E−10 | −8.3240215E−10 |
| A10 | 3.7576811E−06 | −2.0504138E−07 | 2.0489173E−11 | 7.3740996E−11 |
| A11 | −1.0126681E−06 | 5.6042805E−08 | −1.2147197E−12 | 2.8863431E−12 |
| A12 | −8.3754914E−08 | 6.7049213E−09 | −6.4687788E−14 | −2.3294794E−13 |
| A13 | 4.2640162E−08 | −3.9969569E−09 | 2.2220495E−15 | −6.4249880E−15 |
| A14 | −9.3311046E−11 | 1.6203915E−11 | 1.2703670E−16 | 4.6415549E−16 |
| A15 | −1.0177282E−09 | 1.0281462E−10 | −2.5291198E−18 | 8.8073802E−18 |
| A16 | 4.6303412E−11 | −4.3327388E−12 | −1.5141381E−19 | −5.6330041E−19 |
| A17 | 1.3329793E−11 | −1.2319972E−12 | 1.6252919E−21 | −6.7507849E−21 |
| A18 | −9.4671087E−13 | 7.7279220E−14 | 1.0012371E−22 | 3.7895168E−22 |
| A19 | −7.5472890E−14 | 5.7599601E−15 | −4.5101432E−25 | 2.2104397E−24 |
| A20 | 6.5943449E−15 | −4.3822859E−16 | −2.8140390E−26 | −1.0799157E−25 |

### Example 10

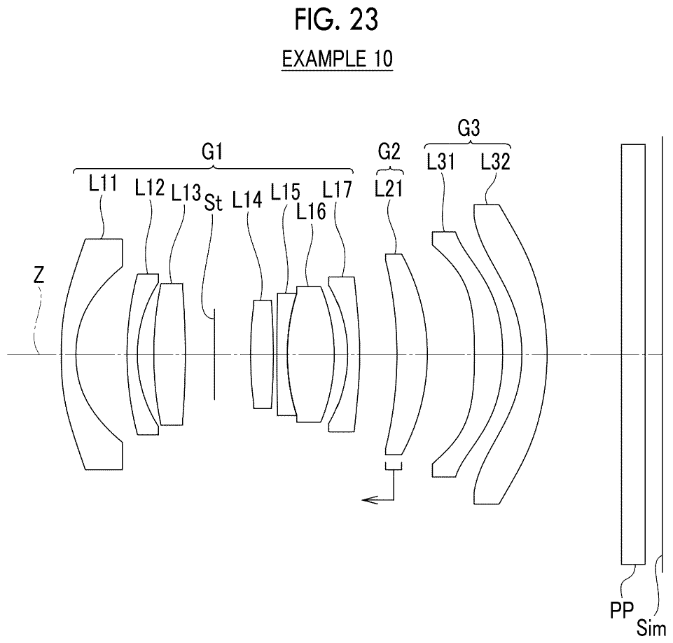

A cross-sectional view of a configuration of an imaging lens of Example 10 is illustrated in FIG. 23. The imaging lens of Example 10 consists of, in order from the object side to the image side, the first lens group G1 having a positive refractive power, the second lens group G2 having a positive refractive power, and the third lens group G3 having a positive refractive power. The focus group consists of the second lens group G2, and during the focusing from the infinite distance object to the nearest object, the focus group moves to the object side along the optical axis Z.

The first lens group G1 consists of, in order from the object side to the image side, the lenses L11 to L13, the aperture stop St, and lenses L14 to L17. The second lens group G2 consists of one lens that is the lens L21. The third lens group G3 consists of, in order from the object side to the image side, two lenses including the lenses L31 and L32.

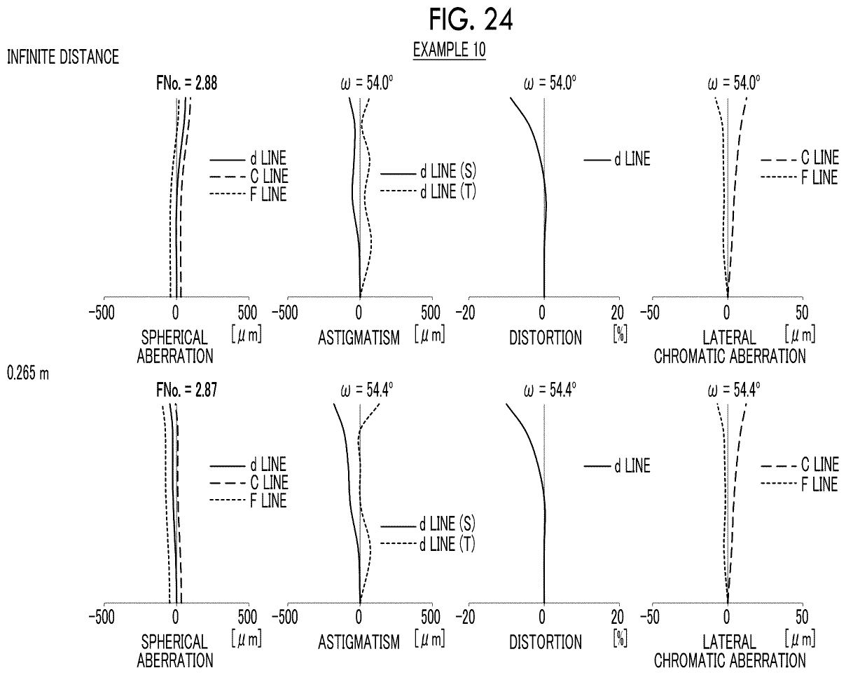

For the imaging lens of Example 10, Table 37 shows basic lens data, Table 38 shows specifications, Table 39 shows a variable surface spacing, Tables 40A and 40B show aspherical coefficients, and FIG. 24 illustrates each aberration diagram.

TABLE 37
Example 10

| Sn | R | D | Nd | vd | ED | Hinf |
|---|---|---|---|---|---|---|
| *1 | 29.6565 | 0.8502 | 1.80139 | 45.45 | 13.68 | 6.21 |
| *2 | 7.3376 | 2.9840 | | | 10.40 | |
| 3 | 18.8507 | 0.6002 | 1.43700 | 95.10 | 9.51 | |
| 4 | 7.9965 | 0.9581 | | | 8.49 | |
| 5 | 21.0617 | 1.8369 | 2.00100 | 29.13 | 8.38 | |
| 6 | −49.9489 | 1.7002 | | | 7.70 | |
| 7 (St) | ∞ | 2.1126 | | | | |
| *8 | 27.5825 | 1.3250 | 1.80139 | 45.45 | 5.80 | |
| *9 | −37.7610 | 0.2103 | | | 6.37 | |
| 10 | 219.9200 | 0.6002 | 1.84666 | 23.78 | 6.71 | |
| 11 | 12.1690 | 2.7387 | 1.72916 | 54.68 | 7.24 | |
| 12 | −10.6403 | 0.7555 | | | 8.01 | |
| *13 | −7.7274 | 0.7002 | 1.68948 | 31.02 | 8.18 | |
| *14 | −21.0051 | DD[14] | | | 9.17 | (3.75) |
| 15 | −23.7799 | 1.7703 | 1.77250 | 49.60 | 11.13 | |
| 16 | −12.5430 | DD[16] | | | 11.88 | |
| *17 | −36.8454 | 1.6451 | 1.69350 | 53.18 | 12.98 | 6.44 |
| *18 | −13.2871 | 1.1206 | | | 14.54 | 5.57 |
| *19 | −9.2284 | 1.4664 | 1.68948 | 31.02 | 16.32 | 5.09 |
| *20 | −16.1057 | 4.3367 | | | 1716 | 8.08/8.59 |
| 21 | ∞ | 1.3800 | 1.51680 | 64.20 | | |
| 22 | ∞ | 0.9994 | | | | |

TABLE 38
Example 10

| | |
|---|---|
| f | 10.31 |
| Bf | 6.25 |
| Fno | 2.88 |
| 2ωm [°] | 108.0 |

TABLE 39
Example 10

| | Infinite Distance | 0.265 m |
|---|---|---|
| DD[14] | 2.1729 | 1.4703 |
| DD[16] | 2.7515 | 3.4541 |

TABLE 40A
Example 10

| Sn | 1 | 2 | 8 | 9 |
|---|---|---|---|---|
| KA | 1.0000000E+00 | 1.0000000E+00 | 0.0000000E+00 | 0.0000000E+00 |
| A3 | −2.2615654E−18 | −5.5517863E−18 | 4.9737992E−18 | 4.9737992E−18 |
| A4 | 2.1135821E−03 | 2.3944029E−03 | 4.5705879E−04 | 1.9045185E−04 |
| A5 | 9.8367855E−05 | 4.4987914E−04 | −1.5205493E−05 | 6.6606066E−06 |
| A6 | −1.7418258E−04 | −2.0486845E−04 | 4.7213736E−07 | −9.0523544E−06 |
| A7 | −8.6989463E−06 | −1.4723240E−04 | 3.9991952E−07 | 1.4017498E−06 |
| A8 | 1.0495525E−05 | 5.9257750E−05 | 6.9595571E−08 | −2.9262276E−08 |
| A9 | −6.8133348E−08 | 1.6824278E−05 | −1.0445202E−08 | −1.6941204E−08 |
| A10 | −3.4188588E−07 | −1.2607804E−05 | −7.0260084E−10 | 1.0563630E−09 |
| A11 | 1.4922192E−08 | 4.3342539E−07 | 5.0970685E−11 | 8.2265615E−11 |
| A12 | 5.3197045E−09 | 1.1002104E−06 | 2.9838025E−12 | −6.8114130E−12 |
| A13 | −2.9602590E−10 | −1.8561692E−07 | −1.2330489E−13 | −2.1782629E−13 |
| A14 | −3.0401945E−11 | −3.9078137E−08 | −6.7020731E−15 | 2.1326317E−14 |
| A15 | 9.8179068E−13 | 1.1843340E−08 | 1.6525758E−16 | 3.2584265E−16 |
| A16 | −1.4912498E−14 | 2.1465118E−10 | 8.1923698E−18 | −3.6438642E−17 |
| A17 | −1.7683434E−14 | −2.9381902E−10 | −1.1862087E−19 | −2.5721214E−19 |
| A18 | 3.1028232E−15 | 1.5448174E−11 | −5.0074616E−21 | 3.2646524E−20 |
| A19 | 5.6923689E−16 | 2.3504332E−12 | 3.5925037E−23 | 8.2855671E−23 |
| A20 | −6.3497535E−17 | −1.9949031E−13 | 1.1266891E−24 | −1.2023997E−23 |

| Sn | 13 | 14 | 17 | 18 |
|---|---|---|---|---|
| KA | 1.0000000E+00 | 1.0000000E+00 | 1.0000000E+00 | 1.0000000E+00 |
| A3 | −1.3877788E−18 | 9.1248708E−19 | 2.9484756E−18 | 4.9429748E−18 |
| A4 | 1.4855782E−03 | 1.7544995E−03 | −8.5538382E−04 | −1.6245312E−03 |
| A5 | −8.7643878E−04 | −1.4344851E−03 | −6.3809467E−04 | 3.2571013E−04 |
| A6 | 3.4109808E−04 | 8.3676073E−04 | 3.8496903E−04 | −6.3055384E−05 |
| A7 | 1.7408001E−04 | −8.7035151E−05 | −4.4719853E−05 | −1.2216894E−05 |
| A8 | −1.9258795E−04 | −1.3249163E−04 | −3.0190543E−05 | 1.1448654E−05 |
| A9 | 1.9186678E−05 | 4.4192613E−05 | 8.5133831E−06 | −1.1696619E−06 |
| A10 | 2.6124612E−05 | 7.1122835E−06 | 9.4534867E−07 | −6.1763180E−07 |
| A11 | −6.4397258E−06 | −4.9246904E−06 | −5.6253380E−07 | 1.4220123E−07 |
| A12 | −1.6294036E−06 | 3.4666063E−08 | 4.6317986E−09 | 1.3245363E−08 |
| A13 | 6.3887006E−07 | 2.7737197E−07 | 2.0383177E−08 | −6.1364719E−09 |
| A14 | 4.0123603E−08 | −2.1500277E−08 | −1.2601018E−09 | 3.3795336E−11 |
| A15 | −3.1608606E−08 | −8.6978751E−09 | −4.4613430E−10 | 1.3348014E−10 |
| A16 | 5.2737109E−10 | 1.0208415E−09 | 4.1137119E−11 | −6.5032118E−12 |
| A17 | 7.9275629E−10 | 1.4471312E−10 | 5.7968018E−12 | −1.4682896E−12 |
| A18 | −4.6993742E−11 | −2.0721296E−11 | −6.4156667E−13 | 1.0611208E−13 |
| A19 | −8.0468301E−12 | −9.9742497E−13 | −3.5169858E−14 | 6.5174247E−15 |
| A20 | 6.8308025E−13 | 1.6067871E−13 | 4.2807312E−15 | −5.6481080E−16 |

TABLE 40B
Example 10

| Sn | 19 | 20 |
|---|---|---|
| KA | 0.0000000E+00 | 0.0000000E+00 |
| A3 | −2.2204460E−18 | 9.2370556E−18 |
| A4 | −1.0556496E−03 | −7.5331920E−04 |
| A5 | 7.5999417E−05 | 3.0610664E−04 |
| A6 | 2.6945557E−05 | −3.1660585E−05 |
| A7 | −7.2747374E−07 | −4.1743278E−06 |
| A8 | −2.9073699E−07 | 7.1278687E−07 |
| A9 | 3.3387539E−09 | 2.4707055E−08 |
| A10 | 1.7559954E−09 | −5.8503490E−09 |
| A11 | −9.6730603E−12 | −9.1273904E−11 |
| A12 | −6.3964018E−12 | 2.5164298E−11 |
| A13 | 1.7161004E−14 | 2.1096534E−13 |
| A14 | 1.4374005E−14 | −6.2413282E−14 |
| A15 | −1.7548020E−17 | −2.9595982E−16 |
| A16 | −1.9503917E−17 | 8.9953256E−17 |
| A17 | 8.9943715E−21 | 2.2972735E−19 |
| A18 | 1.4655293E−20 | −7.0107179E−20 |
| A19 | −1.5525408E−24 | −7.5603160E−23 |
| A20 | −4.6833486E−24 | 2.2880676E−23 |

### Example 11

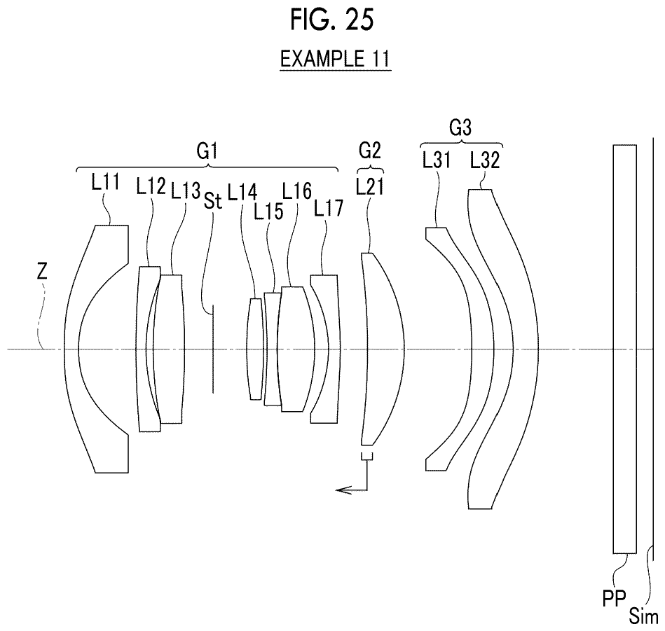

A cross-sectional view of a configuration of an imaging lens of Example 11 is illustrated in FIG. 25. The imaging lens of Example 11 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, the lenses L11 to L13, the aperture stop St, and the lenses L14 to L17. The second lens group G2 consists of one lens that is the lens L21. The third lens group G3 consists of, in order from the object side to the image side, two lenses including the lenses L31 and L32.

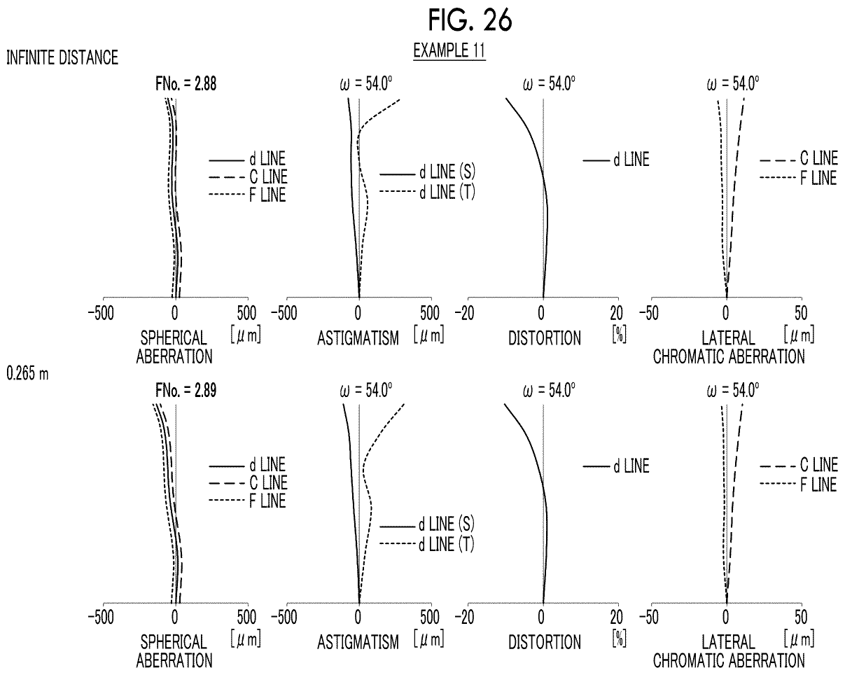

For the imaging lens of Example 11, Table 41 shows basic lens data, Table 42 shows specifications, Table 43 shows a variable surface spacing, Tables 44A and 44B show aspherical coefficients, and FIG. 26 illustrates each aberration diagram.

TABLE 41
Example 11

| Sn | R | D | Nd | vd | ED | Hinf |
|---|---|---|---|---|---|---|
| *1 | 29.1308 | 0.8500 | 1.80139 | 45.45 | 13.18 | 6.06 |
| *2 | 7.2822 | 3.4215 | | | 9.96 | |
| 3 | 58.4772 | 0.6003 | 1.43700 | 95.10 | 8.98 | |
| 4 | 11.0518 | 0.4269 | | | 8.09 | |
| 5 | 22.9324 | 1.8341 | 2.00100 | 29.13 | 8.08 | |
| 6 | −41.7970 | 1.7002 | | | 7.37 | |
| 7 (St) | ∞ | 2.0002 | | | | |
| *8 | 22.4642 | 1.0002 | 1.80139 | 45.45 | 5.80 | |
| *9 | −26.5808 | 0.2103 | | | 6.13 | |
| 10 | −32.6994 | 0.6001 | 1.84666 | 23.78 | 6.30 | |
| 11 | 22.2167 | 2.2381 | 1.72916 | 54.68 | 6.83 | |
| 12 | −10.3916 | 0.8246 | | | 7.57 | |
| *13 | −6.8766 | 0.7000 | 1.68948 | 31.02 | 7.78 | |
| *14 | −21.8538 | DD[14] | | | 8.97 | (2.35) |
| 15 | −42.8678 | 2.1870 | 1.69680 | 55.53 | 11.07 | |
| 16 | −9.9194 | DD[16] | | | 11.65 | |
| *17 | −28.7134 | 1.3178 | 1.69350 | 53.18 | 13.37 | 6.63 |
| *18 | −13.3604 | 1.1204 | | | 14.74 | 5.68 |
| *19 | −9.1035 | 1.4998 | 1.68948 | 31.02 | 16.63 | 4.96 |
| *20 | −16.3421 | 4.4562 | | | 17.95 | 7.23 |
| 21 | ∞ | 1.3800 | 1.51680 | 64.20 | | |
| 22 | ∞ | 1.0000 | | | | |

TABLE 42
Example 11

| | |
|---|---|
| f | 10.31 |
| Bf | 6.37 |
| Fno | 2.88 |
| 2ωm [°] | 108.0 |

TABLE 43
Example 11

| | Infinite Distance | 0.265 m |
|---|---|---|
| DD[14] | 1.6240 | 1.2235 |
| DD[16] | 4.0184 | 4.4189 |

TABLE 44A
Example 11

| Sn | 1 | 2 | 8 | 9 |
|---|---|---|---|---|
| KA | 1.0000000E+00 | 1.0000000E+00 | 0.0000000E+00 | 0.0000000E+00 |
| A3 | 7.7098821E−20 | 2.7758931E−18 | 1.7408297E−17 | −1.2079227E−17 |
| A4 | 2.4290731E−03 | 1.8978058E−03 | 6.6651959E−04 | 4.2062469E−04 |
| A5 | 1.2685712E−04 | 9.2162826E−04 | −2.1633640E−06 | 6.5205890E−06 |
| A6 | −1.9284463E−04 | −8.0048597E−05 | −7.5274276E−06 | −9.6644295E−06 |
| A7 | −1.1538334E−05 | −2.5443586E−04 | −1.6473611E−06 | −1.7219007E−06 |
| A8 | 1.1180465E−05 | 4.3050859E−05 | 3.0930104E−07 | −1.6997055E−07 |
| A9 | 1.4185506E−07 | 3.3487191E−05 | −1.0098636E−09 | 7.2256048E−09 |
| A10 | −3.4338024E−07 | −1.1891460E−05 | −2.8067514E−09 | 2.9382162E−09 |
| A11 | 4.5424997E−09 | −1.1667206E−06 | 2.8794274E−11 | −1.8099435E−11 |
| A12 | 4.3123944E−09 | 1.1499018E−06 | 1.2384967E−11 | −1.7242916E−11 |
| A13 | 2.3816162E−11 | −9.1068744E−08 | −9.0498347E−14 | 3.3792181E−14 |
| A14 | 1.2133509E−11 | −4.6678094E−08 | −3.0844295E−14 | 5.2119253E−14 |
| A15 | −4.8794414E−12 | 8.4875071E−09 | 1.3561046E−16 | −5.0171351E−17 |
| A16 | −8.3021779E−13 | 5.9548516E−10 | 4.4322665E−17 | −8.7331842E−17 |
| A17 | 4.0638449E−14 | −2.2818088E−10 | −1.0421385E−19 | 5.0801620E−20 |
| A18 | 1.0810534E−14 | 6.5406474E−12 | −3.4358565E−20 | 7.7196861E−20 |
| A19 | 3.2699549E−16 | 1.8067044E−12 | 3.2960054E−23 | −2.3443688E−23 |
| A20 | −9.2344586E−17 | −1.1774120E−13 | 1.1145196E−23 | −2.8138607E−23 |

| Sn | 13 | 14 | 17 | 18 |
|---|---|---|---|---|
| KA | 1.0000000E+00 | 1.0000000E+00 | 1.0000000E+00 | 1.0000000E+00 |
| A3 | −1.3877788E−18 | 0.0000000E+00 | 8.6719870E−19 | −3.7072311E−18 |
| A4 | 1.7792276E−03 | 2.7190748E−03 | −9.6743953E−04 | −1.4131178E−03 |
| A5 | −1.4013967E−04 | −1.3642503E−03 | −5.3220059E−04 | 2.5959046E−04 |
| A6 | 1.1664623E−04 | 6.6725554E−04 | 4.3944432E−04 | −2.7489694E−05 |
| A7 | −4.2947120E−05 | −9.3030810E−05 | −6.0843973E−05 | −6.9753899E−06 |
| A8 | −1.1304012E−04 | −1.1119658E−04 | −3.8605649E−05 | 5.4834560E−06 |
| A9 | 5.5031006E−05 | 4.4912670E−05 | 1.0133570E−05 | −1.4474524E−06 |
| A10 | 1.1187427E−05 | 5.1506838E−06 | 1.5614285E−06 | −2.1649053E−07 |
| A11 | −1.0020925E−05 | −5.0010706E−06 | −6.6611385E−07 | 1.5145106E−07 |
| A12 | −1.4106758E−08 | 1.6233107E−07 | −2.0358238E−08 | −1.8783513E−09 |
| A13 | 8.5854004E−07 | 2.8226553E−07 | 2.4494899E−08 | −6.3290741E−09 |
| A14 | −6.4304230E−08 | −2.7022485E−08 | −6.7778107E−10 | 3.7638491E−10 |
| A15 | −3.9687606E−08 | −8.8727121E−09 | −5.4386659E−10 | 1.3591111E−10 |
| A16 | 4.5130832E−09 | 1.1692752E−09 | 3.3730248E−11 | −1.1130154E−11 |
| A17 | 9.5621383E−10 | 1.4795312E−10 | 7.0709491E−12 | −1.4853003E−12 |
| A18 | −1.2979204E−10 | −2.2946427E−11 | −5.9982308E−13 | 1.4043336E−13 |
| A19 | −9.4455833E−12 | −1.0217592E−12 | −4.2187234E−14 | 6.5680966E−15 |
| A20 | 1.4045699E−12 | 1.7483177E−13 | 4.2507298E−15 | −6.7234926E−16 |

TABLE 44B
Example 11

| Sn | 19 | 20 |
|---|---|---|
| KA | 0.0000000E+00 | 0.0000000E+00 |
| A3 | 1.0658141E−18 | 7.8159701E−18 |
| A4 | −1.0360019E−03 | −8.0440995E−04 |
| A5 | 1.1304146E−04 | 3.1753494E−04 |
| A6 | 2.2381801E−05 | −3.1205350E−05 |
| A7 | −1.0567613E−06 | −4.2750041E−06 |
| A8 | −2.3967155E−07 | 7.1648145E−07 |
| A9 | 5.3354050E−09 | 2.5262539E−08 |
| A10 | 1.4382046E−09 | −5.9090841E−09 |
| A11 | −1.7301240E−11 | −9.3142180E−11 |
| A12 | −5.2155611E−12 | 2.5483109E−11 |
| A13 | 3.5324349E−14 | 2.1494250E−13 |
| A14 | 1.1686031E−14 | −6.3328197E−14 |
| A15 | −4.3661735E−17 | −3.0122751E−16 |
| A16 | −1.5828467E−17 | 9.1430553E−17 |
| A17 | 2.9715782E−20 | 2.3371256E−19 |
| A18 | 1.1884307E−20 | −7.1376451E−20 |
| A19 | −8.5158233E−24 | −7.6919899E−23 |
| A20 | −3.7984952E−24 | 2.3332902E−23 |

### Example 12

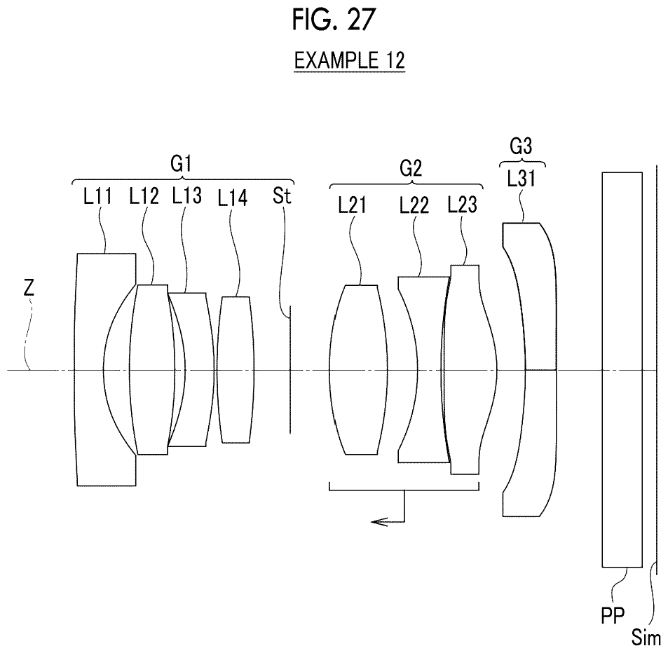

A cross-sectional view of a configuration of an imaging lens of Example 12 is illustrated in FIG. 27. The imaging lens of Example 12 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, four lenses including the lenses L11 to L14, and the aperture stop St. The second lens group G2 consists of, in order from the object side to the image side, three lenses including the lenses L21 to L23. The third lens group G3 consists of one lens that is the lens L31.

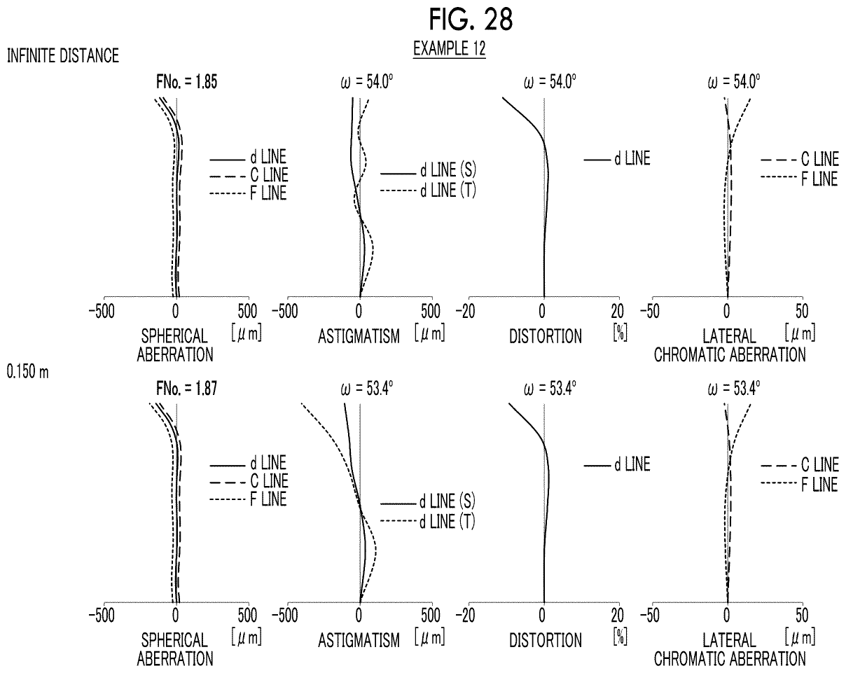

For the imaging lens of Example 12, Table 45 shows basic lens data, Table 46 shows specifications, Table 47 shows a variable surface spacing, Tables 48A and 48B show aspherical coefficients, and FIG. 28 illustrates each aberration diagram.

TABLE 45
Example 12

| Sn | R | D | Nd | vd | ED | Hinf |
|---|---|---|---|---|---|---|
| *1 | −130.9793 | 1.0000 | 1.80139 | 45.45 | 8.14 | 0.56/3.09 |
| *2 | 4.8573 | 0.8969 | | | 6.00 | |
| 3 | 15.1597 | 1.5694 | 1.95375 | 32.32 | 5.94 | |
| 4 | −14.5402 | 0.3579 | | | 5.38 | |
| *5 | −5.4050 | 1.0000 | 2.00178 | 19.32 | 5.38 | |
| *6 | −9.8761 | 0.1000 | | | 5.12 | |
| 7 | 18.0211 | 1.2771 | 1.90525 | 35.04 | 5.04 | |
| 8 | −19.4648 | 1.2504 | | | 4.98 | |
| 9 (St) | ∞ | DD[9] | | | | |
| *10 | 9.3393 | 1.9888 | 1.85135 | 40.10 | 5.48 | |
| *11 | −11.0363 | 1.0406 | | | 5.63 | |
| 12 | −6.3516 | 0.8072 | 1.92286 | 18.90 | 5.65 | |
| 13 | 18.3414 | 0.1119 | | | 6.52 | |
| *14 | −4796.8892 | 1.8204 | 1.73077 | 40.51 | 6.60 | 0.06/2.91 |
| *15 | −4.4313 | DD[15] | | | 7.32 | 1.92/3.36 |
| *16 | −13.9199 | 1.0661 | 1.49710 | 81.56 | 8.53 | |
| *17 | 343.8363 | 1.5916 | | | 10.15 | 1.58 |
| 18 | ∞ | 1.3800 | 1.51680 | 64.20 | | |
| 19 | ∞ | 0.4998 | | | | |

TABLE 46
Example 12

| | |
|---|---|
| f | 5.87 |
| Bf | 3.00 |
| Fno | 1.85 |
| 2ωm [°] | 108.0 |

TABLE 47
Example 12

| | Infinite Distance | 0.150 m |
|---|---|---|
| DD[9] | 1.3500 | 1.1719 |
| DD[15] | 0.9844 | 1.1625 |

TABLE 48A
Example 12

| Sn | 1 | 2 | 5 | 6 |
|---|---|---|---|---|
| KA | −8.3804637E+03 | −4.5414661E−01 | −9.9075428E−02 | 9.3921144E−01 |
| A3 | 0.0000000E+00 | 0.0000000E+00 | 6.4216962E−19 | −3.8863640E−18 |
| A4 | 5.4188662E−04 | 4.3551949E−03 | 1.2823708E−03 | 1.0365529E−03 |
| A5 | 1.8006985E−03 | 8.8659125E−05 | −1.1799096E−05 | 1.0065989E−04 |
| A6 | −6.6708006E−04 | 4.1896137E−04 | −2.4336712E−05 | −1.5082274E−05 |
| A7 | −1.2201588E−04 | −2.7211245E−04 | 1.1282258E−08 | −2.9915797E−07 |
| A8 | 6.4435376E−05 | −1.5205150E−04 | 2.4278473E−07 | 1.6131162E−07 |
| A9 | 3.4506827E−06 | 7.0774795E−05 | 1.1988152E−09 | 3.8413141E−09 |
| A10 | −2.7202648E−06 | 1.4302098E−05 | −1.4529312E−09 | −1.0471235E−09 |
| A11 | −7.0914472E−08 | −7.1762745E−06 | −8.2376381E−12 | −2.5085139E−11 |
| A12 | 4.6554798E−08 | −6.9215875E−07 | 5.4534895E−12 | 4.2063107E−12 |
| A13 | 3.0201325E−09 | 3.7102206E−07 | 2.4768351E−14 | 8.4179477E−14 |
| A14 | 3.0710301E−10 | 2.0026579E−08 | −1.2941900E−14 | −1.0574500E−14 |
| A15 | −9.7614646E−11 | −1.0395141E−08 | −4.1012254E−17 | −1.5996152E−16 |
| A16 | −2.4619570E−11 | −3.6264929E−10 | 1.8848071E−17 | 1.6199806E−17 |
| A17 | 1.4174160E−12 | 1.5026159E−10 | 3.6940850E−20 | 1.6318588E−19 |
| A18 | 3.5152462E−13 | 3.9071857E−12 | −1.5346628E−20 | −1.3822146E−20 |
| A19 | −7.4245652E−15 | −8.7839538E−13 | −1.3817672E−23 | −6.9223376E−23 |
| A20 | −1.6854983E−15 | −1.9283702E−14 | 5.3346636E−24 | 5.0340473E−24 |

| Sn | 10 | 11 | 14 | 15 |
|---|---|---|---|---|
| KA | 5.1453664E−01 | 4.3239837E+00 | 1.9662118E+06 | −3.4999358E+00 |
| A3 | −1.2130698E−17 | 0.0000000E+00 | −3.8781067E−18 | 2.8486525E−18 |
| A4 | 3.6511312E−03 | 6.0689504E−03 | 6.3955079E−03 | 3.1448670E−03 |
| A5 | −6.2403449E−03 | −8.9345675E−03 | −9.0546741E−03 | −6.8524109E−03 |
| A6 | 3.6172092E−03 | 3.7166895E−03 | 2.1741370E−03 | 1.7823865E−03 |
| A7 | 1.4142566E−03 | 2.4181839E−03 | 4.4068440E−03 | 2.0862932E−03 |
| A8 | −2.1856793E−03 | −2.0826396E−03 | −2.0782966E−03 | −8.6660627E−04 |
| A9 | 3.1169493E−04 | −1.0375846E−04 | −8.5723045E−04 | −2.5001777E−04 |
| A10 | 4.0014916E−04 | 4.0345700E−04 | 6.0600703E−04 | 1.5355245E−04 |
| A11 | −1.2353074E−04 | −3.6436779E−05 | 7.0426857E−05 | 1.5849067E−05 |
| A12 | −3.2375591E−05 | −4.0356733E−05 | −8.8520645E−05 | −1.4109782E−05 |
| A13 | 1.5059160E−05 | 5.8321827E−06 | −6.7643139E−07 | −5.6864935E−07 |
| A14 | 1.0734128E−06 | 2.3043757E−06 | 7.2570688E−06 | 7.3747777E−07 |
| A15 | −8.8471767E−07 | −3.6631128E−07 | −2.5868716E−07 | 1.1118707E−08 |
| A16 | 3.3152458E−09 | −7.5871188E−08 | −3.4034399E−07 | −2.2165443E−08 |
| A17 | 2.5586525E−08 | 1.0776446E−08 | 1.5305375E−08 | −9.7878634E−11 |
| A18 | −1.0222018E−09 | 1.3424802E−09 | 8.5544325E−09 | 3.5777811E−10 |
| A19 | −2.9240955E−10 | −1.2282398E−10 | −2.6834674E−10 | 1.4914864E−13 |
| A20 | 1.7129415E−11 | −9.8986857E−12 | −8.9551579E−11 | −2.4086532E−12 |

TABLE 48B
Example 12

| Sn | 16 | 17 |
|---|---|---|
| KA | −2.4968528E−01 | −1.3034168E+08 |
| A3 | −7.2095152E−18 | −4.0155241E−17 |
| A4 | 2.1750805E−03 | 2.2610519E−04 |
| A5 | −4.0283096E−04 | −3.3914331E−05 |
| A6 | −4.1485491E−05 | −1.0467895E−05 |
| A7 | −1.1913075E−06 | −5.7101015E−06 |
| A8 | 3.0946128E−07 | 8.7047966E−08 |
| A9 | 7.1700391E−09 | 3.8671746E−08 |
| A10 | −1.6404603E−09 | −3.6384658E−10 |
| A11 | −1.5649543E−11 | −1.5862008E−10 |
| A12 | 5.8397411E−12 | 9.5043783E−13 |
| A13 | 1.1406791E−14 | 4.1243205E−13 |
| A14 | −1.3113898E−14 | −1.8999252E−15 |
| A15 | 1.4943531E−17 | −6.5720707E−16 |
| A16 | 1.7706131E−17 | 3.0476256E−18 |
| A17 | −3.3084098E−20 | 5.8487155E−19 |
| A18 | −1.3093693E−20 | −3.2083646E−21 |
| A19 | 1.6135785E−23 | −2.2309479E−22 |
| A20 | 4.0607506E−24 | 1.5026543E−24 |

### Example 13

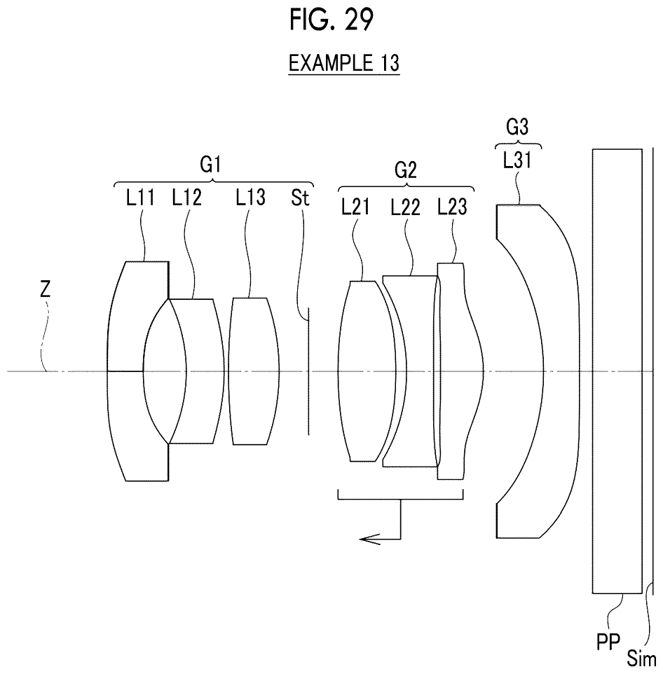

A cross-sectional view of a configuration of an imaging lens of Example 13 is illustrated in FIG. 29. The imaging lens of Example 13 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, three lenses including the lenses L11 to L13, and the aperture stop St. The second lens group G2 consists of, in order from the object side to the image side, three lenses including the lenses L21 to L23. The third lens group G3 consists of one lens that is the lens L31.

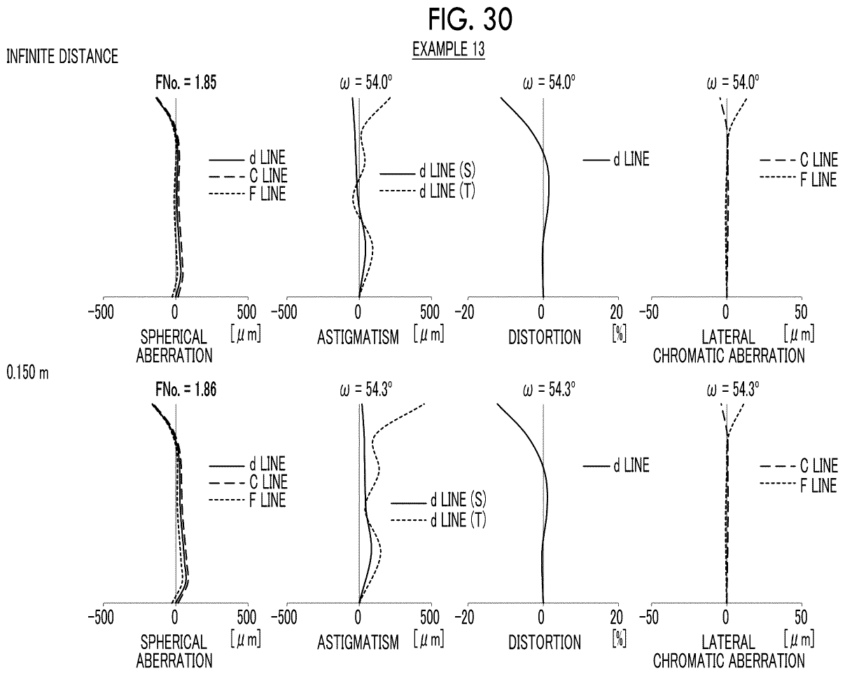

For the imaging lens of Example 13, Table 49 shows basic lens data, Table 50 shows specifications, Table 51 shows a variable surface spacing, Tables 52A and 52B show aspherical coefficients, and FIG. 30 illustrates each aberration diagram.

TABLE 49
Example 13

| Sn | R | D | Nd | vd | ED | Hinf |
|---|---|---|---|---|---|---|
| *1 | −48.8594 | 1.0002 | 1.55332 | 71.68 | 6.23 | 0/3.07 |
| *2 | 5.7237 | 1.1832 | | | 4.13 | |
| *3 | −4.5681 | 1.0553 | 2.00178 | 19.32 | 4.10 | |
| *4 | −5.8911 | 0.1212 | | | 4.01 | |
| *5 | 18.2743 | 1.4108 | 1.77250 | 49.50 | 4.14 | |
| *6 | −6.5126 | 0.8200 | | | 4.15 | |
| 7 (St) | ∞ | DD[7] | | | | |
| *8 | 10.6105 | 1.6105 | 1.72903 | 54.04 | 4.91 | |
| *9 | −10.5678 | 0.3004 | | | 5.11 | |
| *10 | −5.3468 | 0.7502 | 1.82115 | 24.06 | 5.00 | |
| *11 | 1006.7591 | 0.1960 | | | 5.42 | |
| *12 | 23.8229 | 1.1928 | 1.53116 | 56.04 | 5.42 | 1.20/2.12 |
| *13 | −3.1860 | DD[13] | | | 6.14 | 1.46/2.60 |
| *14 | −6.4493 | 1.0001 | 1.68893 | 31.16 | 7.51 | |
| *15 | 9.8738 | 0.3675 | | | 9.42 | |
| 16 | ∞ | 1.3800 | 1.51680 | 64.20 | | |
| 17 | ∞ | 0.2997 | | | | |

TABLE 50
Example 13

| | |
|---|---|
| f | 5.18 |
| Bf | 1.58 |
| Fno | 1.85 |
| 2ωm [°] | 108.0 |

TABLE 51
Example 13

| | Infinite Distance | 0.150 m |
|---|---|---|
| DD[7] | 0.8202 | 0.7111 |
| DD[13] | 1.6615 | 1.7706 |

TABLE 52A
Example 13

| Sn | 1 | 2 | 3 | 4 |
|---|---|---|---|---|
| KA | −3.2235087E+10 | −7.4641191E−01 | 1.0601631E−01 | −8.6248109E−01 |
| A3 | 9.1538861E−18 | −2.3945398E−18 | 2.1661707E−17 | 4.0452744E−18 |
| A4 | 1.4328792E−02 | 2.9049277E−02 | −3.9720490E−05 | 1.7828881E−03 |
| A5 | 6.1851936E−04 | −6.3592629E−03 | −2.5260313E−04 | −1.7668044E−05 |
| A6 | −2.5356286E−03 | 2.0565265E−04 | −1.9658538E−05 | −4.8342670E−05 |
| A7 | 2.5107257E−04 | 1.0309858E−03 | 1.1025762E−05 | 4.8270980E−07 |
| A8 | 1.9976637E−04 | −3.8745647E−04 | 3.5112680E−07 | 6.9405888E−07 |
| A9 | −3.5424781E−05 | −7.9637888E−05 | −8.1158265E−08 | 5.4442130E−10 |
| A10 | −9.0348437E−06 | 2.4401321E−05 | −3.1300134E−09 | −5.6284345E−09 |
| A11 | 1.8943444E−06 | 2.4700343E−06 | 3.9595282E−10 | −3.1454944E−11 |
| A12 | 2.5679166E−07 | −6.8155742E−09 | 1.7376655E−11 | 2.7879677E−11 |
| A13 | −5.2457014E−08 | 6.9906080E−09 | −1.2470976E−12 | 1.6718866E−13 |
| A14 | −4.7171043E−09 | −4.7552367E−08 | −6.1397247E−14 | −8.5985514E−14 |
| A15 | 7.9858831E−10 | −2.2483292E−09 | 2.4023069E−15 | −4.0372563E−16 |
| A16 | 5.4525702E−11 | 1.8282826E−09 | 1.3268677E−16 | 1.6117183E−16 |
| A17 | −6.3461652E−12 | 4.9580391E−11 | −2.5681562E−18 | 4.7412466E−19 |
| A18 | −3.5944208E−13 | −2.8421733E−11 | −1.5858472E−19 | −1.6803291E−19 |
| A19 | 2.0590378E−14 | −3.4791052E−13 | 1.1665581E−21 | −2.2040113E−22 |
| A20 | 1.0242159E−15 | 1.6453054E−13 | 7.9871739E−23 | 7.4727782E−23 |

| Sn | 5 | 6 | 8 | 9 |
|---|---|---|---|---|
| KA | 0.0000000E+00 | 0.0000000E+00 | 4.4231372E+00 | 5.3919200E+00 |
| A3 | 7.8159701E−18 | −3.6415315E−18 | 0.0000000E+00 | 0.0000000E+00 |
| A4 | 2.0558166E−03 | −1.9415240E−03 | 9.1264517E−05 | −8.9962955E−03 |
| A5 | −5.4801351E−04 | 4.1753679E−04 | 5.0975138E−04 | −2.9657381E−03 |
| A6 | −4.0705809E−05 | 2.7988654E−05 | 9.4290659E−04 | 9.3726230E−03 |
| A7 | −4.6928035E−07 | 8.3347752E−07 | −1.3059492E−03 | −3.4214952E−03 |
| A8 | 3.8434321E−07 | −2.3219079E−07 | 3.9660339E−05 | −2.8369168E−03 |
| A9 | 9.6321043E−09 | −9.6133000E−09 | 4.7215207E−04 | 1.6280243E−03 |
| A10 | −2.1232495E−09 | 1.1893262E−09 | −7.8902382E−05 | 3.7986113E−04 |
| A11 | −4.1956090E−11 | 3.4819679E−11 | −7.2642937E−05 | −2.9826238E−04 |
| A12 | 7.2814241E−12 | −3.8233150E−12 | 1.4029066E−05 | −2.4931554E−05 |
| A13 | 9.6899645E−14 | −6.7509396E−14 | 5.7331603E−06 | 2.8214337E−05 |
| A14 | −1.5658163E−14 | 7.7312561E−15 | −1.1139128E−06 | 6.9841862E−07 |
| A15 | −1.2876151E−16 | 7.2937131E−17 | −2.4387034E−07 | −1.4566328E−06 |
| A16 | 2.0531532E−17 | −9.5452948E−18 | 4.5887190E−08 | 2.5606111E−09 |
| A17 | 9.3941330E−20 | −3.9134463E−20 | 5.3206096E−09 | 3.8941516E−08 |
| A18 | −1.5005764E−20 | 6.5741708E−21 | −9.5667006E−10 | −5.5230336E−10 |
| A19 | −3.0029863E−23 | 6.9348341E−24 | −4.6724068E−11 | −4.2173307E−10 |
| A20 | 4.6852521E−24 | −1.9374952E−24 | 7.9901996E−12 | 8.3695669E−12 |

TABLE 52B
Example 13

| Sn | 10 | 11 | 12 | 13 |
|---|---|---|---|---|
| KA | 0.0000000E+00 | 0.0000000E+00 | −3.9023673E+21 | −4.0636684E+00 |
| A3 | −1.0125234E−17 | −6.3948846E−17 | −2.0531662E−17 | 0.0000000E+00 |
| A4 | −2.2971084E−03 | −1.4049369E−04 | −2.2910129E−02 | −2.7364379E−02 |
| A5 | 1.5566643E−04 | 7.8957609E−04 | 6.6229465E−03 | 2.1274166E−02 |
| A6 | 4.0692555E−05 | 6.7370178E−06 | 2.5804641E−02 | 3.5448313E−04 |
| A7 | −1.5359861E−05 | −4.1188377E−06 | −2.4423372E−02 | −9.0728491E−03 |
| A8 | −3.0927643E−07 | −7.1434029E−08 | −1.4796412E−03 | 3.3960296E−03 |
| A9 | 1.0574796E−07 | 2.4732301E−08 | 1.1066929E−02 | 1.7306156E−03 |
| A10 | 1.3088878E−09 | 4.1812178E−10 | −2.4232232E−03 | −8.5754610E−04 |
| A11 | −3.6689105E−10 | −9.3952073E−11 | −2.2959036E−03 | −1.7844827E−04 |
| A12 | −3.5844887E−12 | −1.4719517E−12 | 7.7969156E−04 | 9.6381845E−05 |
| A13 | 6.9862714E−13 | 2.2483568E−13 | 2.5837878E−04 | 1.0610908E−05 |
| A14 | 6.6648629E−15 | 3.1876237E−15 | −1.0872368E−04 | −5.9253085E−06 |
| A15 | −7.0079252E−16 | −3.2582384E−16 | −1.6352923E−05 | −3.6445790E−07 |
| A16 | −8.2123517E−18 | −4.1573494E−18 | 7.9288918E−06 | 2.0634455E−07 |
| A17 | 3.0351257E−19 | 2.6112544E−19 | 5.4917397E−07 | 6.7172947E−09 |
| A18 | 6.0737699E−21 | 2.9978354E−21 | −2.9509616E−07 | −3.8255482E−09 |
| A19 | −1.9063339E−23 | −8.8793977E−23 | −7.6298890E−09 | −5.1386972E−11 |
| A20 | −2.0419689E−24 | −9.1713267E−25 | 4.4275430E−09 | 2.9372329E−11 |

| Sn | 14 | 15 |
|---|---|---|
| KA | −4.9678819E+00 | −2.9370066E+22 |
| A3 | −1.7275838E−18 | 2.5179705E−17 |
| A4 | −1.2317118E−03 | −1.9259397E−04 |
| A5 | −2.2182986E−04 | −5.4713123E−04 |
| A6 | 5.8167975E−05 | 2.8682197E−05 |
| A7 | −1.8724263E−05 | −1.1275292E−06 |
| A8 | −1.0460514E−06 | −8.2066321E−08 |
| A9 | 7.8442008E−08 | 2.0549552E−08 |
| A10 | 8.9692836E−09 | −8.7891906E−10 |
| A11 | −5.8205132E−11 | −1.3284967E−10 |
| A12 | −4.5571750E−11 | 8.3454620E−12 |
| A13 | −4.7961017E−13 | 4.9034072E−13 |
| A14 | 1.4333591E−13 | −3.2184180E−14 |
| A15 | 1.4947760E−15 | −1.0243660E−15 |
| A16 | −2.7228874E−16 | 6.6863028E−17 |
| A17 | −1.5876402E−18 | 1.1322353E−18 |
| A18 | 2.8492394E−19 | −7.3647212E−20 |
| A19 | 4.8575763E−22 | −5.1634242E−22 |
| A20 | −1.2566000E−22 | 3.3871892E−23 |

### Example 14

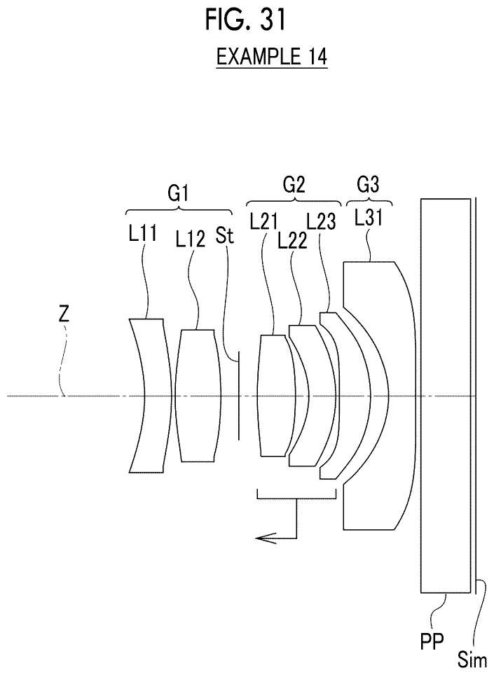

A cross-sectional view of a configuration of an imaging lens of Example 14 is illustrated in FIG. 31. The imaging lens of Example 14 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, two lenses including the lenses L11 and L12, and the aperture stop St. The second lens group G2 consists of, in order from the object side to the image side, three lenses including the lenses L21 to L23. The third lens group G3 consists of one lens that is the lens L31.

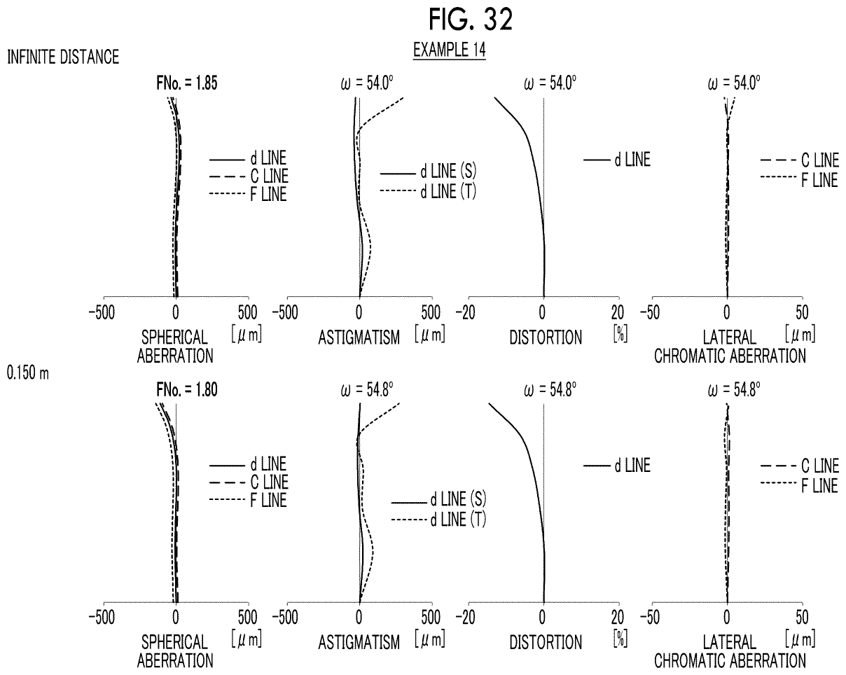

For the imaging lens of Example 14, Table 53 shows basic lens data, Table 54 shows specifications, Table 55 shows a variable surface spacing, Tables 56A and 56B show aspherical coefficients, and FIG. 32 illustrates each aberration diagram.

TABLE 53
Example 14

| Sn | R | D | Nd | vd | ED | Hinf |
|---|---|---|---|---|---|---|
| *1 | −4.5596 | 0.7499 | 2.00178 | 19.32 | 4.35 | |
| *2 | −6.5277 | 0.1001 | | | 4.03 | 1.80 |
| *3 | 7.0787 | 1.2698 | 1.85135 | 40.10 | 3.77 | 1.40 |
| *4 | −9.9356 | 0.5004 | | | 3.44 | |
| 5 (St) | ∞ | DD[5] | | | | |
| *6 | 10.5463 | 1.0584 | 1.71300 | 53.94 | 2.72 | (1.25) |
| *7 | −9.3369 | 0.3729 | | | 3.28 | |
| *8 | −2.4312 | 0.7498 | 2.00178 | 19.32 | 3.34 | |
| *9 | −3.5906 | 0.1002 | | | 3.96 | |
| *10 | −2438.6672 | 0.8670 | 1.95150 | 29.83 | 4.04 | 0.05/0.12 |
| *11 | −3.2765 | DD[11] | | | 4.68 | |
| *12 | −2.6841 | 0.7501 | 2.00178 | 19.32 | 5.02 | |
| *13 | 76.4206 | 0.1481 | | | 7.55 | 0.55 |
| 14 | ∞ | 1.3800 | 1.51680 | 64.20 | | |
| 15 | ∞ | 0.1502 | | | | |

TABLE 54
Example 14

| | |
|---|---|
| f | 4.69 |
| Bf | 1.21 |
| Fno | 1.85 |
| 2ωm [°] | 108.0 |

TABLE 55
Example 14

| | Infinite Distance | 0.150 m |
|---|---|---|
| DD[5] | 0.5004 | 0.4287 |
| DD[11] | 0.5026 | 0.5743 |

TABLE 56A
Example 14

| Sn | 1 | 2 | 3 | 4 |
|---|---|---|---|---|
| KA | −1.1144283E−02 | 7.6682104E−03 | 0.0000000E+00 | 0.0000000E+00 |
| A3 | 1.1183127E−17 | −1.6517252E−17 | −1.1368684E−17 | −2.8421709E−18 |
| A4 | 5.9552792E−03 | 5.7897206E−03 | −3.9977950E−03 | −5.5938430E−03 |
| A5 | −6.1004924E−04 | −6.8362224E−04 | −1.1003162E−03 | 4.6728364E−04 |
| A6 | −1.1508563E−04 | 7.1995912E−06 | 9.7637371E−05 | 6.3557700E−05 |
| A7 | −2.6449779E−05 | 9.5995236E−06 | 1.0054673E−05 | −1.1486097E−06 |
| A8 | 2.0701837E−06 | −5.9923819E−07 | −1.0876854E−06 | −4.0948148E−07 |
| A9 | 5.3528023E−07 | −5.4181393E−08 | −6.5729104E−08 | 4.5322417E−09 |
| A10 | −2.4270085E−08 | 5.2861819E−09 | 6.6820458E−09 | 1.4428876E−09 |
| A11 | −4.3428407E−09 | 2.0319707E−10 | 2.6415483E−10 | −2.6507501E−11 |
| A12 | 1.6511958E−10 | −2.3114348E−11 | −2.4652325E−11 | −2.5166591E−12 |
| A13 | 1.9221700E−11 | −4.9602573E−13 | −6.5137605E−13 | 1.0137176E−13 |
| A14 | −6.5300099E−13 | 5.7934738E−14 | 5.6078218E−14 | 7.7624136E−16 |
| A15 | −4.8303793E−14 | 7.5489129E−16 | 9.6102439E−16 | −2.1407217E−16 |
| A16 | 1.4837030E−15 | −8.4475683E−17 | −7.7039198E−17 | 4.4965186E−18 |
| A17 | 6.4575760E−17 | −6.4607453E−19 | −7.7809265E−19 | 2.3177352E−19 |
| A18 | −1.7949378E−18 | 6.6696342E−20 | 5.8597744E−20 | −7.0050344E−21 |
| A19 | −3.5665651E−20 | 2.3601047E−22 | 2.6541418E−22 | −1.0078077E−22 |
| A20 | 8.9431830E−22 | −2.2060466E−23 | −1.8943448E−23 | 3.2687269E−24 |

| Sn | 6 | 7 | 8 | 9 |
|---|---|---|---|---|
| KA | −2.9244860E−02 | −1.2821124E−02 | 0.0000000E+00 | 0.0000000E+00 |
| A3 | −2.1982281E−17 | 0.0000000E+00 | 1.4210855E−17 | 6.1106675E−17 |
| A4 | 2.9680118E−03 | 2.5972002E−03 | 9.0075872E−04 | −4.3279028E−03 |
| A5 | −1.1945370E−02 | −4.2334229E−02 | 1.8185982E−03 | 1.3773326E−03 |
| A6 | 1.0552096E−02 | 3.6753777E−02 | −3.5553996E−05 | 5.5408700E−05 |
| A7 | −2.3748207E−03 | −3.8442148E−03 | −3.4951113E−05 | −4.3345182E−06 |
| A8 | −2.7038118E−03 | −1.1493783E−02 | 3.7199955E−07 | −4.5445556E−07 |
| A9 | 1.3698029E−03 | 3.4446033E−03 | 2.2761651E−07 | 1.8195475E−08 |
| A10 | 1.9563791E−04 | 1.4797145E−03 | −2.2626757E−09 | 2.3746392E−09 |
| A11 | −2.3740199E−04 | −6.4336556E−04 | −8.1158269E−10 | −7.1479519E−11 |
| A12 | 1.0953748E−05 | −9.0863923E−05 | 8.1954511E−12 | −7.9187546E−12 |
| A13 | 2.0946034E−05 | 5.8608630E−05 | 1.6811370E−12 | 1.9455928E−13 |
| A14 | −2.5302817E−06 | 2.1057931E−06 | −1.7892688E−14 | 1.6827104E−14 |
| A15 | −1.0126993E−06 | −2.8761192E−06 | −1.9949587E−15 | −3.2175151E−16 |
| A16 | 1.5550084E−07 | 3.7308438E−08 | 2.3147682E−17 | −2.2029002E−17 |
| A17 | 2.5486210E−08 | 7.2865725E−08 | 1.2398439E−18 | 2.8933529E−19 |
| A18 | −4.2434043E−09 | −2.7617783E−09 | −1.6329158E−20 | 1.6166154E−20 |
| A19 | −2.6093617E−10 | −7.4809138E−10 | −3.0531521E−22 | −1.0814990E−22 |
| A20 | 4.4147052E−11 | 3.8185080E−11 | 4.8254541E−24 | −5.0812142E−24 |

TABLE 56B
Example 14

| Sn | 10 | 11 | 12 | 13 |
|---|---|---|---|---|
| KA | −1.8599746E−01 | −4.8435044E−03 | −9.1063105E−03 | −9.2496285E+03 |
| A3 | 0.0000000E+00 | −4.9323248E−17 | −5.6288272E−17 | −9.4620709E−18 |
| A4 | 2.6801380E−02 | 4.1456689E−02 | 4.2912965E−03 | −1.5744034E−03 |
| A5 | −1.5158025E−01 | −9.2455675E−02 | −2.4295038E−03 | −6.5629293E−04 |
| A6 | 1.4801765E−01 | 5.6891966E−02 | −5.2291528E−05 | 6.7175201E−05 |
| A7 | 7.1387520E−03 | 1.8093757E−02 | −8.6262801E−06 | 3.3750281E−06 |
| A8 | −8.1667621E−02 | −2.8201612E−02 | 2.6934413E−07 | −5.1458805E−07 |
| A9 | 1.7844678E−02 | −8.5593159E−06 | 5.7755346E−08 | −2.2203467E−08 |
| A10 | 2.1059107E−02 | 6.0446971E−03 | −6.3091985E−10 | 2.4070056E−09 |
| A11 | −6.3735697E−03 | −3.7392428E−04 | −6.2876542E−11 | 1.0083557E−10 |
| A12 | −3.1234120E−03 | −7.2582815E−04 | −3.3441986E−13 | −8.0559340E−12 |
| A13 | 9.8993678E−04 | 4.8029365E−05 | −3.3343916E−13 | −2.8196227E−13 |
| A14 | 2.7816926E−04 | 5.1827593E−05 | 6.8253289E−15 | 1.9270925E−14 |
| A15 | −8.0390968E−05 | −2.7236230E−06 | 1.1160052E−15 | 4.8136870E−16 |
| A16 | −1.4580633E−05 | −2.1817048E−06 | −1.8376455E−17 | −3.0448353E−17 |
| A17 | 3.3375770E−06 | 7.4761306E−08 | −1.1320123E−18 | −4.6101283E−19 |
| A18 | 4.1109400E−07 | 4.9964783E−08 | 2.0446764E−20 | 2.7580079E−20 |
| A19 | −5.5998984E−08 | −8.0850525E−10 | 2.5571634E−22 | 1.8895710E−22 |
| A20 | −4.7554713E−09 | −4.7988726E−10 | −7.9157127E−24 | −1.0567432E−23 |

### Example 15

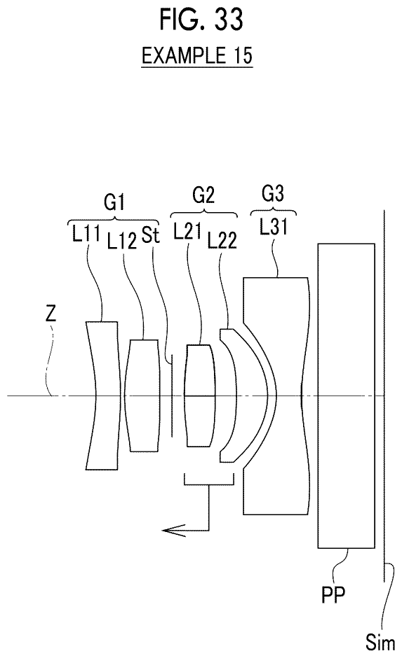

A cross-sectional view of a configuration of an imaging lens of Example 15 is illustrated in FIG. 33. The imaging lens of Example 15 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, two lenses including the lenses L11 and L12, and the aperture stop St. The second lens group G2 consists of, in order from the object side to the image side, two lenses including the lenses L21 and L22. The third lens group G3 consists of one lens that is the lens L31.

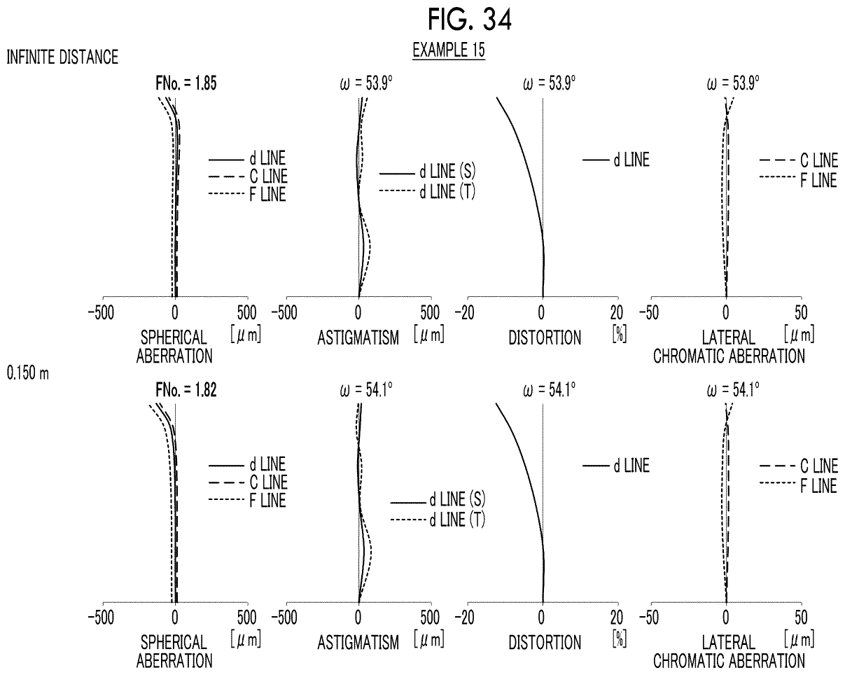

For the imaging lens of Example 15, Table 57 shows basic lens data, Table 58 shows specifications, Table 59 shows a variable surface spacing, Tables 60A and 60B show aspherical coefficients, and FIG. 34 illustrates each aberration diagram.

TABLE 57
Example 15

| Sn | R | D | Nd | vd | ED | Hinf |
|---|---|---|---|---|---|---|
| *1 | −4.1766 | 0.5864 | 1.63350 | 23.62 | 3.67 | 1.33/1.65 |
| *2 | −7.6334 | 0.0998 | | | 3.02 | 0.85/1.46 |
| *3 | 4.3031 | 0.8564 | 1.80139 | 45.45 | 2.77 | 0.91 |
| *4 | −248.7443 | 0.3002 | | | 2.47 | |
| 5 (St) | ∞ | DD[5] | | | | |
| *6 | 6.9551 | 0.7529 | 1.55332 | 71.68 | 2.00 | |
| *7 | −13.8733 | 0.5180 | | | 2.52 | |
| *8 | −8.4052 | 0.7602 | 1.95150 | 29.83 | 2.78 | |
| *9 | −1.7942 | DD[9] | | | 3.31 | 1.63 |
| *10 | −1.7974 | 0.6032 | 1.63350 | 23.62 | 3.63 | |
| *11 | 5.0005 | 0.4000 | | | 5.87 | 1.10 |
| 12 | ∞ | 1.3800 | 1.51680 | 64.20 | | |
| 13 | ∞ | 0.2339 | | | | |

TABLE 58
Example 15

| | |
|---|---|
| f | 3.83 |
| Bf | 1.54 |
| Fno | 1.85 |
| 2ωm [°] | 107.8 |

TABLE 59
Example 15

| | Infinite Distance | 0.150 m |
|---|---|---|
| DD[5] | 0.2998 | 0.2708 |
| DD[9] | 0.2140 | 0.2430 |

TABLE 60A
Example 15

| Sn | 1 | 2 | 3 | 4 |
|---|---|---|---|---|
| KA | 0.0000000E+00 | 0.0000000E+00 | 0.0000000E+00 | 0.0000000E+00 |
| A3 | −6.5126678E−17 | 2.3083162E−17 | −5.2580162E−17 | −2.2737368E−17 |
| A4 | 2.5591497E−02 | 2.1028447E−02 | −9.2741469E−03 | −2.5050012E−02 |
| A5 | −5.4670110E−03 | 2.4426032E−04 | −9.8380407E−03 | 4.0065466E−03 |
| A6 | −5.2603418E−04 | −3.4872241E−03 | 1.4693922E−04 | 5.0499548E−04 |
| A7 | 6.8078844E−06 | −4.1926926E−05 | 6.7357089E−05 | −4.3693976E−05 |
| A8 | 6.5092813E−06 | 1.2004869E−04 | −1.4479467E−06 | −5.1495120E−06 |
| A9 | 7.0135538E−09 | 1.1216118E−06 | −2.7455471E−07 | 3.1794064E−07 |
| A10 | −4.5310400E−08 | −2.1384256E−06 | 8.3526977E−09 | 3.0310437E−08 |
| A11 | −1.8618303E−11 | −2.9068501E−08 | 6.6888317E−10 | −1.3896013E−09 |
| A12 | 1.9004007E−10 | 2.1750211E−08 | −2.9812247E−11 | −1.0952147E−10 |
| A13 | −8.5502973E−14 | 3.1746562E−10 | −9.4318986E−13 | 3.6728459E−12 |
| A14 | −4.8945821E−13 | −1.3201463E−10 | 6.6751734E−14 | 2.4698365E−13 |
| A15 | 2.9119748E−16 | −1.6684279E−12 | 6.7416254E−16 | −5.7350438E−15 |
| A16 | 7.5639910E−16 | 4.7466681E−13 | −9.1231908E−17 | −3.3889910E−16 |
| A17 | −3.0887086E−19 | 4.2747486E−15 | −1.2702902E−19 | 4.8640404E−18 |
| A18 | −6.4301616E−19 | −9.3529704E−16 | 6.9478692E−20 | 2.5882039E−19 |
| A19 | 1.0661994E−22 | −4.3162032E−18 | −6.5195700E−23 | −1.7244649E−21 |
| A20 | 2.3101080E−22 | 7.7975599E−19 | −2.2572445E−23 | −8.4344494E−23 |

| Sn | 6 | 7 | 8 | 9 |
|---|---|---|---|---|
| KA | 0.0000000E+00 | 0.0000000E+00 | 0.0000000E+00 | 0.0000000E+00 |
| A3 | 2.6091727E−17 | −7.7812359E−17 | 0.0000000E+00 | −1.1900604E−16 |
| A4 | −7.1498250E−03 | −6.9640719E−04 | −3.9542496E−02 | 4.0109965E−02 |
| A5 | 1.1466426E−02 | −7.2484797E−02 | −1.6248749E−01 | −1.1636973E−01 |
| A6 | −8.3743162E−03 | 7.6163221E−02 | 3.6068075E−01 | 9.6437243E−02 |
| A7 | 2.9684656E−03 | −6.6075895E−03 | −2.1789664E−01 | 9.4643054E−03 |
| A8 | −3.7655640E−03 | −2.9782787E−02 | −1.7685621E−01 | −5.4429588E−02 |
| A9 | 6.2332478E−04 | 3.8573849E−03 | 2.0233719E−01 | 9.7177250E−03 |
| A10 | 2.0289608E−03 | 5.1879667E−03 | 3.7567501E−02 | 1.3462465E−02 |
| A11 | −3.3174076E−04 | −5.6806938E−04 | −7.6306241E−02 | −2.7893770E−03 |
| A12 | −3.5719332E−04 | −5.0176571E−04 | −4.8443178E−03 | −1.8483025E−03 |
| A13 | 4.5223538E−05 | 4.2868455E−05 | 1.5092047E−02 | 3.2680597E−04 |
| A14 | 3.2143478E−05 | 2.8781048E−05 | 5.5765806E−04 | 1.4975159E−04 |
| A15 | −2.8764532E−06 | −1.7951178E−06 | −1.6344460E−03 | −1.9596226E−05 |
| A16 | −1.5961238E−06 | −9.7579185E−07 | −6.0774059E−05 | −7.1222082E−06 |
| A17 | 8.9110730E−08 | 3.9550950E−08 | 9.1737151E−05 | 5.9411447E−07 |
| A18 | 4.1661622E−08 | 1.8093594E−08 | 4.1661555E−06 | 1.8395794E−07 |
| A19 | −1.0868732E−09 | −3.5754657E−10 | −2.0879870E−06 | −7.2304347E−09 |
| A20 | −4.4709234E−10 | −1.4158826E−10 | −1.1620368E−07 | −1.9923330E−09 |

TABLE 60B
Example 15

| Sn | 10 | 11 |
|---|---|---|
| KA | 0.0000000E+00 | 0.0000000E+00 |
| A3 | −1.1417586E−17 | −4.1018936E−18 |
| A4 | 2.3721154E−02 | −2.2981734E−02 |
| A5 | −5.0273465E−03 | 4.9855913E−03 |
| A6 | −6.3010079E−04 | 1.9000021E−04 |
| A7 | −4.2381067E−04 | −1.2454970E−04 |
| A8 | 7.6442438E−06 | −1.5821344E−06 |
| A9 | 4.4378992E−06 | 1.4327846E−06 |
| A10 | 4.3345373E−09 | 9.6931255E−09 |
| A11 | −3.6054599E−08 | −1.0176480E−08 |
| A12 | −1.0152700E−09 | −3.6797377E−11 |
| A13 | 2.1614011E−10 | 4.5030625E−11 |
| A14 | 1.0859283E−11 | 6.9054214E−14 |
| A15 | −8.6571102E−13 | −1.2119825E−13 |
| A16 | −5.3310451E−14 | 5.6364589E−19 |
| A17 | 2.0315305E−15 | 1.8240909E−16 |
| A18 | 1.2919331E−16 | −2.3828082E−19 |
| A19 | −2.0800336E−18 | −1.1831835E−19 |
| A20 | −1.2496291E−19 | 3.0516916E−22 |

### Example 16

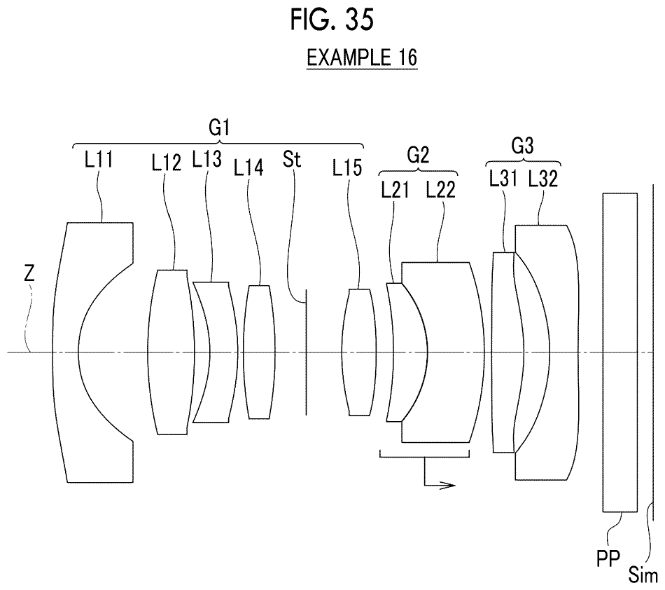

A cross-sectional view of a configuration of an imaging lens of Example 16 is illustrated in FIG. 35. The imaging lens of Example 16 consists of, in order from the object side to the image side, the first lens group G1 having a negative refractive power, the second lens group G2 having a negative refractive power, and the third lens group G3 having a negative refractive power. The focus group consists of the second lens group G2, and during the focusing from the infinite distance object to the nearest object, the focus group moves to the image side along the optical axis Z.

The first lens group G1 consists of, in order from the object side to the image side, the lenses L11 to L14, the aperture stop St, and the lens L15. The second lens group G2 consists of, in order from the object side to the image side, two lenses including the lenses L21 and L22. The third lens group G3 consists of, in order from the object side to the image side, two lenses including the lenses L31 and L32.

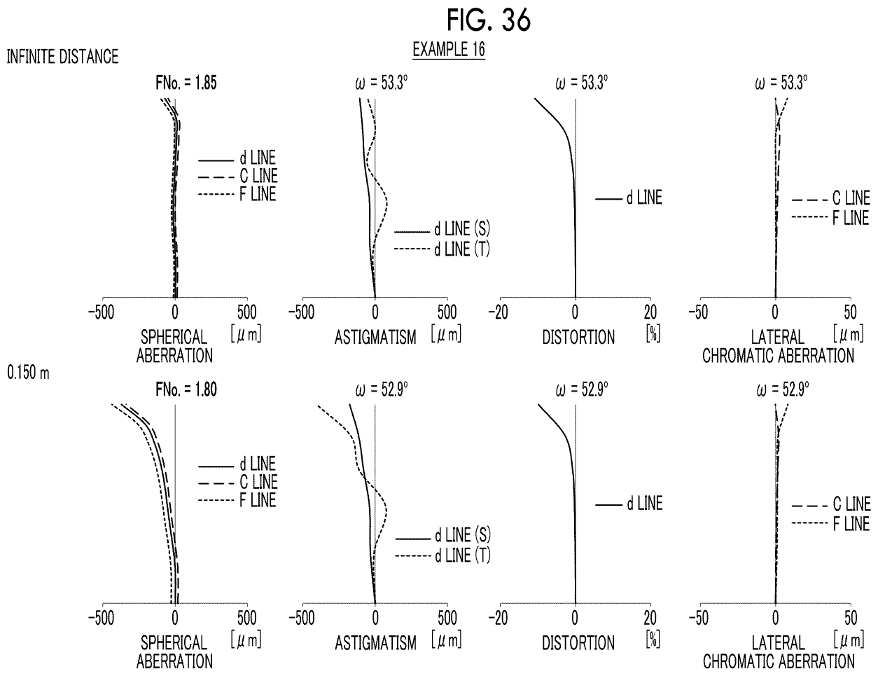

For the imaging lens of Example 16, Table 61 shows basic lens data, Table 62 shows specifications, Table 63 shows a variable surface spacing, Tables 64A and 64B show aspherical coefficients, and FIG. 36 illustrates each aberration diagram.

TABLE 61
Example 16

| Sn | R | D | Nd | vd | ED | Hinf |
|---|---|---|---|---|---|---|
| *1 | 2604.1624 | 1.0307 | 1.69350 | 53.20 | 10.95 | 4.36 |
| *2 | 4.6879 | 2.7816 | | | 7.52 | |
| 3 | 15.1597 | 1.8534 | 1.81600 | 46.62 | 6.95 | |
| 4 | −16.9889 | 0.6206 | | | 6.33 | |
| *5 | −5.8859 | 1.1196 | 1.85135 | 40.10 | 5.92 | |
| *6 | −9.6033 | 0.2203 | | | 5.60 | |
| 7 | 16.9982 | 1.2761 | 1.64850 | 53.02 | 5.63 | |
| 8 | −16.4573 | 1.2496 | | | 5.53 | |
| 9 (St) | ∞ | 1.4233 | | | | |
| *10 | 9.8571 | 1.3844 | 1.73077 | 40.50 | 5.00 | |
| *11 | −16.9954 | DD[11] | | | 5.33 | |
| 12 | −14.8550 | 1.3684 | 1.43875 | 94.66 | 5.64 | |
| 13 | −4.6429 | 2.2767 | 1.95906 | 17.47 | 5.84 | |
| 14 | −12.1712 | DD[14] | | | 7.60 | |
| *15 | −34992.7611 | 1.2764 | 1.80139 | 45.45 | 8.14 | 0.03/1.35/ |
| | | | | | | 2.35/3.62 |
| *16 | −7.3511 | 1.0349 | | | 8.42 | 2.35/4.04 |
| *17 | −7.1998 | 1.1342 | 1.68948 | 31.02 | 8.46 | |
| *18 | 24.1588 | 1.0000 | | | 10.74 | 1.02 |
| 19 | ∞ | 1.3800 | 1.51680 | 64.20 | | |
| 20 | ∞ | 0.6366 | | | | |

TABLE 62
Example 16

| | |
|---|---|
| f | 5.93 |
| Bf | 2.55 |
| Fno | 1.85 |
| 2ωm [°] | 106.6 |

TABLE 63
Example 16

| | Infinite Distance | 0.150 m |
|---|---|---|
| DD[11] | 0.6925 | 0.9258 |
| DD[14] | 0.2906 | 0.0573 |

TABLE 64A
Example 16

| Sn | 1 | 2 | 5 | 6 |
|---|---|---|---|---|
| KA | 1.6887026E+05 | −1.5120228E−01 | −1.7179850E−01 | −6.7668618E−01 |
| A3 | −3.1222131E−18 | 0.0000000E+00 | 6.0621700E−19 | −9.6429443E−19 |
| A4 | 6.6846627E−03 | 7.0050244E−03 | 4.3486163E−04 | 2.4134541E−04 |
| A5 | −1.3972688E−03 | 9.5082868E−04 | 1.1430468E−04 | 1.1500637E−04 |
| A6 | −4.7988732E−04 | −1.1471780E−03 | −5.8867062E−06 | −5.1983507E−06 |
| A7 | 1.9468092E−04 | 6.1643681E−05 | −6.6598670E−07 | −2.4151501E−07 |
| A8 | 4.9285380E−06 | 8.3898043E−05 | 6.0567645E−08 | 5.3589167E−08 |
| A9 | −1.1396586E−05 | −1.3118838E−05 | 5.2029248E−09 | 1.8274930E−09 |
| A10 | 8.5713299E−07 | −2.8025512E−06 | −3.6579985E−10 | −3.3143290E−10 |
| A11 | 3.5460488E−07 | 7.9550888E−07 | −2.3984958E−11 | −9.5372170E−12 |
| A12 | −4.5341350E−08 | 1.4421041E−08 | 1.3616573E−12 | 1.2770043E−12 |
| A13 | −6.3413811E−09 | −2.1585754E−08 | 6.5613546E−14 | 2.9230931E−14 |
| A14 | 1.0420514E−09 | 2.1625237E−09 | −3.1595259E−15 | −3.0977537E−15 |
| A15 | 6.5514227E−11 | 2.2389118E−10 | −1.0569222E−16 | −5.2429453E−17 |
| A16 | −1.2703704E−11 | −7.8058201E−11 | 4.4468131E−18 | 4.5983404E−18 |
| A17 | −3.6390147E−13 | 6.0097761E−13 | 9.2701593E−20 | 5.1128859E−20 |
| A18 | 8.0082201E−14 | 1.1478359E−12 | −3.4699268E−21 | −3.8124561E−21 |
| A19 | 8.4196621E−16 | −1.9054641E−14 | −3.4157227E−23 | −2.0951661E−23 |
| A20 | −2.0569317E−16 | −6.4478649E−15 | 1.1504417E−24 | 1.3510240E−24 |

| Sn | 10 | 11 | 15 | 16 |
|---|---|---|---|---|
| KA | 7.5137212E−01 | 1.0780494E+01 | 2.4397201E+05 | −3.4870290E+00 |
| A3 | −3.3533330E−18 | −3.8102966E−18 | −1.5593153E−18 | 3.8046360E−18 |
| A4 | 1.6734901E−04 | 1.4910040E−03 | 5.5766361E−03 | 1.4777793E−02 |
| A5 | −1.0078152E−03 | −4.5863332E−03 | −7.6673944E−05 | −6.5658411E−03 |
| A6 | 9.3211027E−04 | 3.7839539E−03 | −3.8378117E−03 | −3.3734244E−03 |
| A7 | −2.1905291E−04 | −5.9291648E−04 | 8.9218427E−04 | 2.6748519E−03 |
| A8 | −3.3937822E−04 | −1.2392563E−03 | 8.9113557E−04 | 1.6874624E−04 |
| A9 | 1.8240563E−04 | 6.5769345E−04 | −3.1688539E−04 | −4.3811792E−04 |
| A10 | 5.0459018E−05 | 1.2695076E−04 | −9.7227811E−05 | 2.9407812E−05 |
| A11 | −3.9979023E−05 | −1.4786931E−04 | 4.8526891E−05 | 3.8702164E−05 |
| A12 | −3.5423708E−06 | 3.2388186E−06 | 4.6973905E−06 | −4.8202629E−06 |
| A13 | 4.2758517E−06 | 1.6049474E−05 | −3.9481070E−06 | −1.9869251E−06 |
| A14 | 9.7105531E−08 | −1.6828749E−06 | −1.6773348E−09 | 3.0678188E−07 |
| A15 | −2.4493854E−07 | −9.3772719E−07 | 1.7825336E−07 | 5.9249259E−08 |
| A16 | 1.1712485E−09 | 1.3765004E−07 | −9.5511657E−09 | −1.0198044E−08 |
| A17 | 7.2125102E−09 | 2.8354820E−08 | −4.2264167E−09 | −9.5159199E−10 |
| A18 | −1.1568765E−10 | −4.8231276E−09 | 3.6933280E−10 | 1.7532002E−10 |
| A19 | −8.5801128E−11 | −3.4855217E−10 | 4.1139365E−11 | 6.3649871E−12 |
| A20 | 1.6692893E−12 | 6.3869040E−11 | −4.5126214E−12 | −1.2335859E−12 |

TABLE 64B
Example 16

| Sn | 17 | 18 |
|---|---|---|
| KA | 1.2735921E+00 | −2.6960463E+03 |
| A3 | −1.4103622E−17 | 2.0486435E−17 |
| A4 | 1.5602855E−03 | −5.8068077E−05 |
| A5 | −2.9477598E−04 | −1.1318606E−04 |
| A6 | −1.1794752E−05 | 3.5055245E−06 |
| A7 | 8.2679643E−09 | −4.6304653E−07 |
| A8 | 9.0211931E−08 | −5.1761862E−08 |
| A9 | 1.5866724E−09 | 1.5069989E−09 |
| A10 | −4.3978694E−10 | 3.1275551E−10 |
| A11 | −8.4095535E−12 | −1.7292132E−12 |
| A12 | 1.3934328E−12 | −1.0613378E−12 |
| A13 | 2.5396168E−14 | −3.1412916E−15 |
| A14 | −2.8824787E−15 | 2.1503687E−15 |
| A15 | −4.4979969E−17 | 1.3092821E−17 |
| A16 | 3.7726031E−18 | −2.5762005E−18 |
| A17 | 4.2863504E−20 | −1.6381166E−20 |
| A18 | −2.8461558E−21 | 1.6826321E−21 |
| A19 | −1.6821843E−23 | 7.3858930E−24 |
| A20 | 9.4435681E−25 | −4.5991776E−25 |

### Example 17

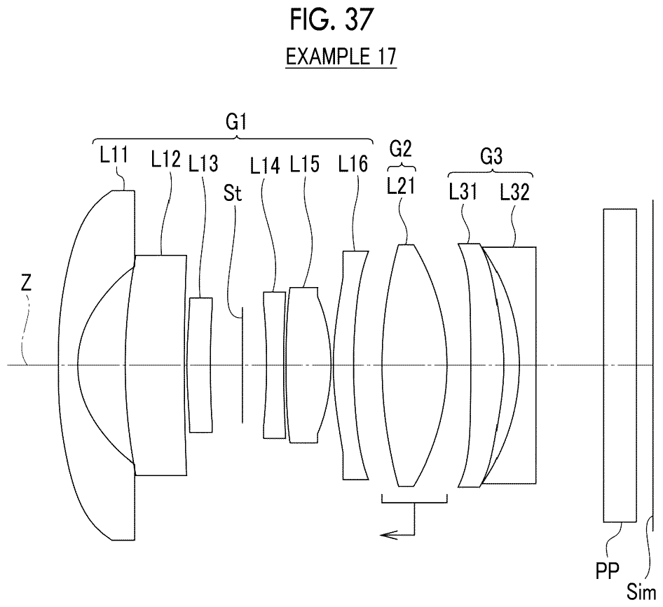

A cross-sectional view of a configuration of an imaging lens of Example 17 is illustrated in FIG. 37. The imaging lens of Example 17 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, the lenses L11 to L13, the aperture stop St, and the lenses L14 to L16. The second lens group G2 consists of one lens that is the lens L21. The third lens group G3 consists of, in order from the object side to the image side, two lenses including the lenses L31 and L32.

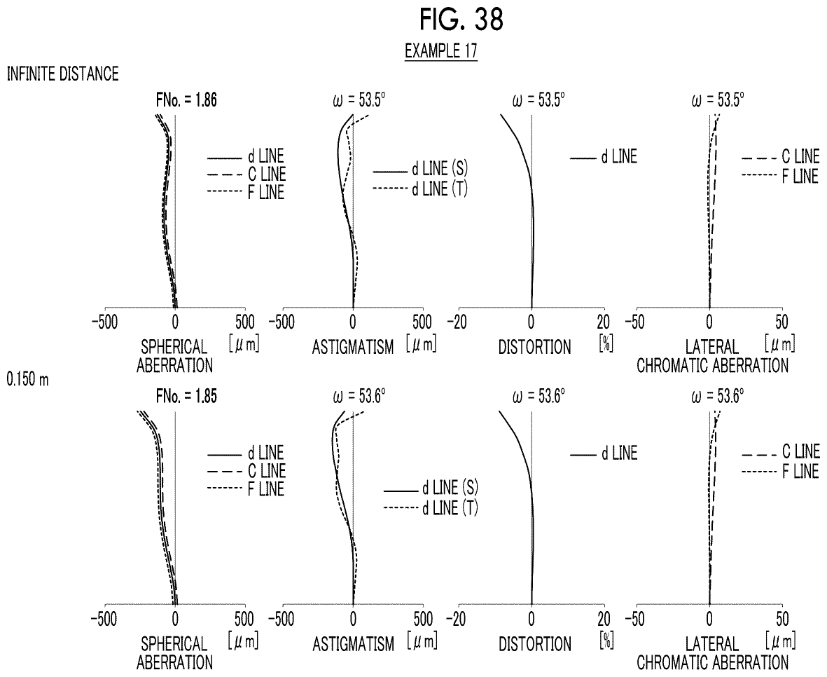

For the imaging lens of Example 17, Table 65 shows basic lens data, Table 66 shows specifications, Table 67 shows a variable surface spacing, Tables 68A and 68B show aspherical coefficients, and FIG. 38 illustrates each aberration diagram.

TABLE 65
Example 17

| Sn | R | D | Nd | vd | ED | Hinf |
|---|---|---|---|---|---|---|
| *1 | 86.4215 | 0.8167 | 1.69350 | 53.20 | 11.47 | |
| *2 | 4.6987 | 1.9973 | | | 8.02 | |
| 3 | 25.0095 | 2.4606 | 2.00272 | 19.32 | 7.76 | |
| 4 | 112.8184 | 0.1138 | | | 6.13 | |
| *5 | 18.9462 | 0.9882 | 1.80610 | 40.73 | 5.78 | 1.69 |
| *6 | 45.4549 | 1.3482 | | | 5.01 | |
| 7 (St) | ∞ | 1.0177 | | | | |
| 8 | −27.1688 | 0.7162 | 1.98613 | 16.48 | 5.21 | |
| 9 | 57.0931 | 0.1029 | | | 5.46 | |
| *10 | 68.6420 | 1.8889 | 1.76802 | 49.24 | 5.55 | |
| *11 | −8.2059 | 0.0999 | | | 5.89 | |
| *12 | 12.7982 | 0.8506 | 1.69350 | 53.20 | 6.78 | (3.26) |
| *13 | 22.0496 | DD[13] | | | 7.03 | |
| 14 | 19.6545 | 2.7347 | 1.62041 | 60.29 | 8.27 | |
| 15 | −10.2569 | DD[15] | | | 8.70 | |
| *16 | −178.7388 | 1.3683 | 1.58313 | 59.46 | 8.64 | |
| *17 | −10.0287 | 0.6522 | | | 8.78 | |
| 18 | −9.0651 | 0.6998 | 2.00069 | 25.46 | 8.76 | |
| 19 | −4551.9398 | 2.8474 | | | 9.62 | |
| 20 | ∞ | 1.3800 | 1.51680 | 64.20 | | |
| 21 | ∞ | 0.7072 | | | | |

TABLE 66
Example 17

| | |
|---|---|
| f | 5.75 |
| Bf | 4.46 |
| Fno | 1.86 |
| 2ωm [°] | 107.0 |

TABLE 67
Example 17

| | Infinite Distance | 0.150 m |
|---|---|---|
| DD[13] | 1.1998 | 1.0334 |
| DD[15] | 1.0000 | 1.1664 |

TABLE 68A
Example 17

| Sn | 1 | 2 | 5 | 6 |
|---|---|---|---|---|
| KA | 1.0000000E+00 | 1.0000000E+00 | 1.0000000E+00 | 1.0000000E+00 |
| A3 | 8.6736174E−19 | 3.1225023E−18 | −1.7347235E−19 | −1.5959456E−17 |
| A4 | 4.6300242E−03 | 4.0059004E−03 | −1.3223944E−03 | −1.5827663E−03 |
| A5 | −1.0112987E−03 | −6.1815040E−04 | −2.7230226E−04 | 1.0370425E−03 |
| A6 | −1.6620121E−04 | −3.8863417E−04 | 3.8107471E−05 | −1.4515914E−04 |
| A7 | 5.8168428E−05 | 5.7886961E−05 | 1.6028556E−05 | −5.9321689E−05 |
| A8 | 3.5795957E−06 | 9.6127323E−06 | 1.1210495E−06 | 2.5972229E−05 |
| A9 | −1.7278722E−06 | −2.2216264E−06 | −6.9588190E−07 | 2.7944378E−06 |
| A10 | −6.4810414E−08 | −5.1341416E−08 | −5.7605057E−08 | −1.0278267E−06 |
| A11 | 3.0545171E−08 | 5.0040916E−08 | 1.8387350E−08 | −7.3273425E−08 |
| A12 | 1.5833480E−09 | −6.3430979E−09 | 1.3865522E−09 | 2.1673591E−08 |
| A13 | −3.3389456E−10 | −6.9778697E−10 | −2.9275853E−10 | 1.1447036E−09 |
| A14 | −3.3125856E−11 | 1.8346439E−10 | −2.3026919E−11 | −2.8122653E−10 |
| A15 | 2.2245521E−12 | 5.9084102E−12 | 2.7493983E−12 | −1.0552528E−11 |
| A16 | 4.1622371E−13 | −2.2328780E−12 | 2.4118488E−13 | 2.2285847E−12 |
| A17 | −8.2961133E−15 | −2.7827447E−14 | −1.4044553E−14 | 5.3028850E−14 |
| A18 | −2.6879507E−15 | 1.3192669E−14 | −1.3743675E−15 | −9.9028277E−15 |
| A19 | 1.3250235E−17 | 5.5930644E−17 | 3.0088171E−17 | −1.1200427E−16 |
| A20 | 6.9080359E−18 | −3.0985458E−17 | 3.2365675E−18 | 1.8937170E−17 |

| Sn | 10 | 11 | 12 | 13 |
|---|---|---|---|---|
| KA | 1.0000000E+00 | 1.0000000E+00 | 1.0000000E+00 | 1.0000000E+00 |
| A3 | −5.4210109E−20 | 8.6736174E−19 | −3.0357661E−19 | 2.3852448E−19 |
| A4 | 1.0781185E−03 | 5.9175590E−05 | −1.1602265E−03 | −8.2112015E−04 |
| A5 | 1.0708242E−04 | 2.3519668E−05 | −1.7213901E−05 | −3.9563712E−05 |
| A6 | −1.0853092E−04 | −1.6620871E−05 | 6.9075769E−05 | 8.9770608E−05 |
| A7 | −1.3353640E−06 | −1.0251959E−05 | 6.8460014E−08 | 4.9908438E−06 |
| A8 | 6.0167593E−06 | −8.9719824E−07 | −4.4220184E−06 | −3.7262399E−06 |
| A9 | −3.9480209E−08 | 4.7729880E−07 | −2.0067911E−08 | −2.0247126E−07 |
| A10 | −2.1387643E−07 | 7.0270493E−08 | 1.7055235E−07 | 9.1934502E−08 |
| A11 | 1.6391448E−09 | −1.1897728E−08 | 8.6465493E−10 | 4.6855304E−09 |
| A12 | 4.7469002E−09 | −2.0798079E−09 | −3.9453538E−09 | −1.3457649E−09 |
| A13 | −2.7524216E−11 | 1.7783586E−10 | −1.6921445E−11 | −6.6083939E−11 |
| A14 | −6.5506680E−11 | 3.3721009E−11 | 5.5792059E−11 | 1.1162652E−11 |
| A15 | 2.5465135E−13 | −1.5833171E−12 | 1.7813025E−13 | 5.5961639E−13 |
| A16 | 5.4751587E−13 | −3.1401624E−13 | −4.7364767E−13 | −4.3938053E−14 |
| A17 | −1.2652977E−15 | 7.7377965E−15 | −9.7655817E−16 | −2.6168883E−15 |
| A18 | −2.5407130E−15 | 1.5774894E−15 | 2.2196456E−15 | 1.6323313E−17 |
| A19 | 2.6467368E−18 | −1.5976250E−17 | 2.1927790E−18 | 5.2037003E−18 |
| A20 | 5.0257236E−18 | −3.3191064E−18 | −4.4158520E−18 | 2.7807583E−19 |

TABLE 68B
Example 17

| Sn | 16 | 17 |
|---|---|---|
| KA | 1.0000000E+00 | 1.0000000E+00 |
| A3 | −2.6020852E−19 | 6.9388939E−19 |
| A4 | −4.8257580E−04 | 2.4231588E−03 |
| A5 | 1.8535519E−04 | −4.9582443E−04 |
| A6 | 4.1875714E−06 | 8.5526156E−05 |
| A7 | −1.6773510E−05 | 3.0756623E−05 |
| A8 | −9.8371608E−07 | −1.3198820E−05 |
| A9 | 6.6521517E−07 | −1.2475873E−06 |
| A10 | 3.1362003E−08 | 5.8670001E−07 |
| A11 | −1.5688034E−08 | 3.0758521E−08 |
| A12 | −2.8539526E−10 | −1.4026653E−08 |
| A13 | 2.2832384E−10 | −4.6476014E−10 |
| A14 | −3.2834481E−12 | 2.0000231E−10 |
| A15 | −2.0075665E−12 | 4.2060656E−12 |
| A16 | 9.0551584E−14 | −1.7034895E−12 |
| A17 | 9.7705505E−15 | −2.0919415E−14 |
| A18 | −7.0550021E−16 | 8.0140628E−15 |
| A19 | −2.0196558E−17 | 4.3944269E−17 |
| A20 | 1.9259437E−18 | −1.6044904E−17 |

### Example 18

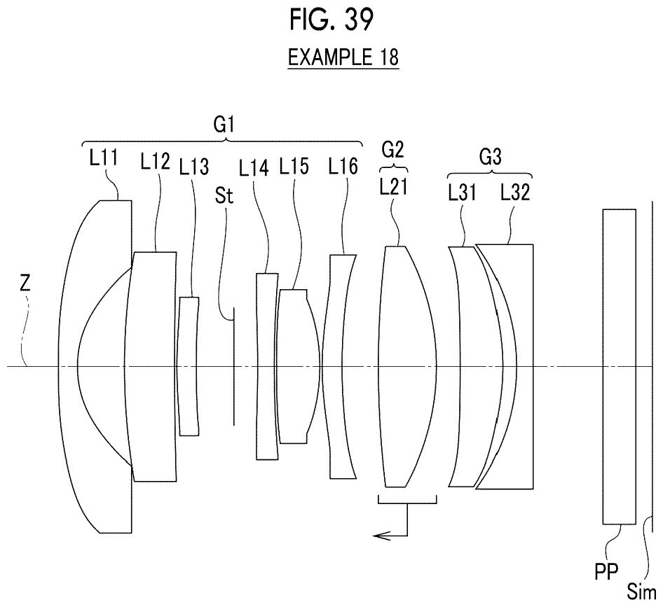

A cross-sectional view of a configuration of an imaging lens of Example 18 is illustrated in FIG. 39. The imaging lens of Example 18 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, the lenses L11 to L13, the aperture stop St, and the lenses L14 to L16. The second lens group G2 consists of one lens that is the lens L21. The third lens group G3 consists of, in order from the object side to the image side, two lenses including the lenses L31 and L32.

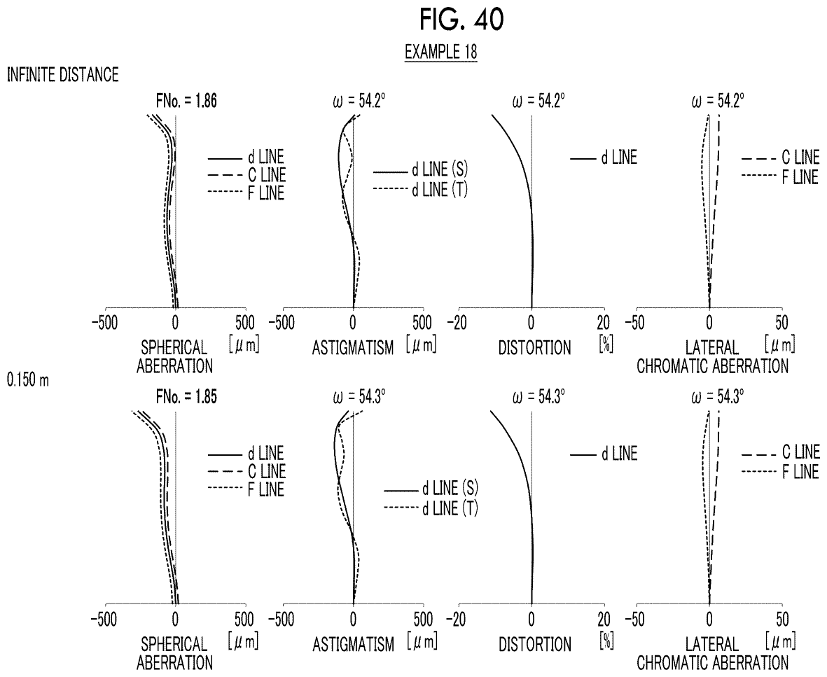

For the imaging lens of Example 18, Table 69 shows basic lens data, Table 70 shows specifications, Table 71 shows a variable surface spacing, Tables 72A and 72B show aspherical coefficients, and FIG. 40 illustrates each aberration diagram.

TABLE 69
Example 18

| Sn | R | D | Nd | vd | ED | Hinf |
|---|---|---|---|---|---|---|
| *1 | 209.8548 | 0.7998 | 1.69350 | 53.20 | 11.44 | |
| *2 | 4.8528 | 1.9809 | | | 8.05 | |
| 3 | 29.1198 | 2.0867 | 2.00069 | 25.46 | 7.72 | |
| 4 | 170.4272 | 0.0999 | | | 6.29 | |
| *5 | 19.5688 | 0.8159 | 1.80610 | 40.73 | 5.93 | 1.72 |
| *6 | 45.8972 | 1.5816 | | | 5.24 | |
| 7 (St) | ∞ | 1.0004 | | | | |
| 8 | −69.5044 | 0.7017 | 2.10420 | 17.02 | 5.27 | |
| 9 | 48.1658 | 0.0998 | | | 5.45 | |
| *10 | 84.3797 | 1.8202 | 1.76802 | 49.24 | 5.52 | |
| *11 | −8.2949 | 0.0998 | | | 5.81 | |
| *12 | 12.7785 | 0.8367 | 1.61881 | 63.85 | 6.59 | (2.64) |
| *13 | 22.3471 | DD[13] | | | 6.89 | |
| 14 | 43.6406 | 2.4467 | 1.69680 | 55.46 | 8.22 | |
| 15 | −10.7829 | DD[15] | | | 8.76 | |
| *16 | −127.3272 | 1.7764 | 1.69350 | 53.20 | 8.92 | |
| *17 | −9.8499 | 0.5778 | | | 9.22 | |
| 18 | −8.9431 | 0.7002 | 1.92286 | 20.88 | 9.17 | |
| 19 | 2968494.4385 | 2.9422 | | | 10.04 | |
| 20 | ∞ | 1.3800 | 1.51680 | 64.20 | | |
| 21 | ∞ | 0.7094 | | | | |

TABLE 70
Example 18

| | |
|---|---|
| f | 5.75 |
| Bf | 4.56 |
| Fno | 1.86 |
| 2ωm [°] | 108.4 |

TABLE 71
Example 18

| | Infinite Distance | 0.150 m |
|---|---|---|
| DD[13] | 1.5311 | 1.3317 |
| DD[15] | 0.9998 | 1.1992 |

TABLE 72A
Example 18

| Sn | 1 | 2 | 5 | 6 |
|---|---|---|---|---|
| KA | 1.0000000E+00 | 1.0000000E+00 | 1.0000000E+00 | 1.0000000E+00 |
| A3 | −6.0715322E−19 | −3.4694470E−19 | −5.2041704E−19 | −4.1633363E−18 |
| A4 | 4.7577774E−03 | 4.0626785E−03 | −1.2013930E−03 | −1.2642343E−03 |
| A5 | −1.0035024E−03 | −5.8652091E−04 | −1.8370140E−04 | 1.0124996E−03 |
| A6 | −1.7419445E−04 | −3.7713251E−04 | −1.6572982E−06 | −1.7173678E−04 |
| A7 | 5.8267513E−05 | 5.6659660E−05 | 1.0395872E−05 | −5.5788362E−05 |
| A8 | 3.9269043E−06 | 7.7936224E−06 | 3.9520927E−06 | 2.7399968E−05 |
| A9 | −1.7464476E−06 | −2.1837943E−06 | −5.4890226E−07 | 2.6495528E−06 |
| A10 | −7.7030902E−08 | 5.1605873E−08 | −1.5886894E−07 | −1.0745227E−06 |
| A11 | 3.1259243E−08 | 4.9369655E−08 | 1.5516817E−08 | −6.9915664E−08 |
| A12 | 1.9084899E−09 | −9.3385281E−09 | 3.5284506E−09 | 2.2621640E−08 |
| A13 | −3.4740584E−10 | −6.9114295E−10 | −2.5246904E−10 | 1.0970565E−09 |
| A14 | −3.8860836E−11 | 2.3302175E−10 | −5.1122251E−11 | −2.9313743E−10 |
| A15 | 2.3646753E−12 | 5.8722227E−12 | 2.3877973E−12 | −1.0134302E−11 |
| A16 | 4.7727060E−13 | −2.7051423E−12 | 4.6624508E−13 | 2.3179570E−12 |
| A17 | −9.0603373E−15 | −2.7728836E−14 | −1.2237253E−14 | 5.0932407E−14 |
| A18 | −3.0397158E−15 | 1.5611755E−14 | −2.3839584E−15 | −1.0266170E−14 |
| A19 | 1.4969351E−17 | 5.5833982E−17 | 2.6271484E−17 | −1.0741699E−16 |
| A20 | 7.7476367E−18 | −3.6148406E−17 | 5.1803982E−18 | 1.9543642E−17 |
| Sn | 10 | 11 | 12 | 13 |
| KA | 1.0000000E+00 | 1.0000000E+00 | 1.0000000E+00 | 1.0000000E+00 |
| A3 | −2.1684043E−19 | 6.9388939E−19 | 1.0570971E−19 | −8.6736174E−20 |
| A4 | 1.1518785E−03 | −4.1995426E−04 | −1.4790241E−03 | −4.0441254E−04 |
| A5 | 6.6559521E−05 | 3.4468582E−05 | −7.7969308E−05 | −9.1371186E−05 |
| A6 | −1.0140500E−04 | 3.5034658E−05 | 1.0664874E−04 | 4.1680614E−05 |
| A7 | 1.8350682E−06 | −1.2380681E−05 | −1.9211541E−06 | 9.1332422E−06 |
| A8 | 5.0925679E−06 | −3.6742220E−06 | −6.2699160E−06 | −7.6530291E−07 |
| A9 | −1.1586146E−07 | 4.9894147E−07 | 7.8138572E−08 | −3.7276232E−07 |
| A10 | −1.7204153E−07 | 1.5972912E−07 | 2.2458366E−07 | −1.2954031E−08 |
| A11 | 2.9503785E−09 | −1.1653212E−08 | −1.4724236E−09 | 8.8386328E−09 |
| A12 | 3.7215284E−09 | −3.8895160E−09 | −4.9492443E−09 | 9.2190487E−10 |
| A13 | −4.3111175E−11 | 1.6774875E−10 | 1.6491329E−11 | −1.2785749E−10 |
| A14 | −5.0703711E−11 | 5.6872455E−11 | 6.7733851E−11 | −1.9410182E−11 |
| A15 | 3.7490855E−13 | −1.4562447E−12 | −1.1218880E−13 | 1.1107105E−12 |
| A16 | 4.2177310E−13 | −4.9578005E−13 | −5.6163691E−13 | 2.0743022E−13 |
| A17 | −1.8016801E−15 | 6.9867926E−15 | 4.2637634E−16 | −5.3259497E−15 |
| A18 | −1.9584487E−15 | 2.3761496E−15 | 2.5852668E−15 | −1.1375345E−15 |
| A19 | 3.6874801E−18 | −1.4222384E−17 | −7.0078306E−19 | 1.0841099E−17 |
| A20 | 3.8909256E−18 | −4.8216582E−18 | −5.0713672E−18 | 2.5450258E−18 |

TABLE 72B
Example 18

| Sn | 16 | 17 |
|---|---|---|
| KA | 1.0000000E+00 | 1.0000000E+00 |
| A3 | −3.4694470E−19 | 1.7347235E−19 |
| A4 | −6.4853930E−04 | 1.7309040E−03 |
| A5 | 1.7296261E−04 | −5.9020461E−04 |
| A6 | 3.8278605E−05 | 1.3205076E−04 |
| A7 | −1.5036211E−05 | 3.6055645E−05 |
| A8 | −3.3404612E−06 | −1.5278769E−05 |
| A9 | 5.7626427E−07 | −1.3959699E−06 |
| A10 | 1.2328150E−07 | 6.4649355E−07 |
| A11 | −1.3240501E−08 | 3.3318240E−08 |
| A12 | −2.4549122E−09 | −1.5146693E−08 |
| A13 | 1.8912507E−10 | −4.9181155E−10 |
| A14 | 2.8295304E−11 | 2.1371053E−10 |
| A15 | −1.6407523E−12 | 4.3728001E−12 |
| A16 | −1.8649311E−13 | −1.8089937E−12 |
| A17 | 7.9107796E−15 | −2.1450866E−14 |
| A18 | 6.3753599E−16 | 8.4735386E−15 |
| A19 | −1.6249768E−17 | 4.4578866E−17 |
| A20 | −8.3738328E−19 | −1.6898058E−17 |

### Example 19

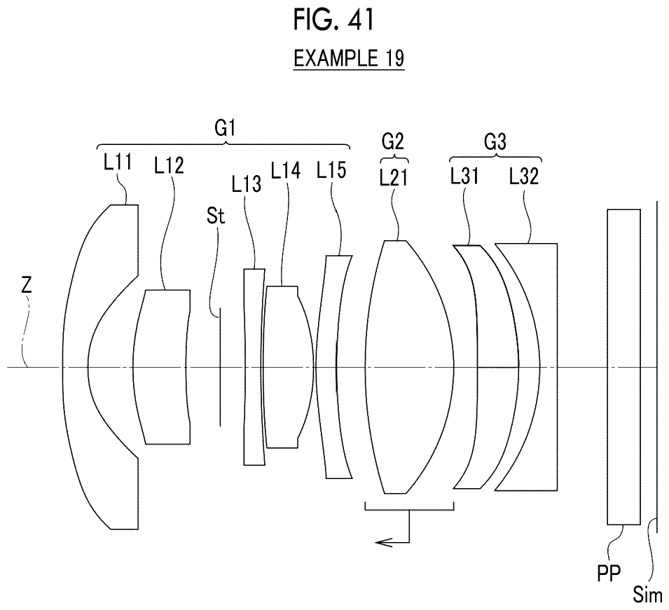

A cross-sectional view of a configuration of an imaging lens of Example 19 is illustrated in FIG. 41. The imaging lens of Example 19 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, the lenses L11 and L12, the aperture stop St, and the lenses L13 to L15. The second lens group G2 consists of one lens that is the lens L21. The third lens group G3 consists of, in order from the object side to the image side, two lenses including the lenses L31 and L32.

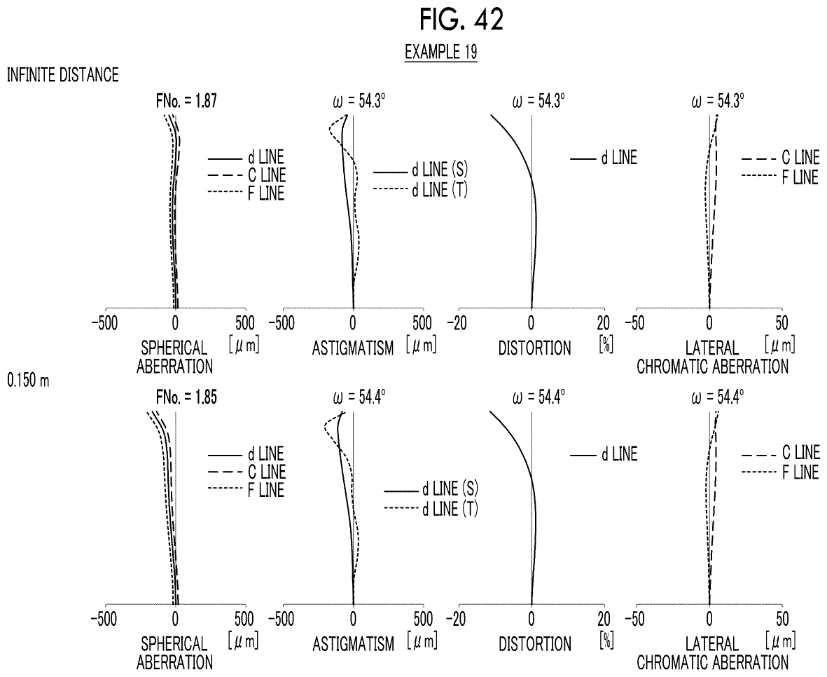

For the imaging lens of Example 19, Table 73 shows basic lens data, Table 74 shows specifications, Table 75 shows a variable surface spacing, Tables 76A and 76B show aspherical coefficients, and FIG. 42 illustrates each aberration diagram.

TABLE 73
Example 19

| Sn | R | D | Nd | vd | ED | Hinf |
|---|---|---|---|---|---|---|
| *1 | 262.7694 | 1.0584 | 1.76802 | 49.24 | 10.85 | |
| *2 | 4.8317 | 1.8962 | | | 7.39 | |
| *3 | 9.4996 | 2.2297 | 1.68948 | 31.02 | 6.59 | 2.65 |
| *4 | 28.2179 | 1.4410 | | | 4.78 | |
| 5 (St) | ∞ | 1.0586 | | | | |
| 6 | −64.6071 | 0.6560 | 2.10420 | 17.02 | 5.39 | |
| 7 | 52.8543 | 0.0998 | | | 5.60 | |
| *8 | 65.9432 | 2.1177 | 1.76802 | 49.24 | 5.69 | |
| *9 | −8.1281 | 0.0998 | | | 6.10 | |
| *10 | 13.2083 | 0.8458 | 1.69350 | 53.20 | 6.93 | (3.1) |
| *11 | 22.4824 | DD[11] | | | 7.21 | |
| 12 | 18.3518 | 3.7265 | 1.49700 | 81.61 | 8.51 | |
| 13 | −8.2933 | DD[13] | | | 9.24 | |
| *14 | −177.2737 | 1.7368 | 1.55332 | 71.68 | 9.15 | |
| *15 | −9.7710 | 0.8853 | | | 9.54 | |
| 16 | −8.2927 | 0.7399 | 1.92286 | 20.88 | 9.35 | |
| 17 | 3898046.9983 | 2.1113 | | | 10.42 | |
| 18 | ∞ | 1.3800 | 1.51680 | 64.20 | | |
| 19 | ∞ | 0.7079 | | | | |

TABLE 74
Example 19

| | |
|---|---|
| f | 5.75 |
| Bf | 3.73 |
| Fno | 1.87 |
| 2ωm [°] | 108.6 |

TABLE 75
Example 19

| | Infinite Distance | 0.150 m |
|---|---|---|
| DD[11] | 1.1998 | 1.0186 |
| DD[13] | 0.9998 | 1.1810 |

TABLE 76A
Example 19

| Sn | 1 | 2 | 3 | 4 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | −7.2858386E−18 | 4.1633363E−18 |
| A4 | 7.7957010E−03 | 7.7895804E−03 | 5.0434231E−04 | 1.7911869E−03 |
| A5 | −1.2507968E−03 | 9.1545729E−04 | 4.6266314E−04 | 4.9779466E−04 |
| A6 | −5.0467176E−04 | −1.2160838E−03 | −1.4760072E−04 | −2.0472348E−04 |
| A7 | 1.0008149E−04 | −7.7353347E−05 | −5.7108960E−05 | 3.5346861E−06 |
| A8 | 1.9545514E−05 | 7.2970207E−05 | 5.1048501E−06 | 1.4260723E−05 |
| A9 | −4.1425003E−06 | 3.2284092E−06 | 2.2788360E−06 | −2.9343272E−07 |
| A10 | −4.9253004E−07 | −2.6021647E−06 | −1.0604952E−07 | −5.4208081E−07 |
| A11 | 1.0217001E−07 | −7.8586132E−08 | −5.3768030E−08 | 8.7142074E−09 |
| A12 | 8.7746659E−09 | 5.7455704E−08 | 1.2645689E−09 | 1.2327937E−08 |
| A13 | −1.5380240E−09 | 1.1689860E−09 | 7.7853082E−10 | −1.3737286E−10 |
| A14 | −1.1227068E−10 | −7.9285648E−10 | −7.2122220E−12 | −1.7256105E−10 |
| A15 | 1.3856955E−11 | −1.0440620E−11 | −6.7856197E−12 | 1.2432385E−12 |
| A16 | 9.7210842E−13 | 6.6540908E−12 | −1.6532972E−15 | 1.4579976E−12 |
| A17 | −6.8629899E−14 | 5.1394208E−14 | 3.2669858E−14 | −6.1052783E−15 |
| A18 | −4.9760456E−15 | −3.1058244E−14 | 2.2550578E−16 | −6.8227580E−15 |
| A19 | 1.4367260E−16 | −1.0712120E−16 | −6.6760151E−17 | 1.2629615E−17 |
| A20 | 1.1141303E−17 | 6.1817502E−17 | −7.8306886E−19 | 1.3579901E−17 |

| Sn | 8 | 9 | 10 | 11 |
|---|---|---|---|---|
| KA | 1.0000000E+00 | 1.0000000E+00 | 1.0000000E+00 | 1.0000000E+00 |
| A3 | 8.6736174E−20 | −1.7347235E−19 | 4.8789098E−19 | 1.7347235E−19 |
| A4 | 1.0885546E−03 | −1.4522265E−03 | −1.9423891E−03 | 1.6305925E−04 |
| A5 | −2.7810371E−05 | 1.0264636E−05 | −3.2479311E−06 | −1.1240703E−04 |
| A6 | −1.0502696E−04 | 1.3664489E−04 | 1.3365996E−04 | −1.4968897E−05 |
| A7 | 5.1833970E−06 | −6.9341040E−06 | −3.7844220E−07 | 1.1566472E−05 |
| A8 | 6.4678226E−06 | −1.0360831E−05 | −7.3743120E−06 | 2.5706847E−06 |
| A9 | −3.0311504E−07 | 3.6439834E−07 | −1.7971390E−08 | −4.8102051E−07 |
| A10 | −2.5161891E−07 | 4.1374042E−07 | 2.5406358E−07 | −1.3014285E−07 |
| A11 | 8.5164519E−09 | −9.2676868E−09 | 1.0054662E−09 | 1.1400991E−08 |
| A12 | 5.9526681E−09 | −9.7363620E−09 | −5.4561778E−09 | 3.4779913E−09 |
| A13 | −1.3613878E−10 | 1.3914857E−10 | −2.0906507E−11 | −1.6430216E−10 |
| A14 | −8.6178875E−11 | 1.3992807E−10 | 7.3339743E−11 | −5.4314431E−11 |
| A15 | 1.2653534E−12 | −1.2397726E−12 | 2.2591953E−13 | 1.4223334E−12 |
| A16 | 7.4855062E−13 | −1.2075476E−12 | −6.0052956E−13 | 4.9754579E−13 |
| A17 | −6.3763896E−15 | 6.0556885E−15 | −1.2590583E−15 | −6.8028650E−15 |
| A18 | −3.5871073E−15 | 5.7499051E−15 | 2.7408479E−15 | −2.4793606E−15 |
| A19 | 1.3497791E−17 | −1.2483275E−17 | 2.8621369E−18 | 1.3818078E−17 |
| A20 | 7.2931455E−18 | −1.1614888E−17 | −5.3473396E−18 | 5.1926250E−18 |

TABLE 76B
Example 19

| Sn | 14 | 15 |
|---|---|---|
| KA | 1.0000000E+00 | 1.0000000E+00 |
| A3 | −7.8062556E−19 | 1.2143064E−18 |
| A4 | −9.2678506E−04 | 1.8504522E−03 |
| A5 | −2.0259214E−05 | −7.2952571E−04 |
| A6 | 6.1828951E−05 | 1.2782093E−04 |
| A7 | −9.1738262E−06 | 3.8399437E−05 |
| A8 | −5.3039832E−06 | −1.6035175E−05 |
| A9 | 4.2059999E−07 | −1.4016369E−06 |
| A10 | 2.0590270E−07 | 7.0591029E−07 |
| A11 | −1.0474585E−08 | 3.2411556E−08 |
| A12 | −4.4196566E−09 | −1.7055972E−08 |
| A13 | 1.5795219E−10 | −4.6945990E−10 |
| A14 | 5.6234846E−11 | 2.4702727E−10 |
| A15 | −1.4271443E−12 | 4.1232369E−12 |
| A16 | −4.2312584E−13 | −2.1389521E−12 |
| A17 | 7.0977043E−15 | −2.0054974E−14 |
| A18 | 1.7417120E−15 | 1.0217868E−14 |
| A19 | −1.4925166E−17 | 4.1416811E−17 |
| A20 | −3.0269430E−18 | −2.0724265E−17 |

### Example 20

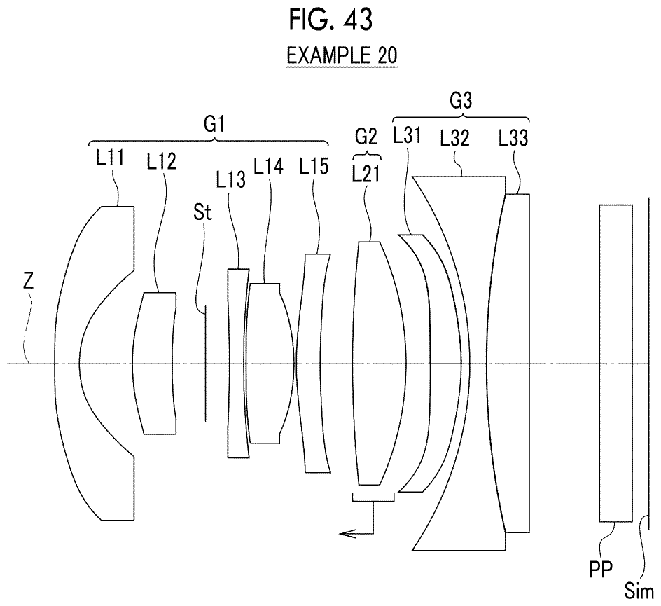

A cross-sectional view of a configuration of an imaging lens of Example 20 is illustrated in FIG. 43. The imaging lens of Example 20 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, the lenses L11 and L12, the aperture stop St, and the lenses L13 to L15. The second lens group G2 consists of one lens that is the lens L21. The third lens group G3 consists of, in order from the object side to the image side, three lenses including the lenses L31 to L33.

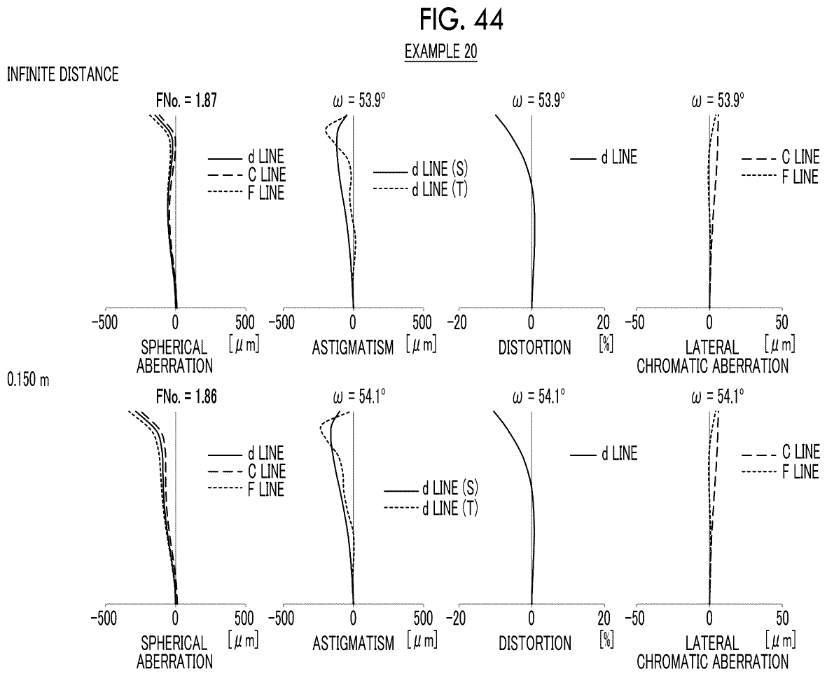

For the imaging lens of Example 20, Table 77 shows basic lens data, Table 78 shows specifications, Table 79 shows a variable surface spacing, Tables 80A and 80B show aspherical coefficients, and FIG. 44 illustrates each aberration diagram.

TABLE 77
Example 20

| Sn | R | D | Nd | vd | ED | Hinf |
|---|---|---|---|---|---|---|
| *1 | 300.0139 | 1.0413 | 1.76802 | 49.24 | 10.63 | |
| *2 | 4.7553 | 2.2318 | | | 7.24 | |
| *3 | 8.8629 | 1.6748 | 1.68948 | 31.02 | 6.04 | 2.52 |
| *4 | 30.0245 | 1.3990 | | | 4.72 | |
| 5 (St) | ∞ | 1.0042 | | | | |
| 6 | −59.3154 | 0.5998 | 1.94595 | 17.98 | 5.37 | |
| 7 | 35.2754 | 0.1002 | | | 5.57 | |
| *8 | 66.7997 | 2.0184 | 1.76802 | 49.24 | 5.65 | |
| *9 | −8.3302 | 0.0998 | | | 6.02 | |
| *10 | 12.7601 | 1.0030 | 1.58313 | 59.46 | 6.83 | (2.63) |
| *11 | 25.6861 | DD[11] | | | 7.20 | |
| 12 | 50.7043 | 2.2505 | 1.88100 | 40.14 | 8.23 | |
| 13 | −12.7412 | DD[13] | | | 8.69 | |
| *14 | −218.1780 | 1.3032 | 1.49710 | 81.56 | 8.73 | |
| *15 | −9.6677 | 0.3593 | | | 9.02 | |
| 16 | −14.4378 | 0.6998 | 2.10420 | 17.02 | 9.01 | |
| 17 | 33.1903 | 1.8098 | 1.77250 | 49.62 | 9.60 | |
| 18 | ∞ | 2.9515 | | | 10.27 | |
| 19 | ∞ | 1.3800 | 1.51680 | 64.20 | | |
| 20 | ∞ | 0.7021 | | | | |

TABLE 78
Example 20

| | |
|---|---|
| f | 5.74 |
| Bf | 4.56 |
| Fno | 1.87 |
| 2ωm [°] | 107.8 |

TABLE 79
Example 20

| | Infinite Distance | 0.150 m |
|---|---|---|
| DD[11] | 1.3381 | 1.1661 |
| DD[13] | 1.0186 | 1.1906 |

TABLE 80A
Example 20

| Sn | 1 | 2 | 3 | 4 |
|---|---|---|---|---|
| KA | 1.0000000E+00 | 1.0000000E+00 | 1.0000000E+00 | 1.0000000E+00 |
| A3 | −6.9388939E−19 | −6.9388939E−19 | 4.8572257E−18 | 1.9081958E−18 |
| A4 | 8.1694944E−03 | 7.9512174E−03 | 3.5903172E−04 | 1.8154387E−03 |
| A5 | −1.2584093E−03 | 1.0044070E−03 | 4.0782977E−04 | 3.9199239E−04 |
| A6 | −5.2571593E−04 | −1.2240666E−03 | −1.4385593E−04 | −1.5605630E−04 |
| A7 | 1.0122147E−04 | −8.4554250E−05 | −6.0434397E−05 | −2.6013339E−06 |
| A8 | 2.0494850E−05 | 7.3194893E−05 | 4.2774686E−06 | 9.8803205E−06 |
| A9 | −4.2020735E−06 | 3.5249392E−06 | 2.4863366E−06 | −2.1434830E−07 |
| A10 | −5.2790599E−07 | −2.6087107E−06 | −5.3961725E−08 | −3.6945399E−07 |
| A11 | 1.0388640E−07 | −8.5529523E−08 | −5.9397683E−08 | 8.9143173E−09 |
| A12 | 9.7145714E−09 | 5.7605835E−08 | −3.0107212E−10 | 8.4176956E−09 |
| A13 | −1.5670350E−09 | 1.2672070E−09 | 8.6596700E−10 | −1.5891347E−10 |
| A14 | −1.2811535E−10 | −7.9500749E−10 | 1.9057206E−11 | −1.1868543E−10 |
| A15 | 1.4143210E−11 | −1.1274950E−11 | −7.5855107E−12 | 1.5332056E−12 |
| A16 | 1.1307882E−12 | 6.6719750E−12 | −2.5413206E−13 | 1.0117524E−12 |
| A17 | −7.0154434E−14 | 5.5315770E−14 | 3.6674009E−14 | −7.8445249E−15 |
| A18 | −5.8351863E−15 | −3.1137295E−14 | 1.5274844E−15 | −4.7794459E−15 |
| A19 | 1.4705436E−16 | −1.1497198E−16 | −7.5210742E−17 | 1.6737143E−17 |
| A20 | 1.3076759E−17 | 6.1961212E−17 | −3.5801568E−18 | 9.6072384E−18 |

| Sn | 8 | 9 | 10 | 11 |
|---|---|---|---|---|
| KA | 1.0000000E+00 | 1.0000000E+00 | 1.0000000E+00 | 1.0000000E+00 |
| A3 | 1.3010426E−19 | −1.2143064E−18 | 3.0357661E−19 | −4.3368087E−19 |
| A4 | 1.3993159E−03 | −5.4075692E−04 | −1.9533957E−03 | −9.7965553E−04 |
| A5 | 1.0179033E−05 | 3.9210753E−05 | −1.0299811E−04 | −1.3106056E−04 |
| A6 | −1.3839215E−04 | 4.6443639E−05 | 1.4495238E−04 | 8.1811453E−05 |
| A7 | 5.4134639E−06 | −1.3880007E−05 | 4.2281753E−06 | 1.4018045E−05 |
| A8 | 8.4144519E−06 | −5.1423004E−06 | −8.4139140E−06 | −2.1991170E−06 |
| A9 | −3.1144714E−07 | 6.4998116E−07 | −1.7064327E−07 | −5.7832564E−07 |
| A10 | −3.1724034E−07 | 2.3473428E−07 | 2.9806816E−07 | 1.6512493E−08 |
| A11 | 8.0575343E−09 | −1.6160887E−08 | 4.3236030E−09 | 1.3710206E−08 |
| A12 | 7.3355728E−09 | −5.9267702E−09 | −6.5127048E−09 | 5.7929233E−10 |
| A13 | −1.1990179E−10 | 2.4054738E−10 | −6.7063831E−11 | −1.9779864E−10 |
| A14 | −1.0462697E−10 | 8.9017064E−11 | 8.8568650E−11 | −1.7462715E−11 |
| A15 | 1.0507304E−12 | −2.1356882E−12 | 6.1946236E−13 | 1.7132289E−12 |
| A16 | 8.9952449E−13 | −7.9196200E−13 | −7.3115904E−13 | 2.0636582E−13 |
| A17 | −5.0399514E−15 | 1.0427872E−14 | −3.1284569E−15 | −8.1897788E−15 |
| A18 | −4.2775149E−15 | 3.8569162E−15 | 3.3556704E−15 | −1.1788908E−15 |
| A19 | 1.0213173E−17 | −2.1553072E−17 | 6.6482593E−18 | 1.6608807E−17 |
| A20 | 8.6429175E−18 | −7.9284399E−18 | −6.5697051E−18 | 2.6859151E−18 |

TABLE 80B
Example 20

| Sn | 14 | 15 |
|---|---|---|
| KA | 1.0000000E+00 | 1.0000000E+00 |
| A3 | −1.4528309E−18 | 6.9388939E−19 |
| A4 | −4.5821204E−04 | 2.7458741E−03 |
| A5 | −9.0894067E−05 | −6.5873548E−04 |
| A6 | 5.2012299E−06 | 5.3341935E−05 |
| A7 | −3.2820389E−06 | 3.6673664E−05 |
| A8 | −1.9507436E−06 | −1.2505141E−05 |
| A9 | 1.4283251E−07 | −1.3780405E−06 |
| A10 | 8.8164739E−08 | 6.0300028E−07 |
| A11 | −2.7135721E−09 | 3.2338207E−08 |
| A12 | −1.8719881E−09 | −1.5128136E−08 |
| A13 | 2.9012785E−11 | −4.7124084E−10 |
| A14 | 2.1886295E−11 | 2.2350273E−10 |
| A15 | −1.7903486E−13 | 4.1416960E−12 |
| A16 | −1.4135693E−13 | −1.9572761E−12 |
| A17 | 5.9695887E−16 | −2.0087977E−14 |
| A18 | 4.5246004E−16 | 9.4111580E−15 |
| A19 | −8.5209488E−19 | 4.1266386E−17 |
| A20 | −5.0113093E−19 | −1.9159017E−17 |

### Example 21

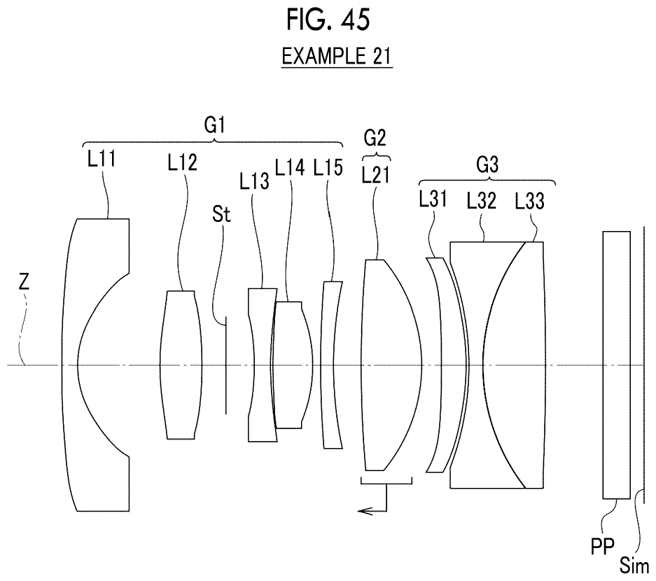

A cross-sectional view of a configuration of an imaging lens of Example 21 is illustrated in FIG. 45. The imaging lens of Example 21 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, the lenses L11 and L12, the aperture stop St, and the lenses L13 to L15. The second lens group G2 consists of one lens that is the lens L21. The third lens group G3 consists of, in order from the object side to the image side, three lenses including the lenses L31 to L33.

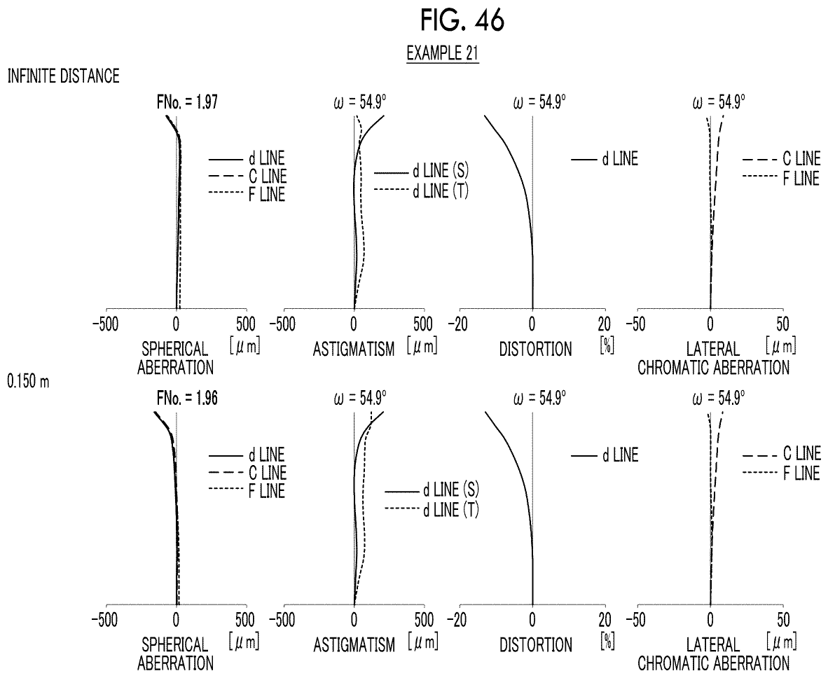

For the imaging lens of Example 21, Table 81 shows basic lens data, Table 82 shows specifications, Table 83 shows a variable surface spacing, Tables 84A and 84B show aspherical coefficients, and FIG. 46 illustrates each aberration diagram.

TABLE 81
Example 21

| Sn | R | D | Nd | vd | ED | Hinf |
|---|---|---|---|---|---|---|
| *1 | 245.6990 | 0.7998 | 1.76802 | 49.24 | 12.69 | |
| *2 | 5.0439 | 4.1599 | | | 9.03 | |
| *3 | 13.1800 | 2.1243 | 1.80610 | 40.73 | 7.58 | 2.59 |
| *4 | −21.6209 | 1.2053 | | | 7.02 | |
| 5 (St) | ∞ | 1.4405 | | | | |
| *6 | −13.0477 | 0.8203 | 1.68948 | 31.02 | 5.09 | |
| *7 | 15.2010 | 0.1230 | | | 5.44 | |
| *8 | 20.0509 | 2.0074 | 1.76802 | 49.24 | 5.47 | |
| *9 | −8.0006 | 0.4019 | | | 5.84 | |
| 10 | 53.6085 | 0.6225 | 1.75520 | 27.53 | 6.67 | |
| 11 | 20.6203 | DD[11] | | | 6.97 | |
| 12 | 63.3218 | 3.0590 | 1.71300 | 53.94 | 8.22 | |
| 13 | −8.5686 | DD[13] | | | 9.01 | |
| *14 | −80.3447 | 1.2468 | 1.69350 | 53.20 | 9.03 | |
| *15 | −12.6157 | 0.1428 | | | 9.29 | |
| 16 | −15.0417 | 0.6998 | 1.84666 | 23.78 | 9.30 | |
| 17 | 10.3172 | 3.1729 | 1.71300 | 53.94 | 10.16 | |
| 18 | −128.1759 | 2.9038 | | | 10.16 | |
| 19 | ∞ | 1.3800 | 1.51680 | 64.20 | | |
| 20 | ∞ | 0.6952 | | | | |

TABLE 82
Example 21

| | |
|---|---|
| f | 5.75 |
| Bf | 4.51 |
| Fno | 1.97 |
| 2ωm [°] | 109.8 |

TABLE 83
Example 21

| | Infinite Distance | 0.150 m |
|---|---|---|
| DD[11] | 1.3984 | 1.2164 |
| DD[13] | 0.9998 | 1.1818 |

TABLE 84A
Example 21

| Sn | 1 | 2 | 3 | 4 |
|---|---|---|---|---|
| KA | 1.0000000E+00 | 1.0000000E+00 | 1.0000000E+00 | 1.0000000E+00 |
| A3 | −8.6736174E−20 | −6.5052130E−19 | −2.3852448E−18 | 1.7564075E−18 |
| A4 | 1.6966732E−03 | 7.9383473E−04 | −9.3660890E−04 | −4.9521184E−04 |
| A5 | −7.2147883E−05 | 1.2825275E−04 | 3.5574111E−04 | 8.5399426E−05 |
| A6 | −1.4254498E−04 | −1.8940147E−04 | −1.2844912E−04 | −3.1943267E−05 |
| A7 | 5.3102824E−06 | −9.8644685E−06 | −9.3073275E−06 | −9.4126697E−06 |
| A8 | 7.1560517E−06 | 5.9530559E−06 | 6.3027180E−06 | 2.4275861E−06 |
| A9 | −2.3748105E−07 | 3.3093642E−07 | 3.0072424E−07 | 3.1170118E−07 |
| A10 | −2.3183052E−07 | −9.0253402E−08 | −2.0347981E−07 | −8.0024220E−08 |
| A11 | 6.3312062E−09 | −7.0201207E−09 | −7.1808714E−09 | −6.2078037E−09 |
| A12 | 5.0822364E−09 | 2.1251449E−10 | 4.2429382E−09 | 1.6369551E−09 |
| A13 | −1.0195158E−10 | 9.5944230E−11 | 1.0821159E−10 | 7.8478325E−11 |
| A14 | −7.3573548E−11 | 1.4910640E−11 | −5.5643198E−11 | −2.1594792E−11 |
| A15 | 9.7207857E−13 | −8.1306716E−13 | −9.7626593E−13 | −6.0932584E−13 |
| A16 | 6.6467240E−13 | −2.4034034E−13 | 4.4410409E−13 | 1.7712390E−13 |
| A17 | −5.0474647E−15 | 3.8739931E−15 | 4.8346963E−15 | 2.6351084E−15 |
| A18 | −3.3649952E−15 | 1.5509086E−15 | −1.9744065E−15 | −8.1864941E−16 |
| A19 | 1.0991890E−17 | −7.9308631E−18 | −1.0129688E−17 | −4.8438821E−18 |
| A20 | 7.2540371E−18 | −3.7919496E−18 | 3.7507426E−18 | 1.6277260E−18 |

| Sn | 6 | 7 | 8 | 9 |
|---|---|---|---|---|
| KA | 1.0000000E+00 | 1.0000000E+00 | 1.0000000E+00 | 1.0000000E+00 |
| A3 | 1.7347235E−19 | 5.2041704E−19 | 8.2399365E−19 | 8.6085652E−18 |
| A4 | −1.1133735E−05 | −3.3834899E−03 | −4.3486244E−03 | −8.0512780E−04 |
| A5 | 3.4937366E−04 | 3.6646415E−04 | 4.3376386E−04 | 4.2795500E−04 |
| A6 | −3.1262091E−04 | 3.5288930E−04 | 3.0934064E−04 | −1.7910653E−04 |
| A7 | −2.9450328E−05 | −3.4972945E−05 | 9.8513605E−07 | 9.4535788E−07 |
| A8 | 2.6650826E−05 | −2.1899107E−05 | −1.3583483E−05 | 1.6533001E−05 |
| A9 | 1.0130630E−06 | 1.4544174E−06 | −1.8726937E−07 | −5.1611614E−08 |
| A10 | −1.0737297E−06 | 7.8753388E−07 | 3.9552746E−07 | −6.9248284E−07 |
| A11 | −2.0360172E−08 | −3.3388455E−08 | 5.7323662E−09 | 4.7479750E−10 |
| A12 | 2.5065747E−08 | −1.7370098E−08 | −7.6032485E−09 | 1.6509552E−08 |
| A13 | 2.7612450E−10 | 4.6546621E−10 | −9.6373867E−11 | 3.6633533E−12 |
| A14 | −3.5620537E−10 | 2.3866273E−10 | 9.4999632E−11 | −2.3697361E−10 |
| A15 | −2.3786180E−12 | −3.9134171E−12 | 9.3516285E−13 | −1.0256554E−13 |
| A16 | 3.0393910E−12 | −1.9920737E−12 | −7.4159573E−13 | 2.0289256E−12 |
| A17 | 1.1632520E−14 | 1.8258684E−14 | −4.8892917E−15 | 7.5917910E−16 |
| A18 | −1.4320133E−14 | 9.2442478E−15 | 3.2841888E−15 | −9.5542759E−15 |
| A19 | −2.4485176E−17 | −3.6294232E−17 | 1.0667735E−17 | −1.9824816E−18 |
| A20 | 2.8646296E−17 | −1.8293565E−17 | −6.2934631E−18 | 1.9054401E−17 |

TABLE 84B
Example 21

| Sn | 14 | 15 |
|---|---|---|
| KA | 1.0000000E+00 | 1.0000000E+00 |
| A3 | 5.2041704E−19 | 1.7347235E−19 |
| A4 | −8.5130526E−04 | 4.8444631E−04 |
| A5 | 1.6636945E−04 | −2.1117428E−04 |
| A6 | 5.8093429E−05 | 9.8218554E−05 |
| A7 | −1.5563652E−05 | 1.4455607E−05 |
| A8 | −4.0663184E−06 | −1.0762855E−05 |
| A9 | 5.9375969E−07 | −5.7477205E−07 |
| A10 | 1.4246194E−07 | 4.7956156E−07 |
| A11 | −1.3615825E−08 | 1.3784195E−08 |
| A12 | −2.9352710E−09 | −1.1887896E−08 |
| A13 | 1.9332667E−10 | −2.0314331E−10 |
| A14 | 3.7426457E−11 | 1.7631764E−10 |
| A15 | −1.6600537E−12 | 1.7976840E−12 |
| A16 | −2.9054784E−13 | −1.5547434E−12 |
| A17 | 7.8984429E−15 | −8.7634385E−15 |
| A18 | 1.2584889E−15 | 7.5200209E−15 |
| A19 | −1.5983618E−17 | 1.8087039E−17 |
| A20 | −2.3333170E−18 | −1.5373337E−17 |

### Example 22

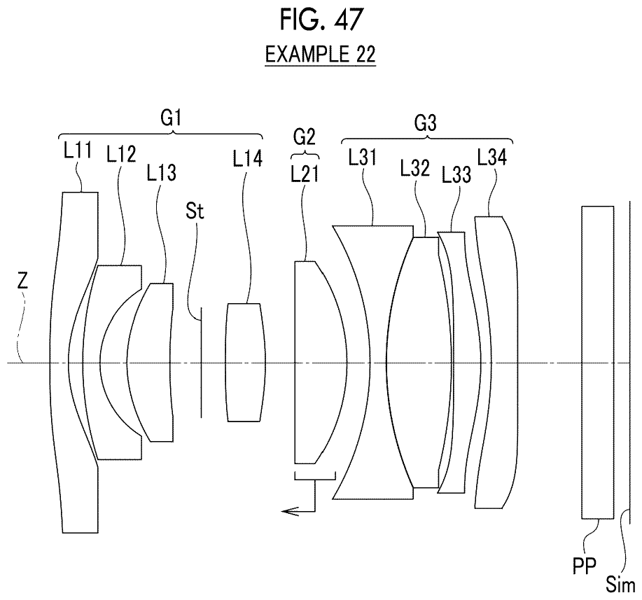

A cross-sectional view of a configuration of an imaging lens of Example 22 is illustrated in FIG. 47. The imaging lens of Example 22 consists of, in order from the object side to the image side, the first lens group G1 having a positive refractive power, the second lens group G2 having a positive refractive power, and the third lens group G3 having a positive refractive power. The focus group consists of the second lens group G2, and during the focusing from the infinite distance object to the nearest object, the focus group moves to the object side along the optical axis Z.

The first lens group G1 consists of, in order from the object side to the image side, the lenses L11 to L13, the aperture stop St, and the lens L14. The second lens group G2 consists of one lens that is the lens L21. The third lens group G3 consists of, in order from the object side to the image side, four lenses including lenses L31 to L34.

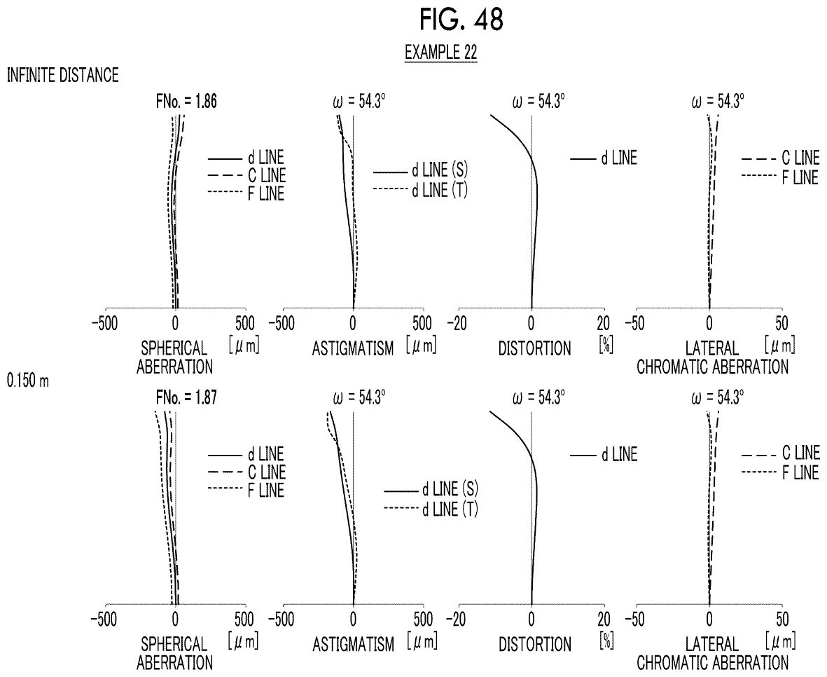

For the imaging lens of Example 22, Table 85 shows basic lens data, Table 86 shows specifications, Table 87 shows a variable surface spacing, Tables 88A and 88B show aspherical coefficients, and FIG. 48 illustrates each aberration diagram.

TABLE 85
Example 22

| Sn | R | D | Nd | vd | ED | Hinf |
|---|---|---|---|---|---|---|
| *1 | 79.5168 | 0.7998 | 1.59201 | 67.02 | 10.84 | 4.36 |
| *2 | 5.9928 | 0.6249 | | | 8.69 | 3.23 |
| 3 | 14.1393 | 0.7445 | 1.49700 | 81.61 | 8.53 | |
| 4 | 3.7904 | 1.1687 | | | 6.19 | |
| *5 | 5.7132 | 1.8602 | 1.69350 | 53.20 | 5.92 | |
| *6 | 24.1925 | 1.3642 | | | 4.75 | |
| 7 (St) | ∞ | 1.0406 | | | | |
| *8 | 44.1000 | 1.7342 | 1.76802 | 49.24 | 5.09 | |
| *9 | −11.8104 | DD[9] | | | 5.17 | (2.2) |
| 10 | −11021.8453 | 2.2280 | 1.77250 | 49.62 | 6.71 | |
| 11 | −7.9023 | DD[11] | | | 7.45 | |
| 12 | −11.8907 | 0.6999 | 1.92286 | 20.88 | 7.74 | |
| 13 | 13.5831 | 2.8235 | 1.83481 | 42.72 | 8.64 | |
| 14 | −20.3968 | 0.1002 | | | 9.43 | |
| *15 | −192.3878 | 1.1731 | 1.85135 | 40.10 | 9.61 | |
| *16 | −10.4589 | 0.4574 | | | 10.06 | 3.1 |
| *17 | −15.8706 | 1.1430 | 1.68948 | 31.02 | 10.57 | 3.73 |
| *18 | −144.9070 | 2.7809 | | | 11.49 | 1.02/2.39 |
| 19 | ∞ | 1.3800 | 1.51680 | 64.20 | | |
| 20 | ∞ | 0.7092 | | | | |

TABLE 86
Example 22

| | |
|---|---|
| f | 5.74 |
| Bf | 4.40 |
| Fno | 1.86 |
| 2ωm [°] | 108.6 |

TABLE 87
Example 22

| | Infinite Distance | 0.150 m |
|---|---|---|
| DD[9] | 1.2826 | 1.0966 |
| DD[11] | 1.0002 | 1.1862 |

TABLE 88A
Example 22

| Sn | 1 | 2 | 5 | 6 |
|---|---|---|---|---|
| KA | 1.0000000E+00 | 1.0000000E+00 | 1.0000000E+00 | 1.0000000E+00 |
| A3 | 2.4394549E−20 | −1.9244589E−19 | −8.6736174E−20 | 1.3877788E−18 |
| A4 | 1.3853985E−03 | −8.0057193E−04 | −1.6441539E−03 | −3.1863980E−04 |
| A5 | −5.9854433E−06 | 6.2428578E−05 | 3.5660406E−05 | 3.2115797E−04 |
| A6 | −9.9176157E−05 | −1.0831102E−04 | 6.1903609E−05 | 6.9385204E−05 |
| A7 | −9.3716844E−07 | −5.5251568E−06 | 4.3704103E−06 | −1.7242755E−05 |
| A8 | 5.0156300E−06 | 4.7641462E−06 | −4.0315192E−06 | −5.1864939E−06 |
| A9 | 3.7568946E−08 | 1.2202975E−07 | −2.6627216E−07 | 6.1469517E−07 |
| A10 | −1.8149789E−07 | −1.4591964E−07 | 1.3922790E−07 | 1.9456255E−07 |
| A11 | −5.9830858E−10 | −1.5708881E−09 | 7.0892076E−09 | −1.3358546E−08 |
| A12 | 4.3313649E−09 | 2.9716171E−09 | −2.8279760E−09 | −4.3264498E−09 |
| A13 | 3.7339919E−12 | 1.1630534E−11 | −1.0885154E−10 | 1.8114186E−10 |
| A14 | −6.5259670E−11 | −3.8405366E−11 | 3.5986473E−11 | 5.9575200E−11 |
| A15 | 8.1018522E−15 | −3.8913017E−14 | 9.8701250E−13 | −1.4972156E−12 |
| A16 | 5.9441151E−13 | 3.0260175E−13 | −2.8232984E−13 | −4.9816168E−13 |
| A17 | −2.1161206E−16 | −2.5138180E−17 | −4.9070156E−15 | 6.8942899E−15 |
| A18 | −2.9819038E−15 | −1.3269203E−15 | 1.2493418E−15 | 2.3148688E−15 |
| A19 | 7.3518717E−19 | 3.7956544E−19 | 1.0309903E−17 | −1.3545963E−17 |
| A20 | 6.3146260E−18 | 2.4809484E−18 | −2.3897458E−18 | −4.5843550E−18 |

| Sn | 8 | 9 | 15 | 16 |
|---|---|---|---|---|
| KA | 1.0000000E+00 | 1.0000000E+00 | 1.0000000E+00 | 1.0000000E+00 |
| A3 | 3.1225023E−18 | −2.2551405E−18 | 8.6736174E−20 | 3.4694470E−19 |
| A4 | 5.5011998E−04 | 6.2716995E−04 | −1.1257331E−04 | 1.1163180E−03 |
| A5 | 2.3244533E−05 | −1.4558876E−04 | −2.5457382E−05 | −8.9766682E−06 |
| A6 | −1.3152304E−05 | 4.2677130E−05 | −2.2367604E−05 | −5.5755123E−05 |
| A7 | 3.2460730E−05 | 3.2670938E−05 | 4.8381154E−06 | 4.3777741E−06 |
| A8 | 3.0149917E−06 | 1.2425837E−07 | 1.1690594E−06 | 4.3810125E−06 |
| A9 | −1.0734529E−06 | −1.0816366E−06 | −2.7885317E−07 | −2.6098215E−07 |
| A10 | −3.2348753E−07 | −4.4975012E−08 | −1.0048479E−07 | −1.6298528E−07 |
| A11 | 2.1520660E−08 | 2.1086079E−08 | 8.6567280E−09 | 6.9047148E−09 |
| A12 | 8.2908755E−09 | 1.0988632E−09 | 4.0973710E−09 | 3.3156219E−09 |
| A13 | −2.6900637E−10 | −2.6010575E−10 | −1.5336669E−10 | −1.0264252E−10 |
| A14 | −1.1876928E−10 | −1.3339389E−11 | −8.4007773E−11 | −3.9436444E−11 |
| A15 | 2.0443035E−12 | 1.9866632E−12 | 1.5515857E−12 | 8.8728322E−13 |
| A16 | 1.0189149E−12 | 9.6577264E−14 | 9.2606432E−13 | 2.7164319E−13 |
| A17 | −8.6607574E−15 | −8.5772027E−15 | −8.3574599E−15 | −4.1747488E−15 |
| A18 | −4.8146354E−15 | −3.8884382E−16 | −5.2718967E−15 | −9.8875255E−16 |
| A19 | 1.5656577E−17 | 1.6019504E−17 | 1.8617022E−17 | 8.2807648E−18 |
| A20 | 9.6380710E−18 | 6.7800707E−19 | 1.2196868E−17 | 1.4340282E−18 |

TABLE 88B
Example 22

| Sn | 17 | 18 |
|---|---|---|
| KA | 1.0000000E+00 | 1.0000000E+00 |
| A3 | 8.6736174E−19 | −2.3852448E−19 |
| A4 | 5.2881854E−04 | 7.5517705E−04 |
| A5 | 2.8975245E−04 | −4.0336521E−05 |
| A6 | −1.5689966E−04 | −5.7965779E−05 |
| A7 | −1.5263140E−05 | 5.1096167E−06 |
| A8 | 1.2288964E−05 | 1.2043681E−06 |
| A9 | 5.8027885E−07 | −2.2573948E−07 |
| A10 | −5.0044401E−07 | −7.5381310E−10 |
| A11 | −1.3576988E−08 | 5.0033124E−09 |
| A12 | 1.1945009E−08 | −7.6490990E−10 |
| A13 | 1.9442148E−10 | −6.3891834E−11 |
| A14 | −1.7423282E−10 | 2.1502247E−11 |
| A15 | −1.6683315E−12 | 4.7726874E−13 |
| A16 | 1.5301359E−12 | −2.7675023E−13 |
| A17 | 7.8887434E−15 | −1.9425780E−15 |
| A18 | −7.4332744E−15 | 1.7608035E−15 |
| A19 | −1.5818592E−17 | 3.3356960E−18 |
| A20 | 1.5347766E−17 | −4.4675684E−18 |

### Example 23

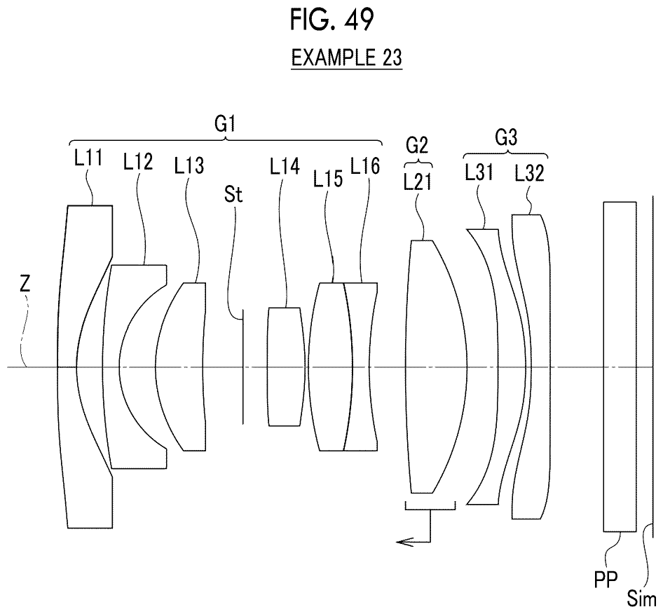

A cross-sectional view of a configuration of an imaging lens of Example 23 is illustrated in FIG. 49. The imaging lens of Example 23 consists of, in order from the object side to the image side, the first lens group G1 having a positive refractive power, the second lens group G2 having a positive refractive power, and the third lens group G3 having a positive refractive power. The focus group consists of the second lens group G2, and during the focusing from the infinite distance object to the nearest object, the focus group moves to the object side along the optical axis Z.

The first lens group G1 consists of, in order from the object side to the image side, the lenses L11 to L13, the aperture stop St, and the lenses L14 to L16. The second lens group G2 consists of one lens that is the lens L21. The third lens group G3 consists of, in order from the object side to the image side, two lenses including the lenses L31 and L32.

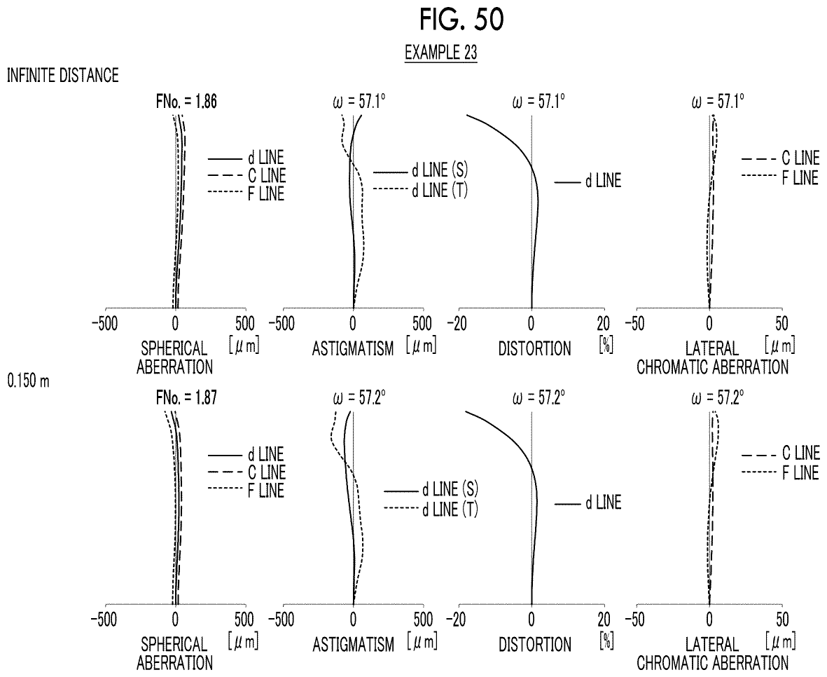

For the imaging lens of Example 23, Table 89 shows basic lens data, Table 90 shows specifications, Table 91 shows a variable surface spacing, Tables 92A and 92B show aspherical coefficients, and FIG. 50 illustrates each aberration diagram.

TABLE 89
Example 23

| Sn | R | D | Nd | vd | ED | Hinf |
|---|---|---|---|---|---|---|
| *1 | 254.1892 | 0.8001 | 1.49710 | 81.56 | 11.62 | 4.78 |
| *2 | 5.9749 | 1.0933 | | | 8.85 | 3.68 |
| 3 | 25.0116 | 0.6998 | 1.49700 | 81.61 | 8.68 | |
| 4 | 4.0701 | 1.5259 | | | 6.40 | |
| *5 | 5.6514 | 1.9915 | 1.76802 | 49.24 | 5.90 | |
| *6 | 26.9995 | 1.6907 | | | 4.78 | |
| 7 (St) | ∞ | 1.0221 | | | | |
| *8 | 117.9003 | 1.5943 | 1.76802 | 49.24 | 5.04 | |
| *9 | −11.7829 | 0.1410 | | | 5.03 | (2.12) |
| 10 | 13.8209 | 1.8351 | 1.80420 | 46.50 | 5.65 | |
| 11 | −17.2013 | 0.7002 | 1.92286 | 20.88 | 6.00 | |
| 12 | 15.3911 | DD[12] | | | 6.42 | |
| 13 | 59.6537 | 2.5902 | 1.71300 | 53.94 | 8.40 | |
| 14 | −10.7330 | DD[14] | | | 9.31 | |
| *15 | −151.4341 | 1.1661 | 1.69350 | 53.20 | 10.06 | |
| *16 | −12.7981 | 0.2369 | | | 10.62 | 3.54 |
| *17 | −21.4071 | 0.7998 | 1.68948 | 31.02 | 11.15 | 3.51 |
| *18 | −292.6618 | 2.2429 | | | 11.97 | 1.08/2.56 |
| 19 | ∞ | 1.3800 | 1.51680 | 64.20 | | |
| 20 | ∞ | 0.7117 | | | | |

TABLE 90
Example 23

| | |
|---|---|
| f | 5.75 |
| Bf | 3.86 |
| Fno | 1.86 |
| 2ωm [°] | 114.2 |

TABLE 91
Example 23

| | Infinite Distance | 0.150 m |
|---|---|---|
| DD[12] | 1.5273 | 1.2068 |
| DD[14] | 1.2998 | 1.6203 |

TABLE 92A
Example 23

| Sn | 1 | 2 | 5 | 6 |
|---|---|---|---|---|
| KA | 1.0000000E+00 | 1.0000000E+00 | 1.0000000E+00 | 1.0000000E+00 |
| A3 | 4.3368087E−20 | −3.4694470E−19 | 1.1709383E−18 | −2.6020852E−19 |
| A4 | 1.1550938E−03 | −3.3023337E−04 | −9.2821329E−04 | 5.0844604E−05 |
| A5 | 7.3301344E−05 | 6.2739965E−05 | 1.3517200E−04 | 1.8147953E−04 |
| A6 | −9.7527467E−05 | −1.2370330E−04 | −7.1975698E−06 | −5.2601680E−06 |
| A7 | −4.9994749E−06 | −2.5319436E−06 | −9.6085745E−07 | −1.1202141E−05 |
| A8 | 5.1494233E−06 | 5.1388762E−06 | −7.0279914E−08 | −3.8131416E−07 |
| A9 | 1.8447081E−07 | −1.9027803E−08 | −7.2854644E−08 | 4.3111805E−07 |
| A10 | −1.8063798E−07 | −1.5714420E−07 | 6.0487874E−09 | 2.4062652E−08 |
| A11 | −4.1321456E−09 | 2.1732388E−09 | 2.7770587E−09 | −9.7977813E−09 |
| A12 | 4.0703871E−09 | 3.3011502E−09 | −5.8142596E−11 | −6.3599779E−10 |
| A13 | 5.7905216E−11 | −4.7834506E−11 | −4.8407260E−11 | 1.3788931E−10 |
| A14 | −5.7654208E−11 | −4.4666215E−11 | −2.4111992E−13 | 9.7155724E−12 |
| A15 | −4.9548230E−13 | 5.1807892E−13 | 4.6688341E−13 | −1.1767512E−12 |
| A16 | 4.9563006E−13 | 3.7084231E−13 | 8.4783384E−15 | −8.7793039E−14 |
| A17 | 2.3640809E−15 | −2.8625702E−15 | −2.3984196E−15 | 5.5733380E−15 |
| A18 | −2.3629203E−15 | −1.7183430E−15 | −6.1822013E−17 | 4.3323021E−16 |
| A19 | −4.8132998E−18 | 6.4475925E−18 | 5.1263408E−18 | −1.1232729E−17 |
| A20 | 4.7911248E−18 | 3.3989166E−18 | 1.5579057E−19 | −9.0060040E−19 |

| Sn | 8 | 9 | 15 | 16 |
|---|---|---|---|---|
| KA | 1.0000000E+00 | 1.0000000E+00 | 1.0000000E+00 | 1.0000000E+00 |
| A3 | 3.1252128E−18 | −1.9081958E−18 | 0.0000000E+00 | 4.3368087E−19 |
| A4 | 7.7606226E−04 | 9.4803586E−04 | −1.8018203E−03 | −3.1364662E−03 |
| A5 | 1.2497405E−04 | 2.9893839E−05 | 2.1728664E−04 | 7.1339007E−05 |
| A6 | 1.9681840E−05 | −1.2167951E−05 | 2.0791376E−05 | 2.8617105E−04 |
| A7 | 4.1392264E−07 | 2.2701384E−05 | −1.4244909E−05 | 8.2962342E−07 |
| A8 | 1.0654419E−07 | 3.1847965E−06 | 5.7201886E−07 | −1.3511313E−05 |
| A9 | −7.9932267E−09 | −1.0274903E−06 | 5.4802204E−07 | −1.2970260E−07 |
| A10 | −2.5653327E−08 | −1.4258368E−07 | −5.4049948E−08 | 4.1907645E−07 |
| A11 | 1.4590822E−10 | 2.4969272E−08 | −1.2827601E−08 | 4.6889989E−09 |
| A12 | 7.4323308E−10 | 3.4957210E−09 | 1.6063610E−09 | −8.5457766E−09 |
| A13 | −3.1332826E−12 | −3.6499925E−10 | 1.8719567E−10 | −8.5739567E−11 |
| A14 | −1.1492074E−11 | −5.1636082E−11 | −2.6489830E−11 | 1.1205957E−10 |
| A15 | 4.0289046E−14 | 3.1917699E−12 | −1.6562640E−12 | 8.6489388E−13 |
| A16 | 1.0425950E−13 | 4.5519148E−13 | 2.5262446E−13 | −9.0773575E−13 |
| A17 | −2.5716726E−16 | −1.5382288E−14 | 8.1121175E−15 | −4.5926747E−15 |
| A18 | −5.1627195E−16 | −2.2063443E−15 | −1.2889678E−15 | 4.1322290E−15 |
| A19 | 6.3296736E−19 | 3.1434469E−17 | −1.6848543E−17 | 1.0060949E−17 |
| A20 | 1.0778589E−18 | 4.5270730E−18 | 2.7217639E−18 | −8.0739832E−18 |

TABLE 92B
Example 23

| Sn | 17 | 18 |
|---|---|---|
| KA | 1.0000000E+00 | 1.0000000E+00 |
| A3 | 4.9873300E−19 | −1.9515639E−19 |
| A4 | −2.8930658E−03 | 3.4328670E−04 |
| A5 | −1.2019175E−05 | −2.2242335E−05 |
| A6 | 2.6702450E−04 | −2.3526373E−05 |
| A7 | 2.5193898E−06 | 2.1619138E−06 |
| A8 | −1.2672262E−05 | 5.8285556E−07 |
| A9 | −5.3626904E−08 | −8.2334120E−08 |
| A10 | 3.8173874E−07 | −9.4815814E−09 |
| A11 | 3.2777373E−10 | 1.9633000E−09 |
| A12 | −7.5031578E−09 | −9.6056849E−11 |
| A13 | 5.7772350E−12 | −2.7962988E−11 |
| A14 | 9.5145763E−11 | 5.3152709E−12 |
| A15 | −1.2792636E−13 | 2.3562712E−13 |
| A16 | −7.4909320E−13 | −7.3791686E−14 |
| A17 | 9.3877359E−16 | −1.0923428E−15 |
| A18 | 3.3300554E−15 | 4.6200208E−16 |
| A19 | −2.4702084E−18 | 2.1550272E−18 |
| A20 | −6.3849889E−18 | −1.1202312E−18 |

### Example 24

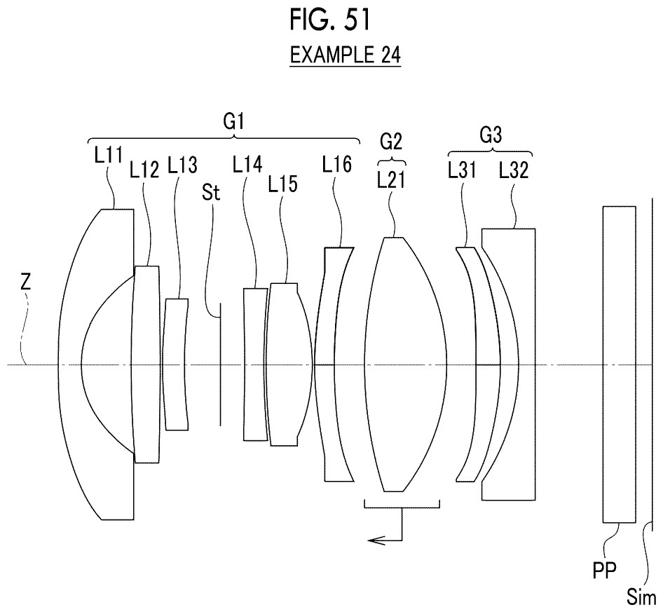

A cross-sectional view of a configuration of an imaging lens of Example 24 is illustrated in FIG. 51. The imaging lens of Example 24 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, the lenses L11 to L13, the aperture stop St, and the lenses L14 to L16. The second lens group G2 consists of one lens that is the lens L21. The third lens group G3 consists of, in order from the object side to the image side, two lenses including the lenses L31 and L32.

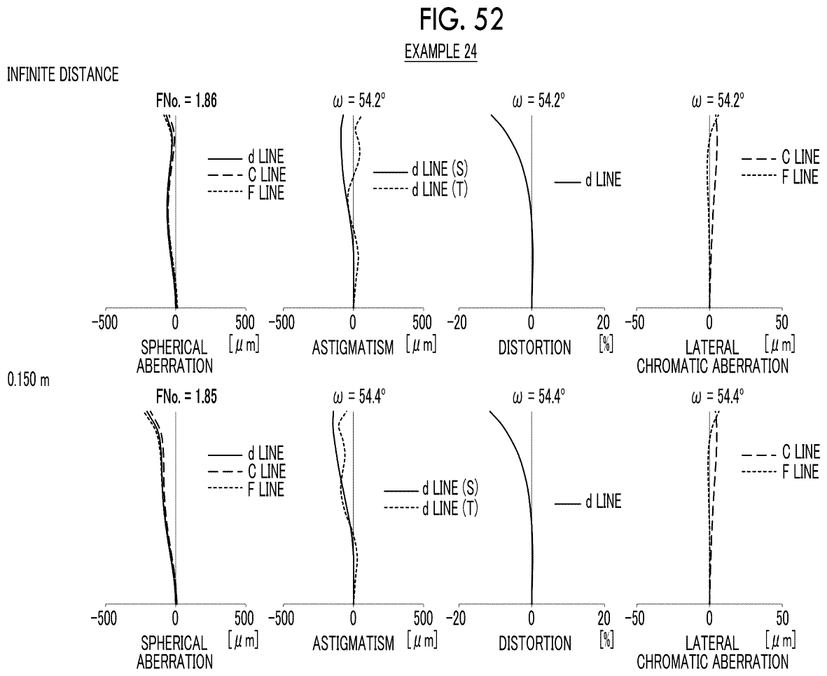

For the imaging lens of Example 24, Table 93 shows basic lens data, Table 94 shows specifications, Table 95 shows a variable surface spacing, Tables 96A and 96B show aspherical coefficients, and FIG. 52 illustrates each aberration diagram.

TABLE 93
Example 24

| Sn | R | D | Nd | vd | ED | Hinf |
|---|---|---|---|---|---|---|
| *1 | 52.2697 | 0.9723 | 1.69350 | 53.20 | 10.58 | |
| *2 | 4.5215 | 2.0953 | | | 7.18 | |
| 3 | 50.4760 | 1.2207 | 1.92119 | 23.96 | 6.80 | |
| 4 | −156.2324 | 0.0997 | | | 6.05 | |
| *5 | 17.7989 | 0.9253 | 1.80610 | 40.73 | 5.59 | 1.83 |
| *6 | 22.0718 | 1.5167 | | | 4.98 | |
| 7 (St) | ∞ | 1.0134 | | | | |
| 8 | −104.5029 | 0.8110 | 2.10420 | 17.02 | 5.46 | |
| 9 | 33.4251 | 0.0998 | | | 5.69 | |
| *10 | 36.9426 | 1.9364 | 1.76802 | 49.24 | 5.77 | |
| *11 | −8.4557 | 0.0998 | | | 6.14 | |
| *12 | 12.9019 | 0.8041 | 1.49710 | 81.56 | 7.01 | (3.49) |
| *13 | 21.4995 | DD[13] | | | 7.31 | |
| 14 | 18.1497 | 3.4597 | 1.59282 | 68.62 | 8.65 | |
| 15 | −8.9091 | DD[15] | | | 9.19 | |
| *16 | −300.0328 | 1.0246 | 1.55332 | 71.68 | 8.84 | |
| *17 | −11.8663 | 0.7688 | | | 9.01 | |
| 18 | −8.8786 | 0.6998 | 1.92286 | 20.88 | 8.96 | |
| 19 | −10500025.1347 | 2.8513 | | | 9.86 | |
| 20 | ∞ | 1.3800 | 1.51680 | 64.20 | | |
| 21 | ∞ | 0.7000 | | | | |

TABLE 94
Example 24

| | |
|---|---|
| f | 5.75 |
| Bf | 4.46 |
| Fno | 1.86 |
| 2ωm [°] | 108.4 |

TABLE 95
Example 24

| | Infinite Distance | 0.150 m |
|---|---|---|
| DD[13] | 1.2727 | 1.1189 |
| DD[15] | 1.2312 | 1.3850 |

TABLE 96A
Example 24

| Sn | 1 | 2 | 5 | 6 |
|---|---|---|---|---|
| KA | 1.0000000E+00 | 1.0000000E+00 | 1.0000000E+00 | 1.0000000E+00 |
| A3 | 2.6020852E−19 | −2.0816682E−18 | 6.9388939E−19 | 2.0816682E−17 |
| A4 | 5.3327816E−03 | 5.2200286E−03 | −5.5749998E−04 | −5.6257408E−04 |
| A5 | −1.0177890E−03 | −2.5509809E−04 | −5.0068146E−05 | 8.5812927E−04 |
| A6 | −2.0376593E−04 | −5.0212082E−04 | −1.7063107E−04 | −3.3044096E−04 |
| A7 | 5.8973318E−05 | 4.2815726E−05 | 3.9652609E−06 | −3.9439524E−05 |
| A8 | 4.8770648E−06 | 1.3475773E−05 | 1.5063912E−05 | 3.7450599E−05 |
| A9 | −1.7658894E−06 | −1.7143714E−06 | −2.5934244E−07 | 2.1550483E−06 |
| A10 | −9.5585689E−08 | −1.0902073E−07 | −5.4287199E−07 | −1.4323633E−06 |
| A11 | 3.1538515E−08 | 3.8506165E−08 | 7.7143869E−09 | −6.0486095E−08 |
| A12 | 2.0883407E−09 | −6.3730997E−09 | 1.1379100E−08 | 3.0508164E−08 |
| A13 | −3.4915773E−10 | −5.2731885E−10 | −1.2309209E−10 | 9.8400502E−10 |
| A14 | −3.8556383E−11 | 1.9725862E−10 | −1.5009927E−10 | −4.0163794E−10 |
| A15 | 2.3627405E−12 | 4.3530501E−12 | 1.1232057E−12 | −9.3266439E−12 |
| A16 | 4.5119861E−13 | −2.4324844E−12 | 1.2274858E−12 | 3.2221309E−12 |
| A17 | −8.9841575E−15 | −1.9903167E−14 | −5.6147210E−15 | 4.7901774E−14 |
| A18 | −2.8030699E−15 | 1.4414041E−14 | −5.6748724E−15 | −1.4433920E−14 |
| A19 | 1.4709982E−17 | 3.8759544E−17 | 1.2066767E−17 | −1.0307844E−16 |
| A20 | 7.0375389E−18 | −3.3832604E−17 | 1.1321731E−17 | 2.7688923E−17 |

| Sn | 10 | 11 | 12 | 13 |
|---|---|---|---|---|
| KA | 1.0000000E+00 | 1.0000000E+00 | 1.0000000E+00 | 1.0000000E+00 |
| A3 | −3.0357661E−19 | −2.1684043E−19 | 3.0357661E−19 | −6.5052130E−20 |
| A4 | 9.9213015E−04 | −3.2995966E−04 | −1.9486353E−03 | −7.9661455E−04 |
| A5 | −1.8648651E−04 | −1.9178497E−04 | 1.9334623E−05 | 1.5966463E−05 |
| A6 | −4.2486188E−05 | 8.6791752E−05 | 1.9286491E−04 | 1.1757074E−04 |
| A7 | 8.9186492E−06 | 6.3772829E−07 | −5.1444589E−06 | 2.5747527E−06 |
| A8 | 9.2354393E−07 | −7.7013654E−06 | −1.2014655E−05 | −6.0249448E−06 |
| A9 | −1.1714803E−07 | 1.1059287E−07 | 2.1261259E−07 | −1.3429268E−07 |
| A10 | −2.0156154E−08 | 3.2139591E−07 | 4.2975336E−07 | 1.7881367E−07 |
| A11 | −6.0374568E−10 | −3.5766260E−09 | −5.0081946E−09 | 3.5905483E−09 |
| A12 | 3.7923439E−10 | −7.8972460E−09 | −9.2962922E−09 | −3.2145898E−09 |
| A13 | 4.2540163E−11 | 5.7311693E−11 | 7.3781088E−11 | −5.5430677E−11 |
| A14 | −4.8607057E−12 | 1.1969985E−10 | 1.2384535E−10 | 3.4645732E−11 |
| A15 | −6.0289502E−13 | −5.4913716E−13 | −6.6541031E−13 | 4.9201905E−13 |
| A16 | 3.8943508E−14 | −1.0964418E−12 | −9.9356826E−13 | −2.1017987E−13 |
| A17 | 3.8396847E−15 | 3.0343269E−15 | 3.3398746E−15 | −2.3237943E−15 |
| A18 | −1.8043700E−16 | 5.5523297E−15 | 4.4022421E−15 | 6.0465710E−16 |
| A19 | −9.5053291E−18 | −7.3209708E−18 | −7.0508589E−18 | 4.5075401E−18 |
| A20 | 3.7628416E−19 | −1.1915001E−17 | −8.2753496E−18 | −4.5096656E−19 |

TABLE 96B
Example 24

| Sn | 16 | 17 |
|---|---|---|
| KA | 1.0000000E+00 | 1.0000000E+00 |
| A3 | −3.4694470E−19 | 1.9081958E−18 |
| A4 | −1.8793690E−03 | 7.0074950E−04 |
| A5 | −3.7481549E−06 | −6.0548037E−04 |
| A6 | 1.2629869E−04 | 1.7179441E−04 |
| A7 | −1.1439962E−05 | 3.5956599E−05 |
| A8 | −7.2106676E−06 | −1.4360180E−05 |
| A9 | 6.5834947E−07 | −1.3932161E−06 |
| A10 | 2.0745319E−07 | 5.2341013E−07 |
| A11 | −1.8289306E−08 | 3.2940659E−08 |
| A12 | −3.2196094E−09 | −1.0770327E−08 |
| A13 | 2.9109059E−10 | −4.8035264E−10 |
| A14 | 2.6095377E−11 | 1.3261509E−10 |
| A15 | −2.7012455E−12 | 4.2239406E−12 |
| A16 | −8.0765793E−14 | −9.6337309E−13 |
| A17 | 1.3595416E−14 | −2.0547337E−14 |
| A18 | −1.8514810E−16 | 3.7805129E−15 |
| A19 | −2.8674013E−17 | 4.2483626E−17 |
| A20 | 1.3323679E−18 | −6.1111259E−18 |

### Example 25

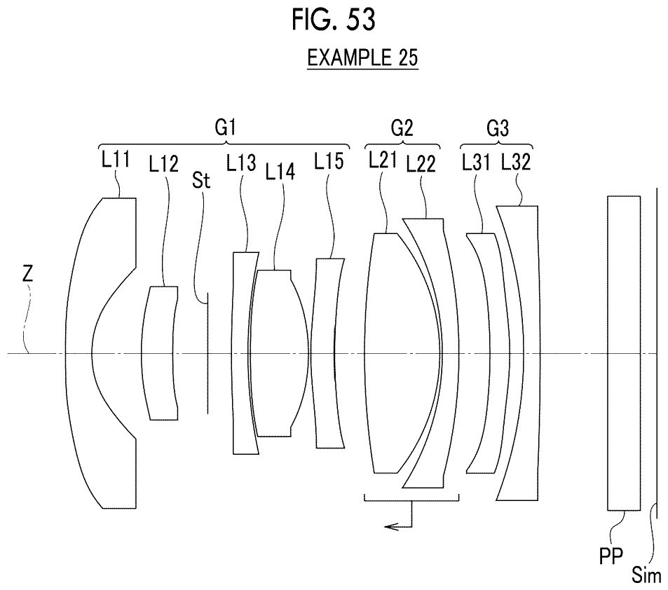

A cross-sectional view of a configuration of an imaging lens of Example 25 is illustrated in FIG. 53. The imaging lens of Example 25 consists of, in order from the object side to the image side, the first lens group G1 having a positive refractive power, the second lens group G2 having a positive refractive power, and the third lens group G3 having a negative refractive power. The focus group consists of the second lens group G2, and during the focusing from the infinite distance object to the nearest object, the focus group moves to the object side along the optical axis Z.

The first lens group G1 consists of, in order from the object side to the image side, the lenses L11 and L12, the aperture stop St, and the lenses L13 to L15. The second lens group G2 consists of, in order from the object side to the image side, two lenses including the lenses L21 and L22. The third lens group G3 consists of, in order from the object side to the image side, two lenses including the lenses L31 and L32.

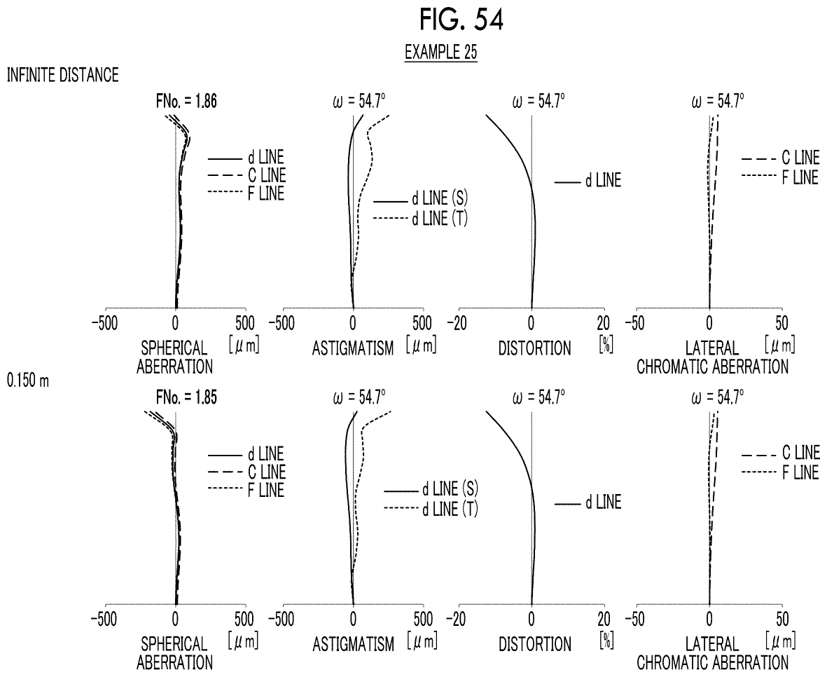

For the imaging lens of Example 25, Table 97 shows basic lens data, Table 98 shows specifications, Table 99 shows a variable surface spacing, Tables 100A and 100B show aspherical coefficients, and FIG. 54 illustrates each aberration diagram.

TABLE 97
Example 25

| Sn | R | D | Nd | vd | ED | Hinf |
|---|---|---|---|---|---|---|
| *1 | 299.9930 | 1.1139 | 1.69350 | 53.20 | 10.32 | |
| *2 | 4.5222 | 2.0949 | | | 6.94 | |
| *3 | 11.6505 | 1.3235 | 1.68948 | 31.02 | 5.72 | 2.44 |
| *4 | 26.6250 | 1.4871 | | | 4.62 | |
| 5 (St) | ∞ | 1.0002 | | | | |
| 6 | 52.8893 | 0.6958 | 1.92286 | 20.88 | 5.67 | |
| 7 | 20.5788 | 0.1037 | | | 5.87 | |
| *8 | 36.6608 | 2.4550 | 1.76802 | 49.24 | 5.94 | |
| *9 | −8.1581 | 0.0999 | | | 6.34 | |
| *10 | 13.2813 | 0.9856 | 1.76802 | 49.24 | 6.88 | (1.99) |
| *11 | 21.6431 | DD[11] | | | 7.14 | |
| 12 | 32.3339 | 3.1840 | 1.72916 | 54.67 | 8.15 | |
| 13 | −8.2519 | 0.1075 | | | 8.71 | |
| 14 | −10.7421 | 0.7001 | 1.98613 | 16.48 | 8.55 | |
| 15 | −21.5232 | DD[15] | | | 8.85 | |
| *16 | −23.1619 | 0.8373 | 1.58313 | 59.46 | 8.99 | |
| *17 | −11.9105 | 0.5865 | | | 9.41 | 2.09/3.11 |
| 18 | −17.8193 | 0.6998 | 1.98613 | 16.48 | 9.57 | |
| 19 | −127.7478 | 2.8515 | | | 10.15 | |
| 20 | ∞ | 1.3800 | 1.51680 | 64.20 | | |
| 21 | ∞ | 0.7039 | | | | |

TABLE 98
Example 25

| | |
|---|---|
| f | 5.74 |
| Bf | 4.47 |
| Fno | 1.86 |
| 2ωm [°] | 109.4 |

TABLE 99
Example 25

| | Infinite | |
|---|---|---|
| | Distance | 0.150 m |
| DD[11] | 1.2622 | 1.0289 |
| DD[15] | 1.3136 | 1.5469 |

TABLE 100A
Example 25

| Sn | 1 | 2 | 3 | 4 |
|---|---|---|---|---|
| KA | 1.0000000E+00 | 1.0000000E+00 | 1.0000000E+00 | 1.0000000E+00 |
| A3 | 1.3877788E−18 | 0.0000000E+00 | −3.1225023E−18 | −5.2041704E−19 |
| A4 | 7.2400602E−03 | 7.1718578E−03 | 1.9448621E−03 | 3.7976540E−03 |
| A5 | −1.3448218E−03 | 5.6391341E−04 | 3.8328752E−04 | 5.5418271E−04 |
| A6 | −4.4091496E−04 | −1.1266579E−03 | −2.5153362E−04 | −3.8236194E−04 |
| A7 | 1.0823149E−04 | −6.6520506E−05 | −6.8712994E−05 | 2.1287106E−05 |
| A8 | 1.5397189E−05 | 6.5179204E−05 | 8.8661843E−06 | 2.2549921E−05 |
| A9 | −4.4946124E−06 | 3.0197634E−06 | 2.8622422E−06 | −1.0110710E−06 |
| A10 | −3.2065943E−07 | −2.2612839E−06 | −1.6833852E−07 | −7.8962522E−07 |
| A11 | 1.1097672E−07 | −7.6397536E−08 | −6.9467348E−08 | 2.6826729E−08 |
| A12 | 4.2818984E−09 | 4.9034860E−08 | 1.5601181E−09 | 1.7211090E−08 |
| A13 | −1.6714135E−09 | 1.1624829E−09 | 1.0278709E−09 | −4.2349693E−10 |
| A14 | −3.9857654E−11 | −6.6925897E−10 | −1.7362564E−12 | −2.3598385E−10 |
| A15 | 1.5063956E−11 | −1.0524507E−11 | −9.1112108E−12 | 3.9569817E−12 |
| A16 | 2.7835050E−13 | 5.5843793E−12 | −9.5147085E−14 | 1.9766559E−12 |
| A17 | −7.4633208E−14 | 5.2220739E−14 | 4.4431125E−14 | −2.0171932E−14 |
| A18 | −1.3621839E−15 | −2.6016252E−14 | 7.7238126E−16 | −9.2347076E−15 |
| A19 | 1.5629699E−16 | −1.0937633E−16 | −9.1605233E−17 | 4.3243442E−17 |
| A20 | 3.2683441E−18 | 5.1837720E−17 | −1.9311731E−18 | 1.8430423E−17 |

| Sn | 8 | 9 | 10 | 11 |
|---|---|---|---|---|
| KA | 1.0000000E+00 | 1.0000000E+00 | 1.0000000E+00 | 1.0000000E+00 |
| A3 | 3.4694470E−19 | 1.6479873E−18 | 5.1770654E−19 | 3.4694470E−19 |
| A4 | 1.3978836E−03 | −1.9342988E−03 | −2.6607671E−03 | 1.7908227E−05 |
| A5 | 1.5671723E−04 | 7.4088781E−05 | −3.3950304E−05 | −2.7634298E−04 |
| A6 | −1.2601688E−04 | 1.6834004E−04 | 1.6658174E−04 | −1.6165093E−06 |
| A7 | −8.9331603E−06 | −1.8908348E−05 | −5.5794252E−07 | 2.8001223E−05 |
| A8 | 6.1520714E−06 | −8.8704899E−06 | −8.7234859E−06 | 1.9796337E−06 |
| A9 | 4.8389541E−07 | 8.0788248E−07 | 7.7378936E−08 | −1.0856838E−06 |
| A10 | −1.9094267E−07 | 2.7689479E−07 | 2.9372879E−07 | −1.1277385E−07 |
| A11 | −1.3090648E−08 | −1.9016029E−08 | −1.7650927E−09 | 2.5131731E−08 |
| A12 | 3.7527981E−09 | −5.4249336E−09 | −6.2513772E−09 | 3.1122784E−09 |
| A13 | 2.0516823E−09 | 2.7212968E−10 | 1.7954623E−11 | −3.6019550E−10 |
| A14 | −4.6157173E−11 | 6.7286593E−11 | 8.3599911E−11 | −4.8997554E−11 |
| A15 | −1.9024413E−12 | −2.3563350E−12 | −8.2550455E−14 | 3.1256917E−12 |
| A16 | 3.4472077E−13 | −5.1252184E−13 | −6.8076220E−13 | 4.4866426E−13 |
| A17 | 9.6986781E−15 | 1.1367774E−14 | 7.7014758E−17 | −1.5040456E−14 |
| A18 | −1.4323847E−15 | 2.1891263E−15 | 3.0848687E−15 | −2.2281650E−15 |
| A19 | −2.0924370E−17 | −2.3440639E−17 | 4.2421120E−19 | 3.0816399E−17 |
| A20 | 2.5438000E−18 | −4.0164908E−18 | −5.9675950E−18 | 4.6448992E−18 |

TABLE 100B
Example 25

| Sn | 16 | 17 |
|---|---|---|
| KA | 1.0000000E+00 | 1.0000000E+00 |
| A3 | −3.4694470E−19 | −3.4694470E−19 |
| A4 | −4.6664991E−04 | 2.3284159E−03 |
| A5 | 8.1271070E−05 | −4.4942832E−04 |
| A6 | 9.3059222E−05 | 1.3177733E−04 |
| A7 | −1.6983526E−05 | 2.4637194E−05 |
| A8 | −8.6966112E−06 | −1.7049535E−05 |
| A9 | 7.5190070E−07 | −9.0536150E−07 |
| A10 | 3.6129795E−07 | 7.2907597E−07 |
| A11 | −1.8428223E−08 | 2.1572207E−08 |
| A12 | −8.4671611E−09 | −1.6901579E−08 |
| A13 | 2.7419349E−10 | −3.2208802E−10 |
| A14 | 1.1970806E−10 | 2.3389725E−10 |
| A15 | −2.4488836E−12 | 2.8958759E−12 |
| A16 | −1.0158844E−12 | −1.9335785E−12 |
| A17 | 1.2052774E−14 | −1.4303671E−14 |
| A18 | 4.7777798E−15 | 8.8262280E−15 |
| A19 | −2.5124755E−17 | 2.9788943E−17 |
| A20 | −9.5897697E−18 | −1.7136874E−17 |

Tables 101 to 109 show the corresponding values of Conditional Expressions (1) to (26) of the imaging lenses of Examples 1 to 25. In fields of the corresponding values of Conditional Expressions (16) and (17), a surface having the specific intersection is shown with “S” and its surface number in parentheses before the corresponding values, and each corresponding value shown for one surface having a plurality of inflection points is separated by “/”. In the fields of the corresponding values of Conditional Expressions (16) and (17), corresponding values not satisfying each conditional expression are not shown, and a surface without corresponding values satisfying each conditional expression is shown with “none” after its surface number. Preferable ranges of the conditional expressions may be set using the corresponding values of the examples shown in Tables 101 to 109 as the upper limits and the lower limits of the conditional expressions.

TABLE 101

| Expres- | | | | |
|---|---|---|---|---|
| sion | | | | |
| Number | | Example 1 | Example 2 | Example 3 |
| (1) | TL/Y | 3.42 | 3.42 | 3.50 |
| (2) | (Y − f × tan ωm)/ | −0.123 | −0.104 | −0.121 |
| | (f × tan ωm) | | | |
| (3) | ωm | 54.02 | 54.18 | 54.16 |
| (4) | f/fG1 | 0.14 | 0.30 | 0.26 |
| (5) | dL1St/Y | 1.41 | 1.34 | 1.49 |
| (6) | \|CRA\| | 28.91 | 25.13 | 27.43 |
| (7) | Bf/TL | 0.13 | 0.16 | 0.13 |
| (8) | f/Fno | 3.21 | 3.12 | 3.12 |
| (9) | \|f/fG2\| | 0.69 | 0.66 | 0.74 |
| (10) | νrp | 45.45 | 54.04 | 45.45 |
| (11) | νfp | 55.35 | 54.68 | 54.68 |
| (12) | νffn | 40.10 | 40.10 | 40.10 |
| (13) | N1nave | 1.69 | 1.82 | 1.64 |
| (14) | ν1nave | 31.02 | 42.71 | 55.18 |
| (15) | fGf/fGr | 3.99 | 1.73 | 2.06 |
| (16) | φa/φ | (S1)0.004 | (S1)0.104 | (S1)0.021 |
| | | (S15)−0.002 | (S16)0.624 | (S15)0.001 |
| | | (S16)0.765 | (S18)−0.051 | (S16)0.658 |
| | | (S18)−0.001 | | (S18)−0.017 |
| (17) | Hinf/He | (S1)0.697 | (S1)0.588 | (S1)0.509/ |
| | | (S15)0.937 | (S16)0.866/ | 0.993 |
| | | (S16)0.585/ | 0.956 | (S15)None |
| | | 0.962 | (S18)None | (S16)0.588 |
| | | (S18)None | | (S18)0.14 |
| (18) | TL/f | 4.14 | 4.25 | 4.26 |
| (19) | f/fGf | 0.14 | 0.30 | 0.26 |
| (20) | f/fGr | 0.56 | 0.51 | 0.53 |
| (21) | \|νGfaven − | 7.14 | 3.46 | 3.39 |
| | νGfavep\| | | | |
| (22) | \|νGraven − | 45.81 | 45.81 | 45.81 |
| | νGravep\| | | | |
| (23) | Fno/tan ωm | 1.34 | 1.34 | 1.34 |
| (24) | f/fG3 | −0.26 | −0.22 | −0.35 |
| (25) | \|(1 − βfoc²) × | 1.33 | 1.28 | 1.46 |
| | βfocR²\| | | | |
| (26) | Y | 7.18 | 7.16 | 7.03 |

TABLE 102

| Expres- | | | | |
|---|---|---|---|---|
| sion | | | | |
| Number | | Example 4 | Example 5 | Example 6 |
| (1) | TL/Y | 3.15 | 2.75 | 2.79 |
| (2) | (Y − f × tan ωm)/ | −0.117 | −0.113 | −0.091 |
| | (f × tan ωm) | | | |
| (3) | ωm | 53.28 | 54.02 | 54.04 |
| (4) | f/fG1 | 1.15 | 0.03 | 1.41 |
| (5) | dL1St/Y | 1.27 | 1.03 | 0.69 |
| (6) | \|CRA\| | 28.68 | 36.81 | 31.42 |
| (7) | Bf/TL | 0.16 | 0.15 | 0.21 |
| (8) | f/Fno | 3.20 | 3.16 | 2.70 |
| (9) | \|f/fG2\| | 0.53 | 0.87 | 0.45 |
| (10) | νrp | 40.73 | 45.45 | 81.56 |
| (11) | νfp | 53.87 | 55.35 | 29.14 |
| (12) | νffn | 40.10 | 40.10 | 81.54 |
| (13) | N1nave | 1.69 | 1.69 | 1.65 |
| (14) | ν1nave | 31.02 | 31.02 | 61.14 |
| (15) | fGf/fGr | 2.29 | 25.04 | −2.73 |
| (16) | φa/φ | (S1)0.005 | (S1)−0.027 | (S1)0.089 |
| | | (S15)−0.002 | (S15)−0.006 | (S14)0.274 |
| | | (S16)0.796 | (S16)1.027 | (S16)−0.018 |
| | | (S18)−0.054 | (S18)0.002 | |
| (17) | Hinf/He | (S1)0.665 | (S1)0.688 | (S1)0.981 |
| | | (S15)0.331/ | (S15)0.305/ | (S14)0.698 |
| | | 0.938 | 0.886 | (S16)0.318/ |
| | | (S16)0.580/ | (S16)0.540/ | 0.397 |
| | | 0.968 | 0.929 | |
| | | (S18)None | (S18)0.306 | |
| (18) | TL/f | 3.73 | 3.36 | 3.49 |
| (19) | f/fGf | 0.25 | 0.03 | −0.28 |
| (20) | f/fGr | 0.57 | 0.71 | 0.76 |
| (21) | \|νGfaven − | 5.94 | 7.14 | 32.00 |
| | νGfavep\| | | | |
| (22) | \|νGraven − | 45.81 | 45.81 | 22.13 |
| | νGravep\| | | | |
| (23) | Fno/tan ωm | 1.38 | 1.34 | 2.61 |
| (24) | f/fG3 | 0.48 | −0.36 | 0.23 |
| (25) | \|(1 − βfoc²) × | 1.00 | 1.48 | 1.28 |
| | βfocR²\| | | | |
| (26) | Y | 7.01 | 7.15 | 12.21 |

TABLE 103

| Expression | | | | |
|---|---|---|---|---|
| Number | | Example 7 | Example 8 | Example 9 |
| (1) | TL/Y | 2.78 | 2.73 | 2.73 |
| (2) | (Y − f × tan ωm)/ | −0.089 | −0.108 | −0.110 |
| | (f × tan ωm) | | | |
| (3) | ωm | 54.02 | 54.01 | 54.02 |
| (4) | f/fG1 | 1.19 | 1.22 | 1.36 |
| (5) | dL1St/Y | 0.73 | 0.72 | 0.75 |
| (6) | \|CRA\| | 21.78 | 24.33 | 21.47 |
| (7) | Bf/TL | 0.24 | 0.20 | 0.20 |
| (8) | f/Fno | 2.71 | 2.86 | 2.86 |
| (9) | \|f/fG2\| | 0.49 | 0.42 | 0.57 |
| (10) | νrp | 55.53 | 63.32 | 63.32 |
| (11) | νfp | 29.14 | 29.13 | 29.13 |
| (12) | νffn | 95.10 | 95.10 | 95.10 |
| (13) | N1nave | 1.62 | 1.62 | 1.62 |
| (14) | ν1nave | 70.28 | 70.28 | 70.28 |
| (15) | fGf/fGr | −3.16 | −3.03 | −4.92 |
| (16) | φa/φ | (S1)0.072 | (S1)0.121 | (S1)0.093 |
| | | (S13)0.006 | (S17)−0.346 | |
| | | | (S18)0.122 | |
| (17) | Hinf/He | (S1)0.874 | (S1)0.977 | (S1)0.973 |
| | | (S13)None | (S17)0.560 | |
| | | | (S18)0.600 | |
| (18) | TL/f | 3.49 | 3.35 | 3.35 |
| (19) | f/fGf | −0.23 | −0.25 | −0.15 |
| (20) | f/fGr | 0.73 | 0.76 | 0.72 |
| (21) | \|νGfaven − | 41.14 | 41.15 | 41.15 |
| | νGfavep\| | | | |
| (22) | \|νGraven − | 18.08 | 15.37 | 15.37 |
| | νGravep\| | | | |
| (23) | Fno/tan ωm | 2.62 | 2.62 | 2.62 |
| (24) | f/fG3 | 0.46 | 0.33 | 0.37 |
| (25) | \|(1 − βfoc²) × | 1.07 | 1.00 | 1.42 |
| | βfocR²\| | | | |
| (26) | Y | 12.28 | 12.67 | 12.64 |

TABLE 104

| Expres- | | | | |
|---|---|---|---|---|
| sion | | Example | Example | Example |
| Number | | 10 | 11 | 12 |
| (1) | TL/Y | 2.67 | 2.70 | 2.73 |
| (2) | (Y − f × tan ωm)/ | −0.089 | −0.099 | −0.111 |
| | (f × tan ωm) | | | |
| (3) | ωm | 54.00 | 54.01 | 54.01 |
| (4) | f/fG1 | 0.65 | 0.33 | 0.15 |
| (5) | dL1St/Y | 0.69 | 0.69 | 1.04 |
| (6) | \|CRA\| | 26.19 | 25.46 | 37.77 |
| (7) | Bf/TL | 0.18 | 0.18 | 0.15 |
| (8) | f/Fno | 3.58 | 3.58 | 3.18 |
| (9) | \|f/fG2\| | 0.32 | 0.57 | 0.78 |
| (10) | νrp | 45.45 | 45.45 | 40.10 |
| (11) | νfp | 29.13 | 29.13 | 35.04 |
| (12) | νffn | 95.10 | 95.10 | 19.33 |
| (13) | N1nave | 1.62 | 1.62 | 1.80 |
| (14) | ν1nave | 70.28 | 70.28 | 45.45 |
| (15) | fGf/fGr | −2.77 | −2.54 | 4.43 |
| (16) | φa/φ | (S1)0.279 | (S1)0.284 | (S1)−0.0036 |
| | | (S17)−0.194 | (S17)−0.249 | (S14)−0.0001 |
| | | (S18)0.538 | (S18)0.535 | (S15)0.969 |
| | | (S19)−0.771 | (S19)−0.781 | (S17)−0.008 |
| | | (S20)0.442 | (S20)0.435 | |
| (17) | Hinf/He | (S1)0.908 | (S1)0.920 | (S1)0.76 |
| | | (S17)0.993 | (S17)0.992 | (S14)0.881 |
| | | (S18)0.766 | (S18)0.771 | (S15)0.524/ |
| | | (S19)0.624 | (S19)0.597 | 0.918 |
| | | (S20)0.910/ | (S20)0.805 | (S17)0.311 |
| | | 0.967 | | |
| (18) | TL/f | 3.35 | 3.35 | 3.34 |
| (19) | f/fGf | −0.28 | −0.31 | 0.15 |
| (20) | f/fGr | 0.78 | 0.80 | 0.65 |
| (21) | \|νGfaven − | 41.15 | 41.15 | 1.29 |
| | νGfavep\| | | | |
| (22) | \|νGraven − | 22.12 | 23.60 | 9.92 |
| | νGravep\| | | | |
| (23) | Fno/tan ωm | 2.09 | 2.09 | 1.34 |
| (24) | f/fG3 | 0.05 | −0.03 | −0.22 |
| (25) | \|(1 − βfoc²) × | 0.55 | 0.98 | 1.27 |
| | βfocR²\| | | | |
| (26) | Y | 12.92 | 12.79 | 7.19 |

TABLE 105

| Expres- | | | | |
|---|---|---|---|---|
| sion | | Example | Example | Example |
| Number | | 13 | 14 | 15 |
| (1) | TL/Y | 2.32 | 1.56 | 1.42 |
| (2) | (Y − f × tan ωm)/ | −0.113 | −0.130 | −0.123 |
| | (f × tan ωm) | | | |
| (3) | ωm | 54.02 | 53.98 | 53.94 |
| (4) | f/fG1 | 0.47 | 0.78 | 0.52 |
| (5) | dL1St/Y | 0.88 | 0.47 | 0.40 |
| (6) | \|CRA\| | 39.78 | 55.99 | 62.61 |
| (7) | Bf/TL | 0.11 | 0.14 | 0.24 |
| (8) | f/Fno | 2.80 | 2.54 | 2.07 |
| (9) | \|f/fG2\| | 0.84 | 1.53 | 1.88 |
| (10) | νrp | 54.04 | 53.94 | 71.68 |
| (11) | νfp | 49.50 | 40.10 | 45.45 |
| (12) | νffn | 19.33 | 19.33 | 23.62 |
| (13) | N1nave | 1.78 | 2.00 | 1.63 |
| (14) | ν1nave | 45.50 | 19.33 | 23.62 |
| (15) | fGf/fGr | 0.64 | 0.09 | 0.89 |
| (16) | φa/φ | (S1)−0.059 | (S2)0.720 | (S1)−0.580 |
| | | (S12)0.115 | (S3)0.564 | (S2)0.318 |
| | | (S13)0.863 | (S10)−0.002 | (S3)0.713 |
| | | | (S13)−0.061 | (S9)2.029 |
| | | | | (S11)−0.485 |
| (17) | Hinf/He | (S1)0.986 | (S2)0.894 | (S1)0.724/ |
| | | (S12)0.442/ | (S3)0.743 | 0.899 |
| | | 0.782 | (S10)None | (S2)0.563/ |
| | | (S13)0.476/ | (S13)None | 0.967 |
| | | 0.847 | | (S3)0.656 |
| | | | | (S9)0.986 |
| | | | | (S11)0.375 |
| (18) | TL/f | 2.84 | 1.86 | 1.71 |
| (19) | f/fGf | 0.47 | 0.78 | 0.52 |
| (20) | f/fGr | 0.30 | 0.07 | 0.47 |
| (21) | \|νGfaven − | 4.00 | 20.78 | 21.83 |
| | νGfavep\| | | | |
| (22) | \|νGraven − | 27.43 | 22.56 | 27.14 |
| | νGravep\| | | | |
| (23) | Fno/tan ωm | 1.34 | 1.35 | 1.35 |
| (24) | f/fG3 | −0.94 | −1.82 | −1.90 |
| (25) | \|(1 − βfoc²) × | 1.60 | 1.98 | 3.32 |
| | βfocR²\| | | | |
| (26) | Y | 6.33 | 5.61 | 4.61 |

TABLE 106

| Expression | | Example | Example | Example |
|---|---|---|---|---|
| Number | | 16 | 17 | 18 |
| (1) | TL/Y | 3.33 | 3.45 | 3.45 |
| (2) | (Y − f × tan ωm)/ | −0.108 | −0.085 | −0.109 |
| | (f × tan ωm) | | | |
| (3) | ωm | 53.29 | 53.46 | 54.19 |
| (4) | f/fG1 | 1.33 | 0.43 | 0.47 |
| (5) | dL1St/Y | 1.43 | 1.09 | 1.04 |
| (6) | \|CRA\| | 37.00 | 32.19 | 29.75 |
| (7) | Bf/TL | 0.11 | 0.18 | 0.19 |
| (8) | f/Fno | 3.20 | 3.09 | 3.09 |
| (9) | \|f/fG2\| | 0.30 | 0.51 | 0.45 |
| (10) | νrp | 40.50 | — | — |
| (11) | νfp | 53.02 | 40.73 | 40.73 |
| (12) | νffn | 40.10 | | |
| (13) | N1nave | 1.69 | 1.69 | 1.69 |
| (14) | ν1nave | 53.20 | 53.20 | 53.20 |
| (15) | fGf/fGr | 1.32 | −2.17 | −1.99 |
| (16) | φa/φ | (S1)0.002 | (S5)0.245 | (S5)0.237 |
| | | (S15)0.0001 | | |
| | | (S16)0.646 | | |
| | | (S18)−0.169 | | |
| (17) | Hinf/He | (S1)0.797 | (S5)0.584 | (S5)0.581 |
| | | (S15)0.890 | | |
| | | (S16)0.959 | | |
| | | (S18)None | | |
| (18) | TL/f | 3.98 | 4.26 | 4.26 |
| (19) | f/fGf | 0.32 | −0.38 | −0.41 |
| (20) | f/fGr | 0.43 | 0.82 | 0.82 |
| (21) | \|νGfaven − | 3.17 | 23.18 | 20.11 |
| | νGfavep\| | | | |
| (22) | \|νGraven − | 35.96 | 34.58 | 36.49 |
| | νGravep\| | | | |
| (23) | Fno/tan ωm | 1.38 | 1.38 | 1.34 |
| (24) | f/fG3 | 0.00 | −0.30 | −0.20 |
| (25) | \|(1 − βfoc²) × | 1.00 | 1.29 | 1.07 |
| | βfocR²\| | | | |
| (26) | Y | 7.09 | 7.10 | 7.10 |

TABLE 107

| Expression | | Example | Example | Example |
|---|---|---|---|---|
| Number | | 19 | 20 | 21 |
| (1) | TL/Y | 3.45 | 3.45 | 4.08 |
| (2) | (Y − f × tan ωm)/ | −0.112 | −0.099 | −0.132 |
| | (f × tan ωm) | | | |
| (3) | ωm | 54.29 | 53.94 | 54.87 |
| (4) | f/fG1 | 0.44 | 0.43 | 0.28 |
| (5) | dL1St/Y | 0.93 | 0.89 | 1.17 |
| (6) | \|CRA\| | 32.32 | 28.17 | 21.57 |
| (7) | Bf/TL | 0.15 | 0.19 | 0.16 |
| (8) | f/Fno | 3.07 | 3.07 | 2.92 |
| (9) | \|f/fG2\| | 0.48 | 0.49 | 0.53 |
| (10) | νrp | — | — | — |
| (11) | νfp | 31.02 | 31.02 | 40.73 |
| (12) | νffn | 49.24 | 49.24 | 49.24 |
| (13) | N1nave | 1.77 | 1.77 | 1.77 |
| (14) | ν1nave | 49.24 | 49.24 | 49.24 |
| (15) | fGf/fGr | −1.62 | −1.69 | 8.11 |
| (16) | φa/φ | (S3)0.417 | (S3)0.446 | (S3)0.352 |
| (17) | Hinf/He | (S3)0.805 | (S3)0.834 | (S3)0.683 |
| (18) | TL/f | 4.27 | 4.27 | 5.03 |
| (19) | f/fGf | −0.55 | −0.49 | 0.07 |
| (20) | f/fGr | 0.89 | 0.83 | 0.59 |
| (21) | \|νGfaven − | 18.22 | 18.22 | 8.51 |
| | νGfavep\| | | | |
| (22) | \|νGraven − | 44.98 | 38.50 | 25.14 |
| | νGravep\| | | | |
| (23) | Fno/tan ωm | 1.34 | 1.36 | 1.39 |
| (24) | f/fG3 | −0.30 | −0.21 | −0.10 |
| (25) | \|(1 − βfoc²) × | 1.18 | 1.24 | 1.18 |
| | βfocR²\| | | | |
| (26) | Y | 7.10 | 7.10 | 7.10 |

TABLE 108

| Expression | | Example | Example | Example |
|---|---|---|---|---|
| Number | | 22 | 23 | 24 |
| (1) | TL/Y | 3.47 | 3.54 | 3.45 |
| (2) | (Y − f × tan ωm)/ | −0.112 | −0.121 | −0.111 |
| | (f × tan ωm) | | | |
| (3) | ωm | 54.32 | 53.97 | 54.24 |
| (4) | f/fG1 | 0.31 | 0.40 | 0.36 |
| (5) | dL1St/Y | 0.92 | 1.12 | 0.96 |
| (6) | \|CRA\| | 20.75 | 23.98 | 31.41 |
| (7) | Bf/TL | 0.18 | 0.16 | 0.18 |
| (8) | f/Fno | 3.09 | 3.09 | 3.09 |
| (9) | \|f/fG2\| | 0.56 | 0.44 | 0.54 |
| (10) | νrp | 49.24 | 49.24 | — |
| (11) | νfp | 53.20 | 49.24 | 40.73 |
| (12) | νffn | 81.61 | 81.61 | — |
| (13) | N1nave | 1.54 | 1.50 | 1.69 |
| (14) | ν1nave | 74.32 | 81.59 | 53.20 |
| (15) | fGf/fGr | −1.82 | −2.90 | −1.57 |
| (16) | φa/φ | (S1)0.043 | (S1)0.011 | (S5)0.260 |
| | | (S2)−0.567 | (S2)−0.478 | |
| | | (S16)0.467 | (S16)0.312 | |
| | | (S17)−0.249 | (S17)−0.185 | |
| | | (S18)0.027 | (S18)0.014 | |
| (17) | Hinf/He | (S1)0.804 | (S1)0.822 | (S5)0.655 |
| | | (S2)0.744 | (S2)0.831 | |
| | | (S16)0.616 | (S16)0.667 | |
| | | (S17)0.706 | (S17)0.630 | |
| | | (S18)0.416 | (S18)0.428 | |
| (18) | TL/f | 4.29 | 4.28 | 4.26 |
| (19) | f/fGf | −0.43 | −0.25 | −0.55 |
| (20) | f/fGr | 0.79 | 0.73 | 0.87 |
| (21) | \|νGfaven − | 21.12 | 32.35 | 20.86 |
| | νGfavep\| | | | |
| (22) | \|νGraven − | 19.47 | 24.77 | 48.13 |
| | νGravep\| | | | |
| (23) | Fno/tan ωm | 1.34 | 1.35 | 1.34 |
| (24) | f/fG3 | 0.06 | 0.12 | −0.32 |
| (25) | \|(1 − βfoc²) × | 1.15 | 0.66 | 1.39 |
| | βfocR²\| | | | |
| (26) | Y | 7.10 | 6.95 | 7.10 |

TABLE 109

| Expression | | |
|---|---|---|
| Number | | Example 25 |
| (1) | TL/Y | 3.45 |
| (2) | (Y − f × tan ωm)/ | −0.124 |
| | (f × tan ωm) | |
| (3) | ωm | 54.70 |
| (4) | f/fG1 | 0.57 |
| (5) | dL1St/Y | 0.85 |
| (6) | \|CRA\| | 29.97 |
| (7) | Bf/TL | 0.18 |
| (8) | f/Fno | 3.09 |
| (9) | \|f/fG2\| | 0.36 |
| (10) | νrp | — |
| (11) | νfp | 31.02 |
| (12) | νffn | 53.20 |
| (13) | N1nave | 1.69 |
| (14) | ν1nave | 53.20 |
| (15) | fGf/fGr | −1.38 |
| (16) | φa/φ | (S3)0.340 |
| | | (S17)0.281 |
| (17) | Hinf/He | (S3)0.853 |
| | | (S17)0.444/0.661 |
| (18) | TL/f | 4.27 |
| (19) | f/fGf | −0.62 |
| (20) | f/fGr | 0.86 |
| (21) | \|νGfaven − νGfavep\| | 22.18 |
| (22) | \|νGraven − νGravep\| | 35.21 |
| (23) | Fno/tan ωm | 1.32 |
| (24) | f/fG3 | −0.13 |
| (25) | \|(1 − βfoc²) × βfocR²\| | 0.91 |
| (26) | Y | 7.10 |

All of the imaging lenses of Examples 1 to 25 are configured to have a wide angle with a maximum full angle of view of 100 degrees or more in the state where the infinite distance object is in focus, while being configured to be reduced in size. In a part of the examples, the F-number is smaller than 2. All of the imaging lenses of Examples 1 to 25 maintain high optical performance by favorably correcting various aberrations.

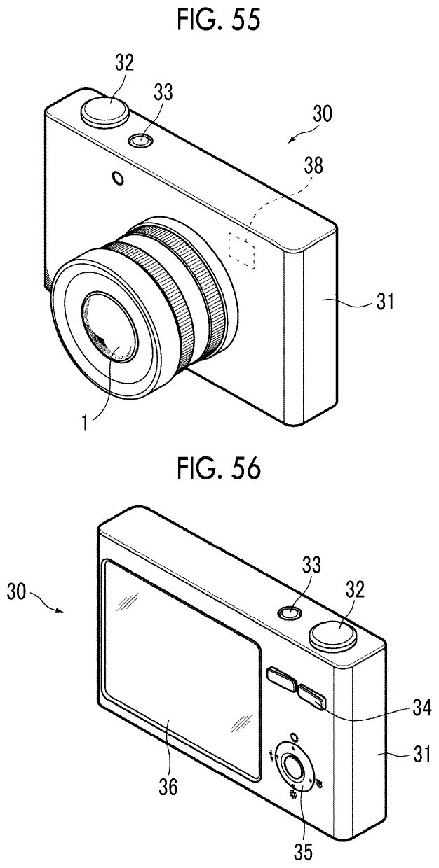

Next, an imaging apparatus according to the embodiment of the present disclosure will be described. FIGS. 55 and 56 illustrate external views of a camera 30 that is the imaging apparatus according to one embodiment of the present disclosure. FIG. 55 illustrates a perspective view of the camera 30 seen from its front surface side, and FIG. 56 illustrates a perspective view of the camera 30 seen from its rear surface side. The camera 30 is a so-called mirrorless-type digital camera and is configured to include an imaging lens 1 according to one embodiment of the present disclosure accommodated in a lens barrel.

The camera 30 comprises a camera body 31. A shutter button 32 and a power button 33 are provided on an upper surface of the camera body 31. An operator 34, an operator 35, and a display unit 36 are provided on a rear surface of the camera body 31. The display unit 36 can display a captured image and an image within an angle of view before capturing.

An imaging element 38 is provided in the camera body 31. The imaging element 38 outputs an imaging signal corresponding to a subject image formed by the imaging lens 1. For example, a charge coupled device (CCD) or a complementary metal oxide semiconductor (CMOS) is used as the imaging element 38. A signal processing circuit (not illustrated), a recording medium (not illustrated), and the like are provided in the camera body 31. The signal processing circuit generates an image by processing the imaging signal output from the imaging element 38. The generated image is recorded on the recording medium. In the camera 30, a static image or a video can be captured by pressing the shutter button 32, and image data obtained by this capturing is recorded on the recording medium.

While the disclosed technology has been described above using the embodiment and the examples, the disclosed technology is not limited to the embodiment and the examples and can be subjected to various modifications. For example, the curvature radius, the surface spacing, the refractive index, the Abbe number, and the aspherical coefficients of each lens are not limited to the values shown in each example and may have other values.

While the aberration diagrams of the examples are illustrated for the d line, the C line, and the F line, the disclosed technology is not limited to this wavelength range and can also be applied to an imaging lens in which the wavelength range is enlarged or reduced. Thus, the imaging apparatus of the present disclosure is not limited to a camera corresponding to the visible range. For example, the disclosed technology can also be applied to a visible range camera, a short wave infra-red (SWIR) range camera, a multispectral camera, a hyperspectral camera, or a thermography camera.

While FIG. 55 illustrates a lens-fixed camera in which the imaging lens is fixed to the camera body, the imaging apparatus of the present disclosure may be a lens-interchangeable camera in which the imaging lens is attachable to and detachable from the camera body. The imaging apparatus of the present disclosure can have various aspects such as a camera of a type other than a mirrorless type, a film camera, a video camera, a factory automation (FA) camera, a machine vision (MV) camera, a surveillance camera, an on-board camera, and a cinema camera.

The following appendices are further disclosed with respect to the embodiment and the examples described above.

### Appendix 1

An imaging lens consisting of, in order from an object side to an image side, a first lens group having a positive refractive power, a second lens group, and a third lens group, in which, during focusing, the first lens group and the third lens group are fixed with respect to an image plane, and the second lens group moves along an optical axis, a lens closest to the object side is a negative meniscus lens, and at least one of a second lens from the object side or a third lens from the object side is a lens other than the negative meniscus lens, a stop is disposed closer to the image side than the second lens from the object side, and in a case where a sum of a back focus of an entire system as an air conversion distance and a distance on the optical axis from a lens surface of the first lens group closest to the object side to a lens surface of the third lens group closest to the image side is denoted by TL, a maximum image height is denoted by Y, a focal length of the entire system in a state where an infinite distance object is in focus is denoted by f, and a maximum half angle of view in the state where the infinite distance object is in focus is denoted by ωm, Conditional Expressions (1) and (2) are satisfied, which are represented by

$$1 < TL / Y < 4.5 and \qquad ( 1 )$$

$$- 0.18 < ( Y - f \times tan ω m ) / ( f \times tan ω m ) < - 0.02 . \qquad ( 2 )$$

### Appendix 2

The imaging lens according to Appendix 1, in which, in a case where a radius of a circle passing through three points consisting of a point of a lens surface on the optical axis and two points of the lens surface at most outer ends of an effective diameter in a cross section including the optical axis is referred to as Rc of the lens surface, and a sign of Rc is positive in a case where the point on the optical axis is closer to the object side than a center of the circle, and is negative in a case where the point on the optical axis is closer to the image side than the center of the circle, the number of lenses, included in the third lens group, of which a lens surface on the object side has an aspherical shape and of which the sign of Rc of the lens surface on the object side is negative is one or two.

### Appendix 3

The imaging lens according to Appendix 1 or 2, in which the number of lenses included in the imaging lens is 5 or more and 10 or less.

### Appendix 4

The imaging lens according to any one of Appendices 1 to 3, in which, in a case where ωm is in degree units, Conditional Expression (3) is satisfied, which is represented by

$$47 < ω m < 60. \qquad ( 3 )$$

### Appendix 5

The imaging lens according to any one of Appendices 1 to 4, in which, in a case where a focal length of the first lens group is denoted by fG1, Conditional Expression (4) is satisfied, which is represented by

$$0.01 < f / fG 1 < 1.6 . \qquad ( 4 )$$

### Appendix 6

The imaging lens according to any one of Appendices 1 to 5, in which, in a case where a distance on the optical axis from the lens surface of the first lens group closest to the object side to the stop in the state where the infinite distance object is in focus is denoted by dL1St, Conditional Expression (5) is satisfied, which is represented by

$$0.1 < d L 1 St / Y < 2.1 . \qquad ( 5 )$$

### Appendix 7

The imaging lens according to any one of Appendices 1 to 6, in which, in a case where an angle between an axis line parallel to the optical axis and a principal ray of a maximum image height incident on the image plane in the state where the infinite distance object is in focus is denoted by CRA, and CRA is in degree units, Conditional Expression (6) is satisfied, which is represented by

$$16 < \vert CRA \vert < 69. \qquad ( 6 )$$

### Appendix 8

The imaging lens according to any one of Appendices 1 to 7, in which, in a case where the back focus of the entire system as the air conversion distance is denoted by Bf, Conditional Expression (7) is satisfied, which is represented by

$$0.06 < Bf / TL < 0.3 . \qquad ( 7 )$$

### Appendix 9

The imaging lens according to any one of Appendices 1 to 8, in which, in a case where f is in millimeter units, and an open F-number in the state where the infinite distance object is in focus is denoted by Fno, Conditional Expression (8) is satisfied, which is represented by

$$1.7 < f / Fno < 4.1 . \qquad ( 8 )$$

### Appendix 10

The imaging lens according to any one of Appendices 1 to 9, in which, in a case where a focal length of the second lens group is denoted by fG2, Conditional Expression (9) is satisfied, which is represented by

$$0.24 < \vert f / fG 2 \vert < 2.4 . \qquad ( 9 )$$

### Appendix 11

The imaging lens according to any one of Appendices 1 to 10, in which one or two single lenses having a negative refractive power and one or two single lenses having a positive refractive power are disposed closer to the object side than the stop, and the number of lenses disposed closer to the object side than the stop is four or less.

### Appendix 12

The imaging lens according to any one of Appendices 1 to 11, in which a positive lens is disposed adjacent to the image side of the stop, and in a case where an Abbe number based on a d line for the positive lens disposed adjacent to the image side of the stop is denoted by vrp, Conditional Expression (10) is satisfied, which is represented by

$$34 < ν rp < 87. \qquad ( 10 )$$

### Appendix 13

The imaging lens according to any one of Appendices 1 to 12, in which a positive lens is disposed adjacent to the object side of the stop, and in a case where an Abbe number based on a d line for the positive lens disposed adjacent to the object side of the stop is denoted by vfp, Conditional Expression (11) is satisfied, which is represented by

$$23 < ν fp < 61. \qquad ( 11 )$$

### Appendix 14

The imaging lens according to any one of Appendices 1 to 13, in which a positive lens is disposed adjacent to the object side of the stop, and an Lffn lens having a negative refractive power is disposed adjacent to the object side of the positive lens, and in a case where an Abbe number based on a d line for the Lffn lens is denoted by vffn, Conditional Expression (12) is satisfied, which is represented by

$$16 < ν ffn < 100. \qquad ( 12 )$$

### Appendix 15

The imaging lens according to any one of Appendices 1 to 14, in which, in a case where a radius of a circle passing through three points consisting of a point of a lens surface on the optical axis and two points of the lens surface at most outer ends of an effective diameter in a cross section including the optical axis is referred to as Rc of the lens surface, and a sign of Rc is positive in a case where the point on the optical axis is closer to the object side than a center of the circle, and is negative in a case where the point on the optical axis is closer to the image side than the center of the circle, the first lens group includes, in consecutive order from a position closest to the object side to the image side, a negative partial group and one positive lens, the negative partial group consists of one or two negative lenses having the same sign of Rc of a lens surface on the object side and Rc of a lens surface on the image side, at least one lens surface included in the negative partial group has an aspherical shape, and in a case where an average value of refractive indices with respect to a d line for all lenses included in the negative partial group is denoted by N1nave, and an average value of Abbe numbers based on the d line for all lenses included in the negative partial group is denoted by ν1nave, Conditional Expressions (13) and (14) are satisfied, which are represented by

$$1.45 < N 1 nave < 2.3 and \qquad ( 13 )$$

$$16 < ν 1 nave < 85. \qquad ( 14 )$$

### Appendix 16

The imaging lens according to any one of Appendices 1 to 15, in which, in a case where a combined focal length of all lenses closer to the object side than the stop in the state where the infinite distance object is in focus is denoted by fGf, and a combined focal length of all lenses closer to the image side than the stop in the state where the infinite distance object is in focus is denoted by fGr, Conditional Expression (15) is satisfied, which is represented by

$$- 10 < fGf / fGr < 31. \qquad ( 15 )$$

### Appendix 17

The imaging lens according to any one of Appendices 1 to 16, in which a lens surface of the second lens group closest to the image side has a convex shape.

### Appendix 18

The imaging lens according to any one of Appendices 1 to 17, in which the imaging lens includes at least one lens surface having an inflection point, and in a case where a distance on the optical axis from the lens surface of the first lens group closest to the object side to the lens surface of the third lens group closest to the image side is denoted by DL, at least one intersection between the lens surface having the inflection point and the optical axis in the state where the infinite distance object is in focus is a specific intersection within a range of 0.3×DL from an intersection between the lens surface of the first lens group closest to the object side and the optical axis to the image side or a range of 0.3×DL from an intersection between the lens surface of the third lens group closest to the image side and the optical axis to the object side.

### Appendix 19

The imaging lens according to Appendix 18, in which, in a case where a refractive power of a lens surface having the specific intersection is denoted by pa, and a refractive power of the imaging lens in the state where the infinite distance object is in focus is denoted by q, at least one lens surface having the specific intersection satisfies Conditional Expression (16) represented by

$$- 2 < φ a / φ < 3. \qquad ( 16 )$$

### Appendix 20

An imaging apparatus comprising the imaging lens according to any one of Appendices 1 to 19.

What is claimed is:

1. An imaging lens consisting of, in order from an object side to an image side, a first lens group having a positive refractive power, a second lens group, and a third lens group,
wherein, during focusing, the first lens group and the third lens group are fixed with respect to an image plane, and the second lens group moves along an optical axis,
a lens closest to the object side is a negative meniscus lens, and at least one of a second lens from the object side or a third lens from the object side is a lens other than the negative meniscus lens,
a stop is disposed closer to the image side than the second lens from the object side, and
in a case where a sum of a back focus of the imaging lens as an air conversion distance and a distance on the optical axis from a lens surface of the first lens group closest to the object side to a lens surface of the third lens group closest to the image side is denoted by TL,
a maximum image height is denoted by Y,
a focal length of the imaging lens in a state where an infinite distance object is in focus is denoted by f, and
a maximum half angle of view in the state where the infinite distance object is in focus is denoted by ωm,
Conditional Expressions (1) and (2) are satisfied, which are represented by
$$1 < TL / Y < 4.5 and \qquad ( 1 )$$
$$- 0.18 < ( Y - f \times tan ω m ) / ( f \times tan ω m ) < - 0.02 . \qquad ( 2 )$$

2. The imaging lens according to claim 1,
wherein, in a case where a radius of a circle passing through three points consisting of a point of a lens surface on the optical axis and two points of the lens surface at most outer ends of an effective diameter in a cross section including the optical axis is referred to as Rc of the lens surface, and
a sign of Rc is positive in a case where the point of the lens surface on the optical axis is closer to the object side than a center of the circle, and is negative in a case where the point of the lens surface on the optical axis is closer to the image side than the center of the circle,
the number of lenses, included in the third lens group, of which a lens surface on the object side has an aspherical shape and of which the sign of Rc of the lens surface on the object side is negative is one or two.

3. The imaging lens according to claim 1,
wherein the number of lenses included in the imaging lens is 5 or more and 10 or less.

4. The imaging lens according to claim 1,
wherein, in a case where ωm is in degree units,
Conditional Expression (3) is satisfied, which is represented by
$$47 < ω m < 60. \qquad ( 3 )$$

5. The imaging lens according to claim 1,
wherein, in a case where a focal length of the first lens group is denoted by fG1,
Conditional Expression (4) is satisfied, which is represented by
$$0.01 < f / fG 1 < 1.6 . \qquad ( 4 )$$

6. The imaging lens according to claim 1,
wherein, in a case where a distance on the optical axis from the lens surface of the first lens group closest to the object side to the stop in the state where the infinite distance object is in focus is denoted by dL1St,
Conditional Expression (5) is satisfied, which is represented by
$$0.1 < d L 1 St / Y < 2.1 . \qquad ( 5 )$$

7. The imaging lens according to claim 1,
wherein, in a case where an angle between an axis line parallel to the optical axis and a principal ray of a maximum image height incident on the image plane in the state where the infinite distance object is in focus is denoted by CRA, and
CRA is in degree units,
Conditional Expression (6) is satisfied, which is represented by
$$16 < \vert CRA \vert < 69. \qquad ( 6 )$$

8. The imaging lens according to claim 1,
wherein, in a case where the back focus of the imaging lens as the air conversion distance is denoted by Bf,
Conditional Expression (7) is satisfied, which is represented by
$$0.06 < Bf / TL < 0.3 . \qquad ( 7 )$$

9. The imaging lens according to claim 1,
wherein, in a case where f is in millimeter units, and
an open F-number in the state where the infinite distance object is in focus is denoted by Fno,
Conditional Expression (8) is satisfied, which is represented by
$$1.7 < f / Fno < 4.1 . \qquad ( 8 )$$

10. The imaging lens according to claim 1,
wherein, in a case where a focal length of the second lens group is denoted by fG2,
Conditional Expression (9) is satisfied, which is represented by
$$0.24 < \vert f / fG 2 \vert < 2.4 . \qquad ( 9 )$$

11. The imaging lens according to claim 1,
wherein one or two single lenses having a negative refractive power and one or two single lenses having a positive refractive power are disposed closer to the object side than the stop, and
the number of lenses disposed closer to the object side than the stop is four or less.

12. The imaging lens according to claim 1,
wherein a positive lens is disposed adjacent to the image side of the stop, and
in a case where an Abbe number based on a d line for the positive lens disposed adjacent to the image side of the stop is denoted by vrp,
Conditional Expression (10) is satisfied, which is represented by
$$34 < ν rp < 87. \qquad ( 10 )$$

13. The imaging lens according to claim 1,
wherein a positive lens is disposed adjacent to the object side of the stop, and
in a case where an Abbe number based on a d line for the positive lens disposed adjacent to the object side of the stop is denoted by vfp,
Conditional Expression (11) is satisfied, which is represented by
$$23 < ν fp < 61. \qquad ( 11 )$$

14. The imaging lens according to claim 1,
wherein a positive lens is disposed adjacent to the object side of the stop, and an Lffn lens having a negative refractive power is disposed adjacent to the object side of the positive lens, and
in a case where an Abbe number based on a d line for the Lffn lens is denoted by vffn,
Conditional Expression (12) is satisfied, which is represented by
$$16 < ν ffn < 100. \qquad ( 12 )$$

15. The imaging lens according to claim 1,
wherein, in a case where a radius of a circle passing through three points consisting of a point of a lens surface on the optical axis and two points of the lens surface at most outer ends of an effective diameter in a cross section including the optical axis is referred to as Rc of the lens surface, and
a sign of Rc is positive in a case where the point of the lens surface on the optical axis is closer to the object side than a center of the circle, and is negative in a case where the point of the lens surface on the optical axis is closer to the image side than the center of the circle,
the first lens group includes, in consecutive order from a position closest to the object side to the image side, a negative partial group and one positive lens,
the negative partial group consists of one or two negative lenses having the same sign of Rc of a lens surface on the object side and Rc of a lens surface on the image side,
at least one lens surface included in the negative partial group has an aspherical shape, and
in a case where an average value of refractive indices with respect to a d line for all lenses included in the negative partial group is denoted by N1nave, and
an average value of Abbe numbers based on the d line for all lenses included in the negative partial group is denoted by ν1nave,
Conditional Expressions (13) and (14) are satisfied, which are represented by
$$1.45 < N 1 nave < 2.3 and \qquad ( 13 )$$
$$16 < ν 1 nave < 85. \qquad ( 14 )$$

16. The imaging lens according to claim 1,
wherein, in a case where a combined focal length of all lenses closer to the object side than the stop in the state where the infinite distance object is in focus is denoted by fGf, and
a combined focal length of all lenses closer to the image side than the stop in the state where the infinite distance object is in focus is denoted by fGr,
Conditional Expression (15) is satisfied, which is represented by
$$- 10 < fGf / fGr < 31. \qquad ( 15 )$$

17. The imaging lens according to claim 1,
wherein a lens surface of the second lens group closest to the image side has a convex shape.

18. The imaging lens according to claim 1,
wherein the imaging lens includes at least one lens surface having an inflection point, and
in a case where a distance on the optical axis from the lens surface of the first lens group closest to the object side to the lens surface of the third lens group closest to the image side is denoted by DL,
at least one intersection between the lens surface having the inflection point and the optical axis in the state where the infinite distance object is in focus is a specific intersection within a range of 0.3×DL from an intersection between the lens surface of the first lens group closest to the object side and the optical axis to the image side or a range of 0.3×DL from an intersection between the lens surface of the third lens group closest to the image side and the optical axis to the object side.

19. The imaging lens according to claim 18,
wherein, in a case where a refractive power of a lens surface having the specific intersection is denoted by pa, and
a refractive power of the imaging lens in the state where the infinite distance object is in focus is denoted by q,
at least one lens surface having the specific intersection satisfies Conditional Expression (16) represented by
$$- 2 < φ a / φ < 3. \qquad ( 16 )$$

20. An imaging apparatus comprising:
the imaging lens according to claim 1.
